(19) United States
(12) Patent Application Publication
(10) Pub. No.: US 2026/0329680 A1
(43) Pub. Date: Oct. 22, 2026

(54) SYSTEM

(71) Applicant: SoftBank Group Corp., Tokyo (JP)

(72) Inventor: Ryo YONEDA, Tokyo (JP)

(73) Assignee: SoftBank Group Corp., Tokyo (JP)

(21) Appl. No.: 19/650,339

(22) Filed: Apr. 17, 2026

(30) Foreign Application Priority Data
Apr. 21, 2025 (JP) 2025-070005

(51) Int. Cl. G06F 11/00; G06F 18/241

(52) U.S. Cl. CPC G06F 11/004; G06F 18/241; G06F 2201/81

(57) ABSTRACT

The present invention relates to a medical information integration system that integrally collects and accumulates multidimensional health-related information such as medical records, biological data, genetic information, and environmental factors for each patient, comprehensively analyzes these data using a generative AI, thereby predicting a health risk for each individual with high accuracy, and automatically generating and proposing an optimal preventive medical plan at a stage before symptom onset. Furthermore, the system is also equipped with functions of real-time remote monitoring, alert notification, and automatic scheduling of a remote medical examination, thereby simultaneously realizing a reduction in the burden on medical workers, an improvement in the QOL of patients, and an elimination of medical disparity.

### CROSS-REFERENCE TO RELATED APPLICATION

The present application claims priority to and incorporates by reference the entire contents of Japanese Patent Application No. 2025-070005 filed in Japan on Apr. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that it requires an enormous amount of time and human cost for a medical worker to individually collect and analyze a wide variety and huge amount of health-related data such as medical records, real-time biological data, genetic information, and environmental factors that differ for each patient, and to design and propose an appropriate diagnosis and preventive medical plan, and that it is currently difficult to early and accurately predict a risk for each patient and individually determine an optimal intervention timing and content only by human judgment, which makes it difficult to always provide a high-quality and personalized medical service to each patient, and particularly in a situation where medical resources are limited, such as for chronic diseases, elderly people, and residents in rural areas, serious problems such as an increase in the number of medical examinations and the burden on medical workers, an expansion of medical disparity, an increase in medical expenses, and a decline in the quality of life of patients occur. Furthermore, there is also a problem that conventional diagnosis support tools and simple remote monitoring systems cannot sufficiently realize advanced functions such as learning of a long-term health pattern of a patient, prediction of a future risk, and automatic generation of an individually optimized preventive medical plan, making it difficult to early grasp a change in the health condition of the patient and perform a medical intervention at an appropriate timing.

### SUMMARY OF THE INVENTION

A means for solving the problem according to the present invention comprises: a patient medical record acquisition unit; a biological data acquisition unit; a genetic information acquisition unit; an environmental factor acquisition unit; a long-term memory management unit; a generative AI processing unit; a preventive medical plan proposal unit; and a remote monitoring cooperation unit, wherein the medical record acquisition unit is configured to acquire a diagnosis history, a treatment history, and past illness information for each patient from a database; the biological data acquisition unit is configured to acquire real-time biological information such as a heart rate, a blood pressure, a blood glucose level, a body temperature, and a respiratory rate of the patient from a wearable device or a medical device; the genetic information acquisition unit is configured to acquire a genetic marker and disease risk genetic information of the patient; the environmental factor acquisition unit is configured to acquire environmental factor data such as a lifestyle, a smoking history, a drinking history, an exercise habit, a living environment, and an occupational environment of the patient; the long-term memory management unit is configured to accumulate and manage all medical records, biological data, genetic information, and environmental factor information from the past to the present for each patient in chronological order; the generative AI processing unit is configured to integrally analyze all of these data, predict a health risk for each patient by multivariate analysis and pattern recognition, and detect an increase in risk at a stage before symptom onset; the preventive medical plan proposal unit is configured to individually generate an optimal preventive medical plan for nutrition, exercise, sleep, lifestyle improvement, and medical intervention according to a genetic tendency, a lifestyle, environmental exposure, and a past health pattern of the patient based on an analysis result of the generative AI processing unit, and propose the optimal preventive medical plan to a medical worker and the patient; the remote monitoring cooperation unit is configured to acquire biological data and medical examination data from a remote location of the patient in real time, automatically notify the medical worker when there is an abnormal value or an increase in risk, and enable a remote medical examination to be performed as necessary; and all of these processes are operated by a generative AI.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

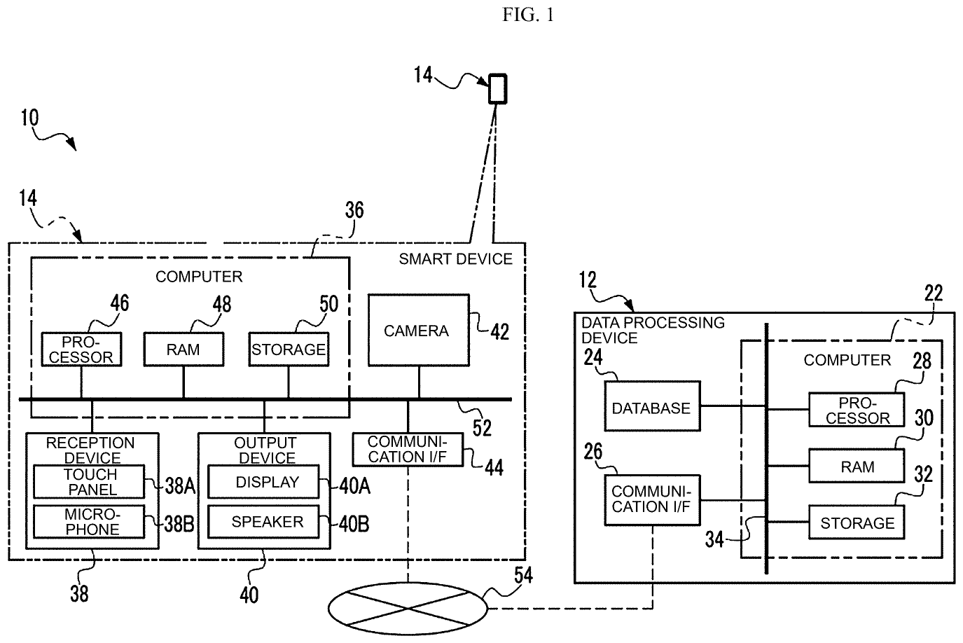

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

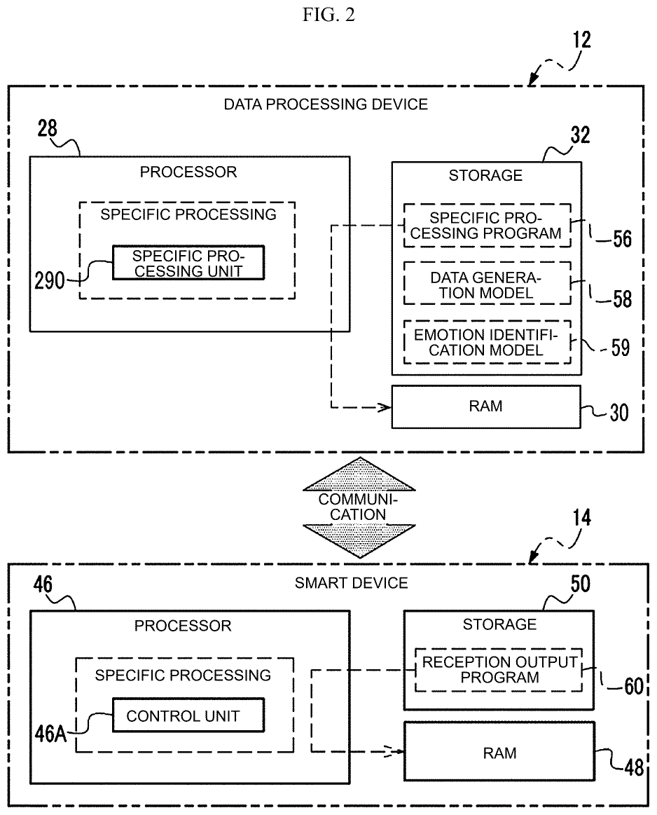

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

An embodiment of the present invention is realized as a medical information integration system composed of a server and terminals. A medical record acquisition unit, a biological data acquisition unit, a genetic information acquisition unit, an environmental factor acquisition unit, a long-term memory management unit, a generative AI processing unit, a preventive medical plan proposal unit, and a remote monitoring cooperation unit are mounted on the server side, and a patient terminal and a medical worker terminal are provided on the terminal side. The patient terminal corresponds to a smartphone, a tablet, a wearable device, a home medical device, or the like, and the medical worker terminal corresponds to a personal computer, a tablet, a dedicated medical examination terminal, or the like. Specifically, the medical information integration system adopts a distributed computing architecture. The system is composed of a plurality of arithmetic node groups. The server side includes a parallel arithmetic cluster for executing a large language model and a deep learning model at high speed. The parallel arithmetic cluster has a hardware configuration in which a plurality of graphics processing units are interconnected. The system asynchronously receives high-frequency and large-capacity chronological biological data transmitted from the terminal side. The system temporarily caches the received data in an in-memory database. The system processes the cached data by a hybrid method of batch processing and stream processing. The system applies an end-to-end encryption protocol in communication between the terminal and the server. The system executes an algorithm for dynamically compressing a communication payload. The system minimizes consumption of a network bandwidth. The system reduces a communication delay. The system realizes real-time data synchronization. The system distributes a rendered analysis result to the medical worker terminal with a low delay. The system deploys a lightened inference model to the patient terminal as edge computing. The system enables a primary analysis on the edge side. The system distributes an arithmetic load on the server side. The system improves a processing throughput of the entire system. The system functions not merely as an information collection system but as a data-driven advanced arithmetic platform. The system supports decision-making in a medical field in real time. The system is particularly effective in fields of telemedicine and preventive medicine.

First, the medical record acquisition unit operates on the server, cooperates with an electronic medical record system or a database of a medical institution, and automatically acquires a diagnosis history, a treatment history, past illness information, a medication history, allergy information, a hospitalization history, a surgery history, a test result, image diagnosis data, a vaccination history, a rehabilitation record, and the like for each patient. For example, a history of the patient being hospitalized for a heart disease in the past, information on a drug prescribed for diabetes treatment, a record of a past surgery history or an allergic reaction, a diagnosis result of an MRI or CT image, detailed numerical data of a blood test or a urine test, a vaccination date or a side reaction record, a progress record of rehabilitation, and the like correspond to this. These pieces of information are centrally managed using a patient ID as a key, and even when the patient visits a plurality of medical institutions, data of each institution can be integrated and managed in chronological order. Specifically, the medical record acquisition unit establishes a connection to an external medical information system via a secure application programming interface. The medical record acquisition unit converts a medical record described in a different data format into a standardized data schema. The medical record acquisition unit executes a natural language processing model. The natural language processing model is based on a transformer architecture. The medical record acquisition unit extracts a medical entity from unstructured text data. The medical record acquisition unit converts the extracted entity into an embedding vector on a multidimensional vector space. The medical record acquisition unit receives, for example, a chief complaint of the patient or a finding text of a doctor as an input tensor. The input tensor is a token ID array of words. The natural language processing model calculates a contextual meaning of each token by a self-attention mechanism. The natural language processing model outputs a probability distribution indicating a disease name or a drug name. The medical record acquisition unit extracts the corresponding entity when a peak value of the output probability distribution exceeds a predetermined threshold. The medical record acquisition unit links the extracted entity to a chronological profile of the patient. The medical record acquisition unit applies a convolutional neural network to the image diagnosis data. The medical record acquisition unit extracts a feature map from an image. The medical record acquisition unit saves the feature map as a numerical vector. The medical record acquisition unit constructs heterogeneous mixed data as unified graph structure data. The medical record acquisition unit defines a patient, a disease, or a drug as a node. The medical record acquisition unit defines a relationship thereof as an edge. The medical record acquisition unit prepares input data for a subsequent inference process using a graph neural network. The medical record acquisition unit automatically complements a missing value of data by a statistical complementation algorithm. The medical record acquisition unit improves data quality. The medical record acquisition unit eliminates a manual data input work by a medical worker. The medical record acquisition unit prevents a human error in data input. The medical record acquisition unit dramatically improves a processing speed of data integration. The medical record acquisition unit is applied as a data sharing platform in a wide-area medical cooperation or a community-based integrated care system.

The biological data acquisition unit acquires biological data in real time from a wearable device or a home medical device (such as a sphygmomanometer, an electrocardiograph, a blood glucose level measuring device, a thermometer, a pulse oximeter, a smart watch, an activity meter, a sleep monitor, a respiration sensor, a weight scale, or a body composition meter) on the terminal side, and transmits the biological data to the server. For example, a result of the patient measuring a blood pressure at home, a heart rate fluctuation during sleep, the number of steps or consumed calories during the day, a respiratory rate at night, a heart rate peak value during exercise, a transition of a body temperature, a blood oxygen saturation, a change in a body weight or a body fat percentage, a depth of sleep or the number of mid-wakefulness, presence or absence of a respiratory arrest event, and the like are automatically collected. These data are transmitted from the terminal to the server by encrypted communication, and are accumulated as chronological data on the server side. For example, various data acquisitions are assumed, such as the patient measuring a body temperature and a blood pressure when waking up every morning, recording a heart rate and a sleep state with a wearable device at night, and measuring a body weight, a body fat percentage, and a muscle mass with a body composition meter on weekends. Specifically, the biological data acquisition unit receives streaming data asynchronously transmitted from a plurality of sensors. The biological data acquisition unit synchronously processes the received data based on a time stamp. The biological data acquisition unit maps a plurality of types of biological data having different sampling rates onto a common chronological axis. The biological data acquisition unit executes a data interpolation algorithm. The biological data acquisition unit estimates a missing section using spline interpolation or linear interpolation. The biological data acquisition unit applies a noise removal filter. The biological data acquisition unit reduces high-frequency noise derived from a sensor using a Kalman filter or a moving average filter. The biological data acquisition unit constructs the preprocessed chronological data as a multidimensional chronological tensor. The biological data acquisition unit combines, for example, data of a heart rate, a blood pressure, and a body temperature. The biological data acquisition unit generates a two-dimensional array having a time dimension and a sensor dimension. The biological data acquisition unit inputs this chronological tensor to a subsequent abnormality detection model. The biological data acquisition unit also has a configuration for executing a lightweight machine learning model on an edge device side. The biological data acquisition unit performs a primary screening of data on the edge side. The biological data acquisition unit lowers a transmission frequency for data within a normal range. The biological data acquisition unit transmits high-resolution raw data to the server only when a sign of an abnormality is detected. The biological data acquisition unit significantly reduces a load on a communication network by this dynamic bandwidth control. The biological data acquisition unit optimizes a storage consumption amount on the server side. The biological data acquisition unit suppresses power consumption of a battery-driven wearable device. The biological data acquisition unit enables long-term continuous monitoring. The biological data acquisition unit exhibits an extremely high technical effect in home monitoring of a chronic disease patient or a watching service for an elderly person.

The genetic information acquisition unit operates on the server, receives genetic marker information and disease risk genetic information acquired by the patient at a genetic testing service or a medical institution, and manages the information for each patient. For example, specific SNP information related to a heart disease risk, a genetic predisposition to diabetes or high blood pressure, a genetic polymorphism of a drug-metabolizing enzyme, a risk gene for breast cancer or colorectal cancer, an Alzheimer's disease risk gene, a genetic tendency for obesity or dyslipidemia, a drug side effect risk gene, and the like correspond to this. These pieces of information are used for analysis by a medical worker or an AI based on the consent of the patient. For example, it is possible for the patient to upload data obtained from an external genetic testing service, or to automatically link a result of a gene panel test performed at a medical institution. Specifically, the genetic information acquisition unit encodes base sequence data or single nucleotide polymorphism data as a structured high-dimensional vector. The genetic information acquisition unit expresses presence or absence of each genetic marker or a type of mutation as a binary value or a categorical value. The genetic information acquisition unit inputs this high-dimensional vector to a dimensionality reduction algorithm. The genetic information acquisition unit extracts a latent feature vector of genetic information using principal component analysis or an autoencoder. The genetic information acquisition unit integrates the extracted latent feature vector into profile data of the patient. The genetic information acquisition unit includes a module that calculates a correlation between genetic information and phenotype data. The genetic information acquisition unit evaluates statistical significance between a specific gene mutation and a past disease onset history. The genetic information acquisition unit applies a homomorphic encryption technology that processes genetic data in an encrypted state. The genetic information acquisition unit does not decrypt genetic information even during a calculation process on the server. The genetic information acquisition unit realizes ultimate privacy protection. The genetic information acquisition unit periodically crawls the latest genome research results from an external database. The genetic information acquisition unit dynamically updates a relevance score between a genetic marker and a disease risk. The genetic information acquisition unit always maintains a genetic risk evaluation of the patient based on the latest medical knowledge. The genetic information acquisition unit is not limited to static storage of genetic information. The genetic information acquisition unit utilizes genetic information as a dynamic calculation resource. The genetic information acquisition unit functions as a fundamental technology for personalized medicine or custom-made treatment. The genetic information acquisition unit provides indispensable data in advanced medical inference such as prediction of a response rate of a specific anticancer drug or prior determination of a side effect risk.

The environmental factor acquisition unit acquires data such as a lifestyle (a smoking history, a drinking history, an exercise habit, a diet, a sleep habit, a stress level, and a medication compliance status), a living environment (an air pollution level, noise, a temperature, a humidity, a heat insulation performance of a house, and access to a surrounding medical institution), and an occupational environment (a working style, a stress level, a working environment, presence or absence of a night shift, long working hours, and an occupational health and safety status of a workplace) of the patient using an input interface on the terminal side or an external database cooperation function on the server side. For example, a case where the patient inputs the number of cigarettes smoked or an amount of drinking every day with a smartphone application, automatically acquires the number of steps or exercise intensity data from an exercise application, acquires a temperature or a PM2.5 concentration of a residential area from an external weather database, or links a stress check result of a workplace corresponds to this. Furthermore, an application in which the patient records daily meal contents with a photograph and a generative AI estimates nutrients by image analysis is also possible. Specifically, the environmental factor acquisition unit collects unstructured and semi-structured data from a wide variety of sources. The environmental factor acquisition unit applies an object detection model based on a convolutional neural network to meal image data. The environmental factor acquisition unit specifies a region of a foodstuff from an input RGB image tensor. The environmental factor acquisition unit outputs a category label of each foodstuff and coordinates of a bounding box. The environmental factor acquisition unit estimates a volume of the foodstuff using a pixel area of the specified foodstuff and distance information obtained from a depth sensor. The environmental factor acquisition unit collates the estimated volume with a foodstuff database. The environmental factor acquisition unit calculates an intake calorie or a content of three major nutrients as a numerical vector. The environmental factor acquisition unit accumulates this numerical vector as daily diet data. The environmental factor acquisition unit applies a spatial interpolation algorithm to environmental data acquired from an external weather API. The environmental factor acquisition unit estimates a concentration of fine particulate matter or a temperature and humidity at an accurate residential position of the patient. The environmental factor acquisition unit configures these pieces of environmental factor data as a chronological multivariate matrix. The environmental factor acquisition unit inputs this matrix to a subsequent causal inference model. The environmental factor acquisition unit extracts a hidden correlation between an environmental factor and a fluctuation of biological data. The environmental factor acquisition unit calculates, for example, a delayed correlation between a specific atmospheric pressure drop and a blood pressure rise of the patient. The environmental factor acquisition unit quantifies an influence of a minute environmental change that is difficult to grasp by human intuition. The environmental factor acquisition unit dramatically reduces an input burden on the patient by automating data collection. The environmental factor acquisition unit eliminates a self-reporting bias. The environmental factor acquisition unit realizes objective and highly accurate acquisition of environmental data. The environmental factor acquisition unit is extremely useful in specifying an environmental trigger for an asthma patient or in preventive management of a weather-related disease.

The long-term memory management unit operates on the server, and integrally accumulates and manages a medical record, biological data, genetic information, and environmental factor information for each patient in chronological order. For example, all data such as a blood pressure transition over the past five years, a heart rate fluctuation for each season, a blood glucose level change before and after a treatment intervention, a body weight transition before and after implementation of a lifestyle improvement program, a rehabilitation progress before and after a surgery, a sleep state before and after a hospitalization, a fluctuation of a health index accompanying a life event such as a job change or a moving, a transition of a medication compliance status, and a side reaction occurrence status after a vaccination are recorded in chronological order. Thereby, a long-term change in a health state for each patient or a fluctuation of a health index accompanying a specific event (such as a surgery, a hospitalization, a moving, a job change, a change in family structure, or an occurrence of a disaster) can be tracked in detail. Specifically, the long-term memory management unit adopts a hybrid storage architecture of a distributed graph database and a time-series database. The long-term memory management unit stores biological data generated at a high frequency in the time-series database. The long-term memory management unit stores relationship data such as a medical record or a life event in the graph database. The long-term memory management unit dynamically synchronizes an index between both databases. The long-term memory management unit speeds up a search for a complex chronological pattern. The long-term memory management unit executes a data compression algorithm. The long-term memory management unit performs feature extraction close to lossy compression on past old data to save a storage capacity. The long-term memory management unit applies lossless compression to the latest data to maintain a high resolution. The long-term memory management unit includes a data tiering function that automatically moves a storage tier according to an importance or an access frequency of data. The long-term memory management unit prevents a deterioration in search performance accompanying long-term data accumulation. The long-term memory management unit enables querying of life log data in units of decades with a latency in units of milliseconds. The long-term memory management unit extracts a biological reaction pattern at the time of a past similar event using a life event of the patient as a trigger. The long-term memory management unit provides this extracted pattern as an initial weight of a subsequent prediction model. The long-term memory management unit is not merely a data repository. The long-term memory management unit functions as a data pipeline that automatically generates a high-quality learning data set for continuous learning of an artificial intelligence model. The long-term memory management unit functions as a management platform for a personal health record throughout life. The long-term memory management unit is optimal for an application of accurately tracking a gradual change in a health state accompanying aging or a progression degree of a chronic disease.

The generative AI processing unit operates on the server and integrally analyzes all the above data. The generative AI is configured by combining a plurality of AI technologies such as natural language processing, image analysis, chronological data analysis, pattern recognition, causal inference, and a generative model. For example, a natural language processing AI is used when extracting a disease risk from a medical record of the patient, an image recognition AI is used for analysis of an electrocardiogram waveform or image data, and a chronological analysis AI is used when detecting an abnormal pattern from chronological data such as a blood pressure or a heart rate. Furthermore, the generative AI performs multivariate analysis on a genetic predisposition, a lifestyle, and an environmental factor of the patient, and predicts a future disease onset risk or symptom exacerbation risk. For example, the AI automatically calculates that a heart disease onset risk increases to several times a normal level when a specific genetic marker, a past history of high blood pressure, a lack of exercise, and a smoking habit are combined. In addition, the generative AI learns a long-term health pattern for each patient, and extracts an individual-specific pattern such as “a tendency for a blood pressure to rise every winter”, “a tendency for a blood glucose level to rise sharply after administration of a specific drug”, “a tendency for a stress index to deteriorate and a sleep quality to decline after a job change”, “a tendency for a respiratory function to decline during a hay fever season”, or “a tendency for a blood pressure to deteriorate during a period when a medication compliance rate declines”. These analysis results are automatically generated as an explanatory text or a report that is easy for a medical worker or the patient to understand, using a natural language generation function by the AI. For example, specific advice is automatically generated, such as “Since your blood pressure tends to rise in winter, let's strengthen a reduced-salt diet and exercise from November” or “Since your sleep quality has declined during the past three job changes, let's strengthen sleep monitoring after a job change”. Specifically, the generative AI processing unit adopts a multimodal neural network architecture. The generative AI processing unit projects text data, chronological numerical data, and image data onto a common latent feature space. The generative AI processing unit simultaneously receives, for example, a one-dimensional chronological array indicating a blood pressure transition of the patient over the past year, a binary vector indicating a genetic marker, and a two-dimensional tensor of the latest chest X-ray image as inputs. The generative AI processing unit applies a long short-term memory network or a one-dimensional convolutional layer to the chronological data. The generative AI processing unit applies a residual network to the image data. The generative AI processing unit applies a transformer encoder to the text data. The generative AI processing unit combines feature vectors extracted from each modality in a combining layer. The generative AI processing unit inputs the combined high-dimensional vector to a fully connected layer. The generative AI processing unit outputs a continuous value score between 0 and 1 indicating an onset probability of a specific future disease. The generative AI processing unit determines whether this score exceeds a preset warning threshold. When the threshold is exceeded, the generative AI processing unit specifies an input feature amount having a high degree of involvement by a gradient-weighted class activation mapping method. The generative AI processing unit embeds this specified feature amount and the onset probability score into a prompt of a large language model. The generative AI processing unit causes the large language model to generate a personalized warning text for the patient. The generative AI processing unit acquires character string data of a natural language as an output from the large language model. The generative AI processing unit transmits this character string data to a subsequent user interface unit. The generative AI processing unit uses a cross-entropy error function in learning of the model. The generative AI processing unit optimizes a weight of each network by an error backpropagation method. The generative AI processing unit mathematically elucidates a complex nonlinear interaction of a plurality of factors that is difficult for a human doctor to discover. The generative AI processing unit dramatically improves accuracy of diagnosis. The generative AI processing unit exhibits an immense effect in personalized risk evaluation or decision support for early intervention in preventive medicine.

The preventive medical plan proposal unit operates on the server, and automatically generates a preventive medical plan optimized for each patient based on an analysis result of the generative AI processing unit. For example, for a patient with a high heart disease risk, a plan combining “aerobic exercise three times a week”, “practice of a reduced-salt diet”, “regular electrocardiogram test”, “taking a stress management program”, and the like is proposed, and for a patient with a high diabetes risk, “calorie-restricted diet”, “blood glucose level measurement after every meal”, “strengthening of an exercise habit”, “securing sleep time”, and the like are recommended. Furthermore, the generative AI flexibly adjusts plan contents according to a living environment or an occupational environment of the patient. For example, individually optimized contents are automatically generated, such as “a diet, exercise, and sleep plan tailored to a shift” for a night shift worker, “a muscle training program for fall prevention” for an elderly person, and “a regular health check utilizing a remote medical examination” for a rural resident. Furthermore, a preference, a life rhythm, a family structure, an economic situation, a religious restriction, and the like of the patient are also considered, and fine customization is possible, such as “proposing an alternative foodstuff when it is necessary to avoid a specific food for religious reasons”, “proposing a low-cost exercise plan in consideration of an economic burden”, and “proposing a health program that can be tackled together with a family member”. These plans are automatically distributed to the patient terminal or the medical worker terminal, and contents are updated at any time according to an understanding degree or an implementation status of the patient. For example, when the patient is unable to implement the plan, the AI performs a cause analysis and automatically generates an easy-to-implement alternative plan or advice for maintaining motivation. Specifically, the preventive medical plan proposal unit includes a hybrid inference engine combining a reinforcement learning algorithm and a constrained optimization solver. The preventive medical plan proposal unit searches for an action sequence that minimizes a distance between a current health state vector and a target health state vector of the patient. The preventive medical plan proposal unit receives a disease risk score, a living environment parameter, and a categorical variable indicating an economic restriction of the patient as inputs. The preventive medical plan proposal unit calculates an expected reward of various intervention plans in a simulation environment based on a Markov decision process. The preventive medical plan proposal unit defines an improvement degree of a health index as a positive reward and an execution difficulty or an economic cost of a plan as a negative penalty as a reward function. The preventive medical plan proposal unit generates structured JSON data including a list of specific action tasks, a recommended execution frequency of each task, and a priority score as an output. The preventive medical plan proposal unit inputs this structured data to a large language model. The preventive medical plan proposal unit converts the structured data into a proposal text of a natural language tailored to a health literacy level of the patient. The preventive medical plan proposal unit continuously monitors task execution history data fed back from the terminal of the patient. The preventive medical plan proposal unit determines that a difficulty level of the plan is too high when an uncompleted rate of a task exceeds a certain threshold. The preventive medical plan proposal unit dynamically updates a parameter of a reinforcement learning model. The preventive medical plan proposal unit recalculates an alternative task with higher executability. The preventive medical plan proposal unit dramatically improves compliance of the patient by this adaptive feedback loop. The preventive medical plan proposal unit fundamentally overturns a conventional guidance method based on a uniform guideline. The preventive medical plan proposal unit realizes dynamic health management completely synchronized with an individual lifestyle. The preventive medical plan proposal unit functions as a specific solution for preventing aggravation of a lifestyle-related disease or reducing medical expenses.

The remote monitoring cooperation unit operates on the server, receives biological data in real time from a home medical device or a wearable device of the patient, and sequentially transmits the biological data to the generative AI processing unit. The generative AI analyzes the received data in real time, and when detecting an abnormal value or an increase in risk, automatically issues an alert notification to the medical worker terminal. For example, when a heart rate rises sharply, when a blood glucose level reaches a dangerous range, or when a respiratory arrest is detected during sleep, a medical worker is immediately notified, and scheduling of a remote medical examination or an emergency response is performed as necessary. In addition, when the patient has mobility difficulty or lives in a rural area, the AI automatically determines whether a remote medical examination can be performed, and notifies both the patient and the medical worker of a schedule for the remote medical examination. For example, a remote medical examination can be flexibly utilized according to various situations, such as when the patient is elderly and has difficulty visiting a hospital, when it is necessary to refrain from going out during an infectious disease epidemic, or when access to a medical institution is difficult at the time of a disaster occurrence. Specifically, the remote monitoring cooperation unit adopts an event-driven stream processing architecture. The remote monitoring cooperation unit asynchronously processes thousands of biological data packets per second via a message queuing system. The remote monitoring cooperation unit applies a sliding window type abnormality detection algorithm to the received chronological data stream. The remote monitoring cooperation unit receives an electrocardiogram waveform tensor or a continuous numerical array of a blood oxygen saturation for the latest several minutes as input data. The remote monitoring cooperation unit reconstructs the input data using an autoencoder-based neural network. The remote monitoring cooperation unit calculates a reconstruction error between the input data and the reconstructed data. The remote monitoring cooperation unit outputs this reconstruction error as an abnormality degree score. The remote monitoring cooperation unit determines that a critical event has occurred when the abnormality degree score exceeds a dynamically set threshold. The remote monitoring cooperation unit activates a subsequent alert generation module using this determination result as a trigger. The remote monitoring cooperation unit comprehensively evaluates position information of the patient, a severity of a vital sign, and an acceptable status of a neighboring medical institution in the alert generation module. The remote monitoring cooperation unit determines an optimal response action. The remote monitoring cooperation unit immediately executes an automatic request protocol for an ambulance or a push notification to an attending doctor. The remote monitoring cooperation unit executes a decision tree algorithm for determining necessity of a remote medical examination. The remote monitoring cooperation unit receives a mobility ability score or an infectious disease risk index of the patient as an input. The remote monitoring cooperation unit outputs a binary flag indicating eligibility for a remote medical examination. The remote monitoring cooperation unit automatically generates a session URL of a video conference system when this flag is true. The remote monitoring cooperation unit automatically registers a schedule in a calendar of a related person. The remote monitoring cooperation unit minimizes a delay in medical intervention. The remote monitoring cooperation unit dramatically improves a prognosis of an acute disease. The remote monitoring cooperation unit plays an extremely important role in eliminating a disparity in medical access in a depopulated area or preventing a medical collapse during a pandemic.

Furthermore, the generative AI automatically adjusts an explanatory text or plan contents according to an understanding degree or an implementation status of the patient, and realizes optimal information provision according to a user attribute, for example, by explaining in plain expressions to an elderly person and adding a specialized explanation to a medical worker. For example, when the patient is unable to understand the plan contents, it is possible to automatically generate an explanation using an illustration or a moving image, and to generate a multilingual explanatory text for a foreign language speaker. Specifically, the generative AI applies a conditional text generation technology in a decoder part of a natural language generation model. The generative AI receives structured data of a medical analysis result and an attribute vector of a target user as inputs. The attribute vector includes a numerical parameter indicating an age group, an expertise level, a mother tongue, or a visual cognitive ability. The generative AI embeds these input parameters as a context of a prompt. The generative AI applies difficulty adjustment of vocabulary or length restriction of a phrase according to a reading comprehension score of the user. The generative AI generates a customized text character string as an output. The generative AI executes a text-to-image conversion model in parallel in addition to text generation. The generative AI dynamically renders pixel data of infographics or an animation that visually complements a semantic content of the generated text. The generative AI collects log data of a scroll speed, a stay time, or a click operation on the terminal of the user. The generative AI executes a classification model for estimating an understanding degree of the user from this log data. The generative AI further finely divides a granularity of explanation when it is determined that the understanding degree is low. The generative AI activates an interactive chatbot interface to directly extract a question of the user. The generative AI eliminates asymmetry of medical information by this adaptive information presentation mechanism. The generative AI technically ensures informed consent of the patient. The generative AI completely abolishes a communication barrier in an international hospital having multinational patients or community medicine where aging is progressing.

In addition, the generative AI can anonymize and aggregate data of a plurality of patients to analyze a risk tendency and a preventive effect at a population level, and can also be utilized for proposing a health promotion measure for an entire region and optimizing medical resource allocation to a medical institution or an administrative agency. For example, when a heart disease risk is increasing in a specific region, the AI can also propose implementation of a health awareness program or a mass screening for local residents. Furthermore, during an infectious disease epidemic, the generative AI can aggregate fever data and cough symptom data of patients, early detect a sign of infection spread, and notify the administrative agency. Specifically, the generative AI applies a federated learning architecture or a secure multi-party computation technology. The generative AI integrally analyzes data among a plurality of facilities without invading individual privacy. The generative AI performs a local gradient calculation on a terminal of each patient or an edge server of each medical institution. The generative AI aggregates only the calculated gradient information to a central server. The generative AI updates a weight of a global model. The generative AI receives, as input data, a time-series tensor of an anonymized symptom onset frequency and the number of abnormality detections of vital signs linked to a specific geographical mesh code. The generative AI executes a spatiotemporal graph convolutional network. The generative AI simultaneously models a spatial adjacency relationship and a chronological transition. The generative AI generates, as an output, a numerical matrix indicating heat map data of a future disease occurrence probability in each region and a predicted value of the required number of hospital beds. The generative AI inputs this prediction matrix to a subsequent optimization algorithm. The generative AI calculates an optimal allocation plan for limited medical staff and medical supplies. The generative AI outputs a sign of an infectious disease cluster occurrence as a probabilistic score several days to several weeks in advance. The generative AI automatically transmits an API request to an administrative dashboard system when this score exceeds an alert level. The generative AI supports public health decision-making in a data-driven manner. The generative AI eliminates a time lag in an epidemiological investigation. The generative AI functions as a city-level healthcare operating system in a smart city. The generative AI provides an extremely powerful technical foundation in pandemic countermeasures and medical triage during a disaster.

As described above, the embodiment of the present invention is an extremely practical and highly scalable medical information integration system that comprehensively and highly accurately realizes from individual optimization for each patient to health management at a population level, with the generative AI at the core under the role sharing of the server and the terminal. For example, a major feature of the present invention is that a series of flows can be fully automatically realized, such as automatically collecting data (such as the number of steps, sleep, meals, stress, temperature, noise, air quality, and medication status) unconsciously acquired in the daily life of the patient, comprehensively analyzing these by the generative AI, predicting a future health risk, individually proposing an optimal preventive measure, immediately notifying a medical worker in the event of an abnormality, and automatically scheduling a remote medical examination or an emergency response as necessary. Furthermore, an important feature of the present invention is that fine individual optimization can be realized by integrally considering various factors that could not be fully considered in a conventional medical system, such as a living environment, a social background, an economic situation, a family structure, a preference, and a religious restriction of the patient. Specifically, the system is deployed on a cloud infrastructure as a group of containerized modules based on a microservices architecture. The system has a configuration in which each functional module can be independently scaled out. The system dynamically activates an auto-scaling function in response to a rapid increase in data traffic. The system maximizes availability and fault tolerance of the entire system. The system is fundamentally different from a conventional electronic medical record system that merely records and displays data. The system constructs an advanced arithmetic pipeline that processes multidimensional heterogeneous data in real time. The system extracts a complex correlation exceeding human cognitive limits by a deep learning model. The system feeds back the extracted knowledge as an immediately executable action plan. The system functions as a closed-loop control system. The system completely automates a series of processes from data collection to analysis, intervention, and re-evaluation of results. The system dramatically reduces a workload of a medical worker. The system equalizes the quality of medical services. The system strongly promotes an improvement in patient compliance and behavior modification by the power of an algorithm. The system completely shifts a paradigm of preventive medicine from a reactive type to a predictive preemptive type. The system functions as a de facto standard for a next-generation digital healthcare platform. The system has a wide range of application possibilities as a foundation for constructing a dynamic pricing model by an insurance company and collecting real-world data by a pharmaceutical company.

### (System Configuration)

The system according to the present embodiment comprises a medical record acquisition unit, a biological data acquisition unit, a genetic information acquisition unit, an environmental factor acquisition unit, a long-term memory management unit, a generative AI processing unit, a preventive medical plan proposal unit, a remote monitoring cooperation unit, a user interface unit, and a security management unit.

The medical record acquisition unit cooperates with an electronic medical record system or a medical examination database of a medical institution, and automatically acquires a wide variety of medical information such as a diagnosis history, a treatment history, past illness information, a medication history, allergy information, a hospitalization history, a surgery history, a test result, image diagnosis data, a vaccination history, and a rehabilitation record for each patient. For example, a hospitalization history for a heart disease, a drug prescription history for diabetes treatment, a record of a past surgery or an allergic reaction, a diagnosis result of an MRI or CT image, detailed numerical data of a blood test or a urine test, a vaccination date or a side effect record, a progress record of rehabilitation, and the like are comprehensively collected and centrally managed using a patient ID as a key. Furthermore, even for a patient who visits a plurality of medical institutions, data of each institution can be integrated and managed in chronological order. Specifically, the medical record acquisition unit includes a data integration engine that cooperates with a distributed database system. The medical record acquisition unit parses incompatible data formats output from electronic medical record systems of different vendors in real time. The medical record acquisition unit converts the extracted data into structured data in a JSON format compliant with an international standard medical information exchange standard. The medical record acquisition unit uses both rule-based syntax analysis and machine learning-based semantic analysis in this conversion process. The medical record acquisition unit receives, for example, a doctor's finding described in free text as an input. The medical record acquisition unit specifies a token indicating a disease name, a part, or a severity using a named entity recognition model. The medical record acquisition unit automatically maps the specified token to a code system of a standard disease name master. The medical record acquisition unit stores the mapped code in an integrated profile database of the patient. The medical record acquisition unit analyzes header information in a DICOM format for image diagnosis data. The medical record acquisition unit extracts image pixel data as a three-dimensional tensor. The medical record acquisition unit normalizes this three-dimensional tensor according to an input format of a subsequent image recognition model. The medical record acquisition unit executes a data cleansing algorithm that detects data duplication or contradiction. The medical record acquisition unit integrates, for example, drugs with the same component prescribed in different hospitals by a name identification process. The medical record acquisition unit completely eliminates siloing of medical data. The medical record acquisition unit constructs a comprehensive and accurate longitudinal data set of the patient. The medical record acquisition unit fundamentally supports inference accuracy of a machine learning model. The medical record acquisition unit functions as a hub system of a regional medical information network.

The biological data acquisition unit acquires biological data in real time from a wearable device, a home medical device, a smartphone application, or the like worn by the patient, and transmits the biological data to the server. For example, various biological data are automatically collected, such as blood pressure and electrocardiogram data from a sphygmomanometer and an electrocardiograph, a blood glucose level from a blood glucose level measuring device, a body temperature from a thermometer, a blood oxygen saturation from a pulse oximeter, the number of steps and consumed calories from a smart watch and an activity meter, a sleep depth and the number of mid-wakefulness from a sleep monitor, a respiratory rate and a respiratory arrest event from a respiration sensor, and a body weight, a body fat percentage, and a muscle mass from a weight scale and a body composition meter. For example, various data acquisitions are assumed, such as the patient measuring a body temperature and a blood pressure when waking up every morning, recording a heart rate and a sleep state with a wearable device at night, and measuring a body weight, a body fat percentage, and a muscle mass with a body composition meter on weekends. These data are transmitted from the terminal to the server by encrypted communication, and are accumulated as time-series data on the server side. Specifically, the biological data acquisition unit cooperates with an edge gateway module implementing an IoT device management protocol. The biological data acquisition unit receives a raw data stream in a binary format from each sensor device connected via Bluetooth or Wi-Fi. The biological data acquisition unit decodes this raw data stream. The biological data acquisition unit converts the raw data stream into an array of floating-point numbers indicating physical quantities. The biological data acquisition unit adds a time stamp and a device ID to the converted data. The biological data acquisition unit queues this data in a write buffer of a time-series database. The biological data acquisition unit implements a retransmission control mechanism to ensure reliability of data transmission. The biological data acquisition unit temporarily stores data in a local storage on an edge device side when a network is disconnected. The biological data acquisition unit automatically synchronizes difference data when communication is restored. The biological data acquisition unit executes a fast Fourier transform on an edge side for data with a high sampling rate such as an electrocardiogram waveform. The biological data acquisition unit extracts a feature vector in a frequency domain. The biological data acquisition unit transmits only this feature vector to the server. The biological data acquisition unit dramatically reduces consumption of a communication band by this edge computing technology. The biological data acquisition unit distributes a data processing load on the server side. The biological data acquisition unit enables highly real-time vital sign monitoring. The biological data acquisition unit exhibits an extremely high technical effect in early detection of arrhythmia and screening for sleep apnea syndrome.

The genetic information acquisition unit receives genetic marker information and disease risk genetic information acquired by the patient at a genetic testing service or a medical institution, and manages the information for each patient. For example, specific SNP information related to a heart disease risk, a genetic predisposition to diabetes or high blood pressure, a genetic polymorphism of a drug-metabolizing enzyme, a risk gene for breast cancer or colorectal cancer, an Alzheimer's disease risk gene, a genetic tendency for obesity or dyslipidemia, a drug side effect risk gene, and the like correspond to this. It is possible for the patient to upload data obtained from an external genetic testing service, or to automatically link a result of a gene panel test performed at a medical institution. Furthermore, a family history, a disease tendency of a relative, and the like are also supplementarily acquired to improve accuracy of genetic risk evaluation. Specifically, the genetic information acquisition unit includes a dedicated bioinformatics pipeline that processes large-capacity genome sequence data output from a next-generation sequencer. The genetic information acquisition unit extracts data of a specific single nucleotide polymorphism or insertion-deletion mutation from an input VCF format file. The genetic information acquisition unit aligns the extracted mutation data with a reference genome sequence. The genetic information acquisition unit scores a pathological significance of each mutation by collating it with an annotation database. The genetic information acquisition unit encodes this score as a multidimensional genetic risk vector. The genetic information acquisition unit links this vector to a master record of the patient. The genetic information acquisition unit adopts a graph data structure to process family history data. The genetic information acquisition unit constructs a family tree originating from the patient as a network of nodes and edges. The genetic information acquisition unit adds an attribute of a disease history to each node. The genetic information acquisition unit applies a network propagation algorithm to this graph data. The genetic information acquisition unit calculates a potential genetic risk probability in an unaffected relative. The genetic information acquisition unit provides the calculated probability value as a prior probability for a subsequent disease prediction model. The genetic information acquisition unit functions not as a static repository of genetic information but as a dynamic risk calculation engine. The genetic information acquisition unit accelerates integrated analysis of genomic data and clinical data. The genetic information acquisition unit provides an indispensable technical foundation in supporting optimal drug selection and dose determination based on pharmacogenomics.

The environmental factor acquisition unit multilaterally acquires data such as a lifestyle, a living environment, and an occupational environment of the patient. For example, the environmental factor acquisition unit acquires lifestyle data such as a smoking history, a drinking history, an exercise habit, a diet, a sleep habit, a stress level, and a medication compliance status, living environment data such as an air pollution level, noise, a temperature, a humidity, a heat insulation performance of a house, and access to a surrounding medical institution in a residence, and occupational environment data such as a working style, a stress level, a working environment, presence or absence of a night shift, long working hours, and an occupational health and safety status. A case where the patient inputs the number of cigarettes smoked or an amount of alcohol consumed every day using a smartphone application, automatically acquires the number of steps or exercise intensity data from an exercise application, acquires a temperature or a PM2.5 concentration in a residential area from an external weather database, or links a stress check result at a workplace corresponds to this. Furthermore, an application is also possible in which the patient records daily meal contents with a photograph, and the generative AI estimates nutrients by image analysis. Specifically, the environmental factor acquisition unit adopts a data lake architecture that integrates heterogeneous data asynchronously collected from various data sources. The environmental factor acquisition unit receives, as an input, a time-series coordinate array of position information acquired from a GPS sensor of a smartphone. The environmental factor acquisition unit analyzes this coordinate array by a spatial clustering algorithm. The environmental factor acquisition unit automatically specifies a polygon region of a home, a workplace, or a frequently visited place of the patient. The environmental factor acquisition unit transmits a query to an external environmental data API using barycentric coordinates of this specified region. The environmental factor acquisition unit acquires time-series data of a fine particulate matter concentration, an ultraviolet index, and a noise level in the corresponding area. The environmental factor acquisition unit resamples and combines the acquired environmental data on the same time axis as the biological data of the patient. The environmental factor acquisition unit applies a semantic segmentation model to meal image data. The environmental factor acquisition unit outputs, as a probability tensor, which food ingredient class each pixel in the image belongs to. The environmental factor acquisition unit calculates a region area of the food ingredient from this probability tensor. The environmental factor acquisition unit estimates a weight of each food ingredient using an area ratio and standard density data. The environmental factor acquisition unit calculates a nutrient content as a numerical vector from the estimated weight. The environmental factor acquisition unit completely automates quantification of environmental factors by this series of processes. The environmental factor acquisition unit constructs an objective data set that does not depend on a subjective declaration of the patient. The environmental factor acquisition unit exhibits extremely high usefulness in analysis of an epigenetic effect of an environmental factor on health and a public health epidemiological investigation.

The long-term memory management unit integrally accumulates and manages medical records, biological data, genetic information, and environmental factor information for each patient in chronological order. For example, all data are recorded in chronological order, such as a blood pressure transition over the past five years, a heart rate fluctuation for each season, a blood glucose level change before and after a treatment intervention, a body weight transition before and after implementation of a lifestyle improvement program, a rehabilitation progress before and after a surgery, a sleep state before and after a hospitalization, a fluctuation of a health index accompanying a life event such as a job change or a moving, a transition of a medication compliance status, and an occurrence status of a side effect after a vaccination. Thereby, a long-term change in a health state for each patient and a fluctuation of a health index accompanying a specific event (such as a surgery, a hospitalization, a moving, a job change, a change in a family structure, or an occurrence of a disaster) can be tracked in detail. Specifically, the long-term memory management unit adopts a distributed columnar database capable of processing petabyte-class data with low latency. The long-term memory management unit partitions data using a patient ID and a time stamp as a composite primary key. The long-term memory management unit scans data within a specific time window at high speed in response to a search query for time-series data. The long-term memory management unit applies delta encoding and run-length encoding algorithms for data compression. The long-term memory management unit stores only a difference between continuous biological data. The long-term memory management unit significantly reduces a physical capacity of a storage. The long-term memory management unit executes an event-driven data tagging engine in the background. For example, when detecting a flag of surgery implementation from an electronic medical record, the long-term memory management unit automatically adds a metadata tag to biological data for several months before and after the surgery. The long-term memory management unit optimizes an execution speed of an SQL query for extracting a transition of a health index before and after a specific event using this metadata tag. The long-term memory management unit automatically executes a data lifecycle management policy. The long-term memory management unit transparently migrates old data with a decreased access frequency to an inexpensive cold storage. The long-term memory management unit minimizes a system operation cost by this tiered storage management. The long-term memory management unit safely holds a huge amount of healthcare data over a lifetime without omission. The long-term memory management unit provides an indispensable data foundation for a subsequent deep learning model to learn a long-term time dependency. The long-term memory management unit exhibits a tremendous effect in long-term prognosis prediction of a chronic disease and modeling of a physiological change accompanying aging.

The generative AI processing unit integrally analyzes all the above data. The generative AI is configured by combining a plurality of AI technologies such as natural language processing, image analysis, time-series data analysis, pattern recognition, causal inference, and a generative model. For example, a natural language processing AI is used when extracting a disease risk from a medical record of the patient, an image recognition AI is used for analyzing an electrocardiogram waveform or image data, and a time-series analysis AI is used when detecting an abnormal pattern from time-series data such as a blood pressure or a heart rate. Furthermore, the generative AI performs multivariate analysis on a genetic predisposition, a lifestyle, and an environmental factor of the patient, and predicts a future disease onset risk or symptom exacerbation risk. For example, the AI automatically calculates that a heart disease onset risk increases to several times a normal level when a specific genetic marker is combined with a past history of high blood pressure, lack of exercise, and a smoking habit. In addition, the generative AI learns a long-term health pattern for each patient, and extracts an individual-specific pattern such as “a tendency for a blood pressure to increase every winter”, “a tendency for a blood glucose level to rapidly increase after administration of a specific drug”, “a tendency for a stress index to worsen and a sleep quality to decrease after a job change”, “a tendency for a respiratory function to decrease during a hay fever season”, or “a tendency for a blood pressure to worsen when a medication compliance rate decreases”. These analysis results are automatically generated as an explanatory text or a report easy to understand for a medical worker or the patient using a natural language generation function by the AI. For example, specific advice is automatically generated, such as “Since your blood pressure tends to increase in winter, let's strengthen a reduced-salt diet and exercise from November” or “Since your sleep quality has decreased during the past three job changes, let's strengthen sleep monitoring after a job change”. Specific examples of a prompt sentence to be read by the generative AI include “Based on the following patient data, predict a future heart disease risk and generate a lifestyle improvement plan for risk reduction. Patient data: age 55, male, past history: high blood pressure and diabetes, genetic information: heart disease risk gene positive, lifestyle: smoking history present, exercise habit absent, diet: high-fat diet, latest blood pressure value: 150/95, latest blood glucose level: 140 mg/dL, residence: urban area, occupation: night shift present, stress level high.” and the like. Specifically, the generative AI processing unit adopts an ensemble learning architecture. The generative AI processing unit executes a gradient boosting decision tree model and a deep neural network model in parallel. The generative AI processing unit receives, as input data, a high-dimensional feature tensor obtained by combining a scalar value such as an age or a blood pressure value of the patient, a binary vector of genetic information, and a text embedding vector of a past medical record. The generative AI processing unit inputs this feature tensor to each model. The generative AI processing unit normalizes a logit value of a disease onset probability output from each model by a softmax function. The generative AI processing unit calculates a weighted average of the normalized probability values as a final risk score. The generative AI processing unit activates a causal inference module when this risk score exceeds a predetermined threshold. The generative AI processing unit specifies which input feature amount contributes most to an increase in the risk score by probabilistic inference using a Bayesian network. The generative AI processing unit formats this specified contribution degree ranking and risk score as structured data. The generative AI processing unit dynamically inserts this structured data into an input prompt of a large language model. The generative AI processing unit causes the large language model to execute autoregressive token generation. The generative AI processing unit generates, as an output, natural language text data prompting a specific behavior modification for the patient. The generative AI processing unit transmits this text data to a subsequent user interface unit. The generative AI processing unit does not make an inference process of the model a black box. The generative AI processing unit quantitatively visualizes a contribution degree of each feature amount using a Shapley additive explanation method. The generative AI processing unit completely satisfies a requirement as an explainable AI for a medical worker. The generative AI processing unit brings about an extremely high technical effect in improving accuracy of diagnosis support and speeding up decision-making of a doctor.

The preventive medical plan proposal unit automatically generates a preventive medical plan optimized for each patient based on an analysis result of the generative AI processing unit. For example, for a patient with a high heart disease risk, a plan combining “aerobic exercise three times a week”, “practice of a reduced-salt diet”, “regular electrocardiogram examination”, “taking a stress management program”, and the like is proposed, and for a patient with a high diabetes risk, “calorie-restricted diet”, “blood glucose level measurement after every meal”, “strengthening of exercise habit”, “securing sleep time”, and the like are recommended. Furthermore, the plan content is flexibly adjusted according to a living environment and an occupational environment of the patient. For example, individually optimized contents such as a “diet, exercise, and sleep plan tailored to a shift” for a night shift worker, a “muscle strength training program for fall prevention” for an elderly person, and a “regular health check utilizing a remote medical examination” for a person living in a rural area are automatically generated. Furthermore, a preference, a life rhythm, a family structure, an economic situation, a religious restriction, and the like of the patient are also considered, and fine customization is possible, for example, “proposing alternative ingredients when it is necessary to avoid a specific food for religious reasons”, “proposing a low-cost exercise plan in consideration of an economic burden”, and “proposing a health program that can be worked on together with a family member”. As a specific example of a prompt sentence to be read by the generative AI, “Generate an optimal preventive medical plan in Japanese considering a living environment, a preference, and an economic situation of a patient based on the following health risk analysis result of the patient. Patient information: age 68, female, past medical history: osteoporosis, exercise habit: walk once a week, family structure: living with husband, economic situation: living on a pension, preference: mainly Japanese food, religious restriction: specific meat not allowed.” and the like can be cited. Specifically, the preventive medical plan proposal unit adopts a retrieval-augmented generation architecture in which a knowledge graph and a large language model are integrated. The preventive medical plan proposal unit receives a multidimensional vector indicating a disease risk score, a living environment parameter, and an economic restriction of the patient as an input. The preventive medical plan proposal unit searches a vector database storing medical evidence and clinical guidelines using this input vector as a query. The preventive medical plan proposal unit extracts a list of the most relevant intervention tasks by cosine similarity calculation. The preventive medical plan proposal unit combines this extracted task list and the restriction condition of the patient as a context of a prompt. The preventive medical plan proposal unit inputs this combined prompt to the large language model. The preventive medical plan proposal unit causes the large language model to generate text data including a specific schedule and an alternative plan satisfying the restriction condition. The preventive medical plan proposal unit applies a rule-based filtering process to the output text data. The preventive medical plan proposal unit automatically verifies whether a medically contraindicated combination or a logical contradiction is included. The preventive medical plan proposal unit push-notifies the text data that has passed this verification to a terminal of the patient as a final preventive medical plan. The preventive medical plan proposal unit continuously monitors a completion flag of a task and a fluctuation of biological data transmitted from the terminal of the patient. The preventive medical plan proposal unit calculates a reward function for evaluating effectiveness of the plan. The preventive medical plan proposal unit dynamically fine-tunes a search weight and a parameter of a prompt at the time of next plan generation based on a value of this reward function. The preventive medical plan proposal unit continuously improves personalization accuracy of the plan by this self-optimization loop. The preventive medical plan proposal unit scientifically and efficiently induces a behavioral change of the patient. The preventive medical plan proposal unit provides an extremely powerful solution in prevention of a lifestyle-related disease and extension of a healthy life expectancy.

The remote monitoring cooperation unit receives biological data in real time from a home medical device or a wearable device of the patient, and sequentially transmits the biological data to the generative AI processing unit. The generative AI analyzes the received data in real time, and when detecting an abnormal value or an increase in risk, automatically issues an alert notification to a medical worker terminal. For example, when a heart rate rapidly increases, when a blood glucose level reaches a dangerous range, or when a respiratory arrest is detected during sleep, a medical worker is immediately notified, and scheduling of a remote medical examination or an emergency response is performed as necessary. In addition, when the patient has mobility difficulty or lives in a rural area, the AI automatically determines whether a remote medical examination can be performed, and notifies both the patient and the medical worker of a schedule of the remote medical examination. As a specific example of a prompt sentence to be read by the generative AI, “Analyze the following real-time biological data, and when detecting an abnormal value or an increase in risk, generate a content to be notified to a medical worker and a recommended countermeasure in Japanese. Biological data: heart rate 120 bpm, blood pressure 160/100, blood glucose level 180 mg/dL, presence of respiratory arrest event during sleep.” and the like can be cited. Specifically, the remote monitoring cooperation unit includes a data collection module utilizing edge computing technology. This module receives biological signals asynchronously transmitted from a plurality of sensor nodes. This module converts the received analog signals into digital data. This module generates chronological array data at a sampling rate of 100 hertz. This module inputs the generated chronological array data to a noise removal filter. This filter reduces high-frequency noise using a moving average method. This module transmits the preprocessed chronological array data to the generative AI processing unit. The generative AI processing unit implements a multimodal neural network in which a large language model and a time-series prediction model are integrated. This network adopts a transformer architecture having a self-attention mechanism. Input data to this network is configured in a multidimensional tensor format. This input tensor includes a numerical vector indicating a heart rate, a blood pressure, a blood glucose level, and a respiratory state. The number of dimensions of this input tensor is, for example, 128 dimensions. As specific examples of this input data, there are a heart rate vector of 120 beats per minute, a blood pressure vector of 160 to 100, and a blood glucose level vector of 180 milligrams per deciliter. This network maps the input tensor to a high-dimensional feature space. This network calculates a Mahalanobis distance between a past normal data distribution and current input data. This network calculates an abnormality score based on the calculated distance. Output data from this network is a combination of a floating-point number indicating an abnormality probability and a natural language text indicating a recommended action. As specific examples of this output data, there are an abnormality probability score of 95 percent, text data recommending emergency transport, and a control command instructing a reservation for a remote medical examination. The system compares the output abnormality probability score with a preset threshold value. The system activates an alert generation module when the score exceeds the threshold value. This module transmits an immediate notification packet to the medical worker terminal. The system drives a scheduler based on the output control command. This scheduler searches for free time and automatically registers a schedule for a remote medical examination in a database. By this process, the system realizes real-time and highly accurate abnormality detection without depending on human visual monitoring. The system significantly reduces a cognitive load on a medical worker. Since the system transmits only important alerts without compressing a communication band, consumption of network resources is optimized. This technology is extremely useful in a use case such as home medical monitoring of an elderly person in a depopulated area.

A user interface unit provides interface functions such as data input, plan confirmation, alert reception, and remote medical examination participation in a patient terminal and a medical worker terminal. For example, a patient inputs a daily physical condition and lifestyle using a smartphone application, and automatically transmits biological data using a wearable device, and a medical worker confirms an AI-generated report and plan using a personal computer, and performs a remote medical examination with the patient as necessary. Furthermore, an explanatory text and a plan content are automatically adjusted according to a comprehension level and an implementation status of the patient, and optimal information provision according to a user attribute is realized, such as explaining in plain expressions to an elderly person and adding a specialized explanation to a medical worker. Specifically, the user interface unit functions as a front-end module including a dynamic rendering engine. This module automatically optimizes a display layout according to a screen size and a resolution of the terminal. This module provides an API endpoint that receives input data from the patient terminal. This module serializes the input text data and biological data. This module transmits the serialized data to a server via a secure communication protocol. The server analyzes the received data and extracts attribute information of a user. The server drives a natural language generation model based on the extracted attribute information. This model receives an age, a literacy level, and presence or absence of specialized knowledge of the user as input parameters. Input data to this model is an original text including a medical technical term and a vector of a categorical variable indicating a target attribute. As specific examples of this input data, there are a pathological explanatory text of myocardial infarction, a flag variable indicating an elderly person, and a flag variable indicating a non-medical worker. This model projects the input vector into a latent space. This model reconstructs the text while selecting a plain vocabulary using a decoder network. Output data from this model is a natural language text whose difficulty level is adjusted and metadata for display. As specific examples of this output data, there are a plain explanatory text that it is a disease in which a blood vessel of a heart is clogged, a control flag for enlarging a character size, and ruby data for voice reading. The user interface unit executes a screen drawing process based on the output metadata. This unit applies a color scheme pattern with an increased contrast ratio for an elderly person. This unit generates a dashboard that superimposes and displays a chronological graph and detailed numerical data for a medical worker. By this process, the system improves accuracy of information transmission to diverse users. The system reduces a risk of a medical accident caused by an erroneous operation or a lack of understanding of a user. The system eliminates a manual update work of a system administrator by automating generation of display contents. This technology is applicable to a use case such as a community-based integrated care system used by multiple generations or a telemedicine platform in which a specialist and a general patient share information.

A security management unit performs an encryption process on all data communications and data storage, and implements security measures such as anonymization of patient information, access authority management, multi-factor authentication, audit log recording, and unauthorized access detection. For example, communication encryption by TLS is performed when transmitting and receiving patient data, AES encryption is performed on a database on a server, an access authority is finely set for each medical worker, and a third party is prevented from browsing data unless there is consent of a patient. Furthermore, a security audit log of the entire system is recorded, and an AI automatically detects a sign of unauthorized access or information leakage and notifies an administrator. Specifically, the security management unit executes generation and storage of an encryption key in cooperation with a hardware security module. This unit establishes mutual authentication based on a public key infrastructure between a data transmission source and a reception destination. This unit encrypts a communication path end-to-end using a transport layer security protocol. This unit applies an advanced encryption standard algorithm to each record stored in the database. This unit converts personal identification information of a patient into irreversible anonymized data using a hash function. This unit expands a role-based access control list on a memory. This unit executes a multi-factor authentication process including a one-time password and biometric authentication in response to an authentication request of a user. This unit records all transactions occurring in the system together with a time stamp as an audit log in an append-only database. This unit implements an abnormality detection AI model that monitors the recorded log data in real time. This model adopts an autoencoder-type neural network architecture. Input data to this model is a multidimensional feature vector including an access time, an IP address, a URI of a requested resource, and a data transfer amount. As specific examples of this input data, there are an access time vector of 2:00 a.m., a categorical variable indicating an overseas IP address, and a query vector requesting a large amount of medical record data. This model compresses the input vector into a low-dimensional latent representation. This model reconstructs an original feature vector from the latent representation. This model calculates a reconstruction error between the input vector and the reconstruction vector. Output data from this model is a threat score based on the reconstruction error and a contribution vector indicating an abnormality factor. As specific examples of this output data, there are a threat score of 99 percent, a flag indicating an abnormality of an IP address, and a flag indicating an abnormality of a data transfer amount. When the output threat score exceeds a specified threshold value, this unit immediately forcibly disconnects a corresponding session. This unit transmits an emergency alert to a terminal of an administrator. By this process, the system prevents information leakage due to an unknown cyber attack or internal fraud. The system shortens a delay time from detection of a security incident to a response to a millisecond unit. This technology becomes an indispensable fundamental technology in a use case such as a large-scale medical data center handling sensitive personal information or a wide-area medical information network in which a plurality of medical institutions cooperate.

As described above, the system according to the present embodiment is an extremely practical and highly scalable medical information integration system in which each unit cooperates to integrally manage and analyze diverse medical and health data for each patient, and automatically generates an individually optimized preventive medical plan, performs real-time monitoring, issues an alert notification at the time of an abnormality, automatically schedules a remote medical examination, and the like with a generative AI at the core. Specifically, the system causes a plurality of arithmetic nodes based on a distributed processing architecture to operate cooperatively. The system adopts a microservice architecture in which each unit exchanges data via an asynchronous messaging queue. The system executes each phase of data collection, accumulation, analysis, proposal, and notification as a pipeline process. The system arranges the generative AI as a core of an inference engine. This AI is a hybrid model in which a large language model having billions of parameters and a recurrent neural network specialized for time-series prediction are integrated. The system integrates diverse medical data for each patient as a high-dimensional tensor. The system inputs the integrated tensor to this AI and executes a parallel operation. The system dynamically generates an individually optimized preventive medical plan. The system continuously evaluates real-time monitoring data using a stream processing engine. The system generates an interrupt process at the time of abnormality detection and immediately executes an alert notification. The system formulates scheduling of a remote medical examination as a constraint satisfaction problem, and automatically solves the problem using an optimization algorithm. The system autonomously executes these complex arithmetic processes without human intervention. The system dramatically reduces a work burden on a medical worker. The system provides preventive medicine based on a data-driven objective index. The system has scalability capable of easily scaling out even when the number of patients increases by a dynamic allocation function of computing resources. This technology is applied as a core system for constructing a national-scale medical information infrastructure and realizing a next-generation smart hospital concept.

### (Implementation Steps)

Step 1: Multidimensional Collection of Patient Information

In this step, a patient medical record acquisition unit cooperates with an electronic medical record system or a medical examination database, and comprehensively acquires a diagnosis history, a treatment history, past illness information, a medication history, allergy information, a hospitalization history, a surgery history, a test result, image diagnosis data, a vaccination history, a rehabilitation record, and the like. In addition, a biological data acquisition unit automatically collects real-time data such as a blood pressure, a heart rate, a blood glucose level, a body temperature, a blood oxygen saturation, the number of steps, calorie consumption, a sleep state, a respiratory rate, a body weight, a body fat percentage, and a muscle mass from a wearable device, a home medical device, or a smartphone application, and a genetic information acquisition unit acquires information such as a heart disease risk gene, a diabetes risk gene, a drug-metabolizing enzyme gene, a cancer risk gene, and an Alzheimer's disease risk gene from a genetic testing service or a medical institution. Furthermore, an environmental factor acquisition unit multilaterally acquires a lifestyle (a smoking history, a drinking history, an exercise habit, a diet, a sleep habit, a stress level, and a medication compliance status), a living environment (air pollution, noise, a temperature, a humidity, a housing performance, and medical institution access), an occupational environment (a working style, stress, a working environment, a night shift, long working hours, and a safety and health status), and the like, and the patient inputs a daily lifestyle and meal contents using a smartphone application, or automatically acquires weather and environmental data from an external database. Specifically, in this step, the system activates a data ingest pipeline that asynchronously collects data from a plurality of heterogeneous data sources. The medical record acquisition unit issues a standardized query to a database of a hospital information system. This unit parses returned structured data. This unit extracts an entity from an unstructured text using a natural language processing model. The biological data acquisition unit establishes pairing with a wearable device via a short-range wireless communication protocol. This unit temporarily stores a biological signal streamed from the device in a buffer memory. This unit extracts a frequency component by applying a fast Fourier transform to waveform data acquired via an analog-to-digital converter. The genetic information acquisition unit receives a variant call file from an external genome analysis center using a secure file transfer protocol. This unit parses base sequence data in the file and converts the base sequence data into a binary vector indicating a specific single nucleotide polymorphism. The environmental factor acquisition unit acquires coordinates from a position information sensor of a smartphone. This unit transmits the acquired coordinates to an external weather information system, and acquires an environmental data vector of a corresponding area. The system maps data having these diverse modalities to a common data schema. The system executes a data cleansing process such as complementation of a missing value and removal of an outlier. The system constructs the preprocessed data as a multidimensional patient state tensor. By this process, the system converts an enormous amount of medical data having different formats into a unified data structure computable by a computer. The system dramatically improves calculation efficiency and inference accuracy in subsequent AI analysis. This technology is applied to a use case such as construction of a personal health record system that integrates health data over an individual's lifetime.
Step 2: Accumulation of Chronological Data by Long-Term Memory Management

In this step, a long-term memory management unit integrally accumulates and manages medical records, biological data, genetic information, and environmental factor information for each patient in chronological order. For example, all data such as a blood pressure transition for the past several years, a heart rate fluctuation for each season, a blood glucose level change before and after a treatment intervention, a body weight transition before and after implementation of a lifestyle improvement program, a rehabilitation progress before and after a surgery, a sleep state before and after a hospitalization, a fluctuation of a health index accompanying a life event such as a job change or a moving, a transition of a medication compliance status, and an occurrence status of a side reaction after a vaccination are recorded in chronological order, and a long-term change in a health state for each patient and a fluctuation of a health index accompanying a specific event can be tracked in detail. Specifically, in this step, the long-term memory management unit drives a distributed time-series database engine. This unit adds a time stamp to the patient state tensor generated in Step 1. This unit writes data to a storage cluster using the time stamp as an index key. This unit optimizes a storage capacity by applying a data compression algorithm when writing data. This unit aligns data acquired at different sampling rates on a time axis. This unit estimates data in a missing section using linear interpolation or spline interpolation, and generates a continuous chronological array. This unit constructs a multidimensional index tree in order to efficiently search data over a long period of time. This unit superimposes an event marker indicating a timing of a specific life event or treatment intervention on chronological data. This unit executes a sliding window process for extracting a data section before and after an event. The system dynamically updates a baseline state of the patient using the accumulated chronological data. The system continuously trains a statistical model for calculating a degree of deviation from the baseline in a background. By this process, the system consistently manages a long-term data fluctuation in units of years and a short-term data fluctuation in units of seconds on the same platform. The system improves a data read/write speed, and shortens a query response time for large-scale data to a millisecond order. This technology is extremely important in a use case such as generation of learning data for a progression prediction model of a chronic disease or clinical trial data management for evaluating long-term effectiveness of a new drug.
Step 3: Integrated Analysis and Risk Prediction by Generative AI

In this step, a generative AI processing unit integrally analyzes all the aforementioned data. A generative AI combines natural language processing, image analysis, chronological data analysis, pattern recognition, causal inference, a generative model, and the like, extracts a disease risk from a medical record of a patient, detects an abnormal pattern from analysis of an electrocardiogram waveform and image data and chronological data such as a blood pressure and a heart rate, and predicts a future disease onset risk and symptom exacerbation risk by performing multivariate analysis on a genetic predisposition, a lifestyle, and an environmental factor. For example, an individual-specific pattern such as a “tendency for a blood pressure to increase every winter”, a “tendency for a blood glucose level to rapidly increase after administration of a specific drug”, and a “tendency for a stress index to deteriorate and sleep quality to decline after a job change” is extracted. As a specific example of a prompt sentence to be read by the generative AI, “Predict a future heart disease risk based on the following patient data, and generate a lifestyle improvement plan for risk reduction. Patient data: age 55, male, past medical history: high blood pressure and diabetes, genetic information: positive for heart disease risk gene, lifestyle: presence of smoking history, no exercise habit, diet: high-fat diet, latest blood pressure value: 150/95, latest blood glucose level: 140 mg/dL, residence: urban area, occupation: presence of night shift, high stress level.” and the like can be cited. Specifically, in this step, the generative AI processing unit activates an integrated inference engine in which a plurality of specialized neural networks are ensembled. This engine includes a long short-term memory network that processes chronological data, a convolutional neural network that processes image data, and a transformer model that processes text data. Input data to this engine is a multidimensional time-series tensor extracted from the long-term memory management unit, a pixel matrix of a medical image, and a token embedding vector of a natural language text. As specific examples of this input data, there are a one-dimensional array indicating a blood pressure fluctuation for the past one month, a two-dimensional tensor of a chest X-ray image, and a 768-dimensional embedding representation obtained by vectorizing a text of an electronic medical record. This engine inputs a feature vector output from each network to a combining layer, and generates a single integrated feature vector. This engine inputs the integrated feature vector to a fully connected layer and performs non-linear transformation. This engine calculates an onset probability distribution of each disease by applying a softmax function. Output data from this engine is a predicted probability score for each disease, an attention weight matrix indicating a contribution degree of a risk factor, and a natural language text explaining a prediction basis. As specific examples of this output data, there are numerical data of an onset probability of myocardial infarction of 85 percent, an attention map in which a high weight is assigned to a blood pressure increase trend, and a text explaining that a blood pressure increase in winter increases a risk. The system inputs the output probability score to a risk stratification algorithm, and determines a risk level of the patient. The system analyzes the attention weight matrix, and specifies a feature amount having the highest contribution degree. By this process, the system mathematically elucidates a non-linear correlation between complex variables that cannot be recognized by a human doctor. The system significantly improves prediction accuracy as compared with a conventional method depending on a single data source. This technology is applied to a use case such as early screening of a high-risk patient in preventive medicine or decision support of an optimal treatment policy in personalized medicine.
Step 4: Automatic Generation of Individually Optimized Preventive Medical Plan

In this step, a preventive medical plan proposal unit automatically generates a preventive medical plan optimized for each patient based on an analysis result of the generative AI processing unit. For example, for a patient with a high heart disease risk, a plan combining “aerobic exercise three times a week”, “practice of a reduced-salt diet”, “regular electrocardiogram examination”, “taking a stress management program”, and the like is proposed, and for a patient with a high diabetes risk, “calorie-restricted diet”, “blood glucose level measurement after every meal”, “strengthening of exercise habit”, “securing sleep time”, and the like are recommended. A living environment, an occupational environment, a preference, a family structure, an economic situation, a religious restriction, and the like of the patient are also considered, and fine customization is possible, for example, “proposing alternative ingredients when it is necessary to avoid a specific food for religious reasons”, “proposing a low-cost exercise plan in consideration of an economic burden”, and “proposing a health program that can be worked on together with a family member”. As a specific example of a prompt sentence to be read by the generative AI, “Generate an optimal preventive medical plan in Japanese considering a living environment, a preference, and an economic situation of a patient based on the following health risk analysis result of the patient. Patient information: age 68, female, past medical history: osteoporosis, exercise habit: walk once a week, family structure: living with husband, economic situation: living on a pension, preference: mainly Japanese food, religious restriction: specific meat not allowed.” and the like can be cited. Specifically, in this step, the preventive medical plan proposal unit drives a plan generation agent implementing a reinforcement learning algorithm. This agent operates in an environmental model based on a Markov decision process. Input data to this agent is the disease prediction probability score output in Step 3, an attribute information vector of the patient, and a binary mask matrix indicating a restriction condition. As specific examples of this input data, there are a score of a diabetes onset probability of 90 percent, an attribute vector indicating an elderly person and a low income, and a restriction mask indicating a specific food allergy. This agent calculates an action value function based on the input data. This agent selects an optimal action sequence that maximizes a future health state and minimizes a cost from among a plurality of possible intervention actions. This agent inputs the selected action sequence to a natural language generation model. This model converts the action sequence into a specific instruction text understandable by a human. Output data from this model is a scheduled task list, structured data of a recommended meal menu, and a message text for improving motivation. As specific examples of this output data, there are task data of stretching executed at 10:00 a.m. every day, recipe data of 2 grams or less of salt, and an encouraging text prompting continuation. The system push-distributes the output plan data to an application of a patient terminal. The system activates a tracking module for monitoring an execution status of the plan. By this process, the system dynamically synthesizes an executable plan perfectly adapted to an individual context, rather than presenting a uniform guideline. The system improves compliance of the patient and enhances effectiveness of preventive medicine. This technology is applied to a use case such as automation of a health promotion program for a subscriber by a health insurance association or automatic generation of a personal training menu in a fitness club.
Step 5: Real-time remote monitoring and alert notification. In this step, the remote monitoring cooperation unit receives biological data in real time from a home medical device or a wearable device of a patient, and sequentially transmits the biological data to the generative AI processing unit. The generative AI analyzes the received data in real time, and when detecting an abnormal value or an increase in risk, automatically issues an alert notification to a medical worker terminal. For example, when a heart rate rapidly increases, when a blood glucose level reaches a dangerous range, or when a respiratory arrest is detected during sleep, a medical worker is immediately notified, and scheduling of a remote medical examination or an emergency response is performed as necessary. As a specific example of a prompt sentence to be read by the generative AI, “Analyze the following real-time biological data, and when detecting an abnormal value or an increase in risk, generate contents to be notified to a medical worker and a recommended countermeasure in Japanese. Biological data: heart rate 120 bpm, blood pressure 160/100, blood glucose level 180 mg/dL, with respiratory arrest event during sleep.” and the like are given. Specifically, in this step, the remote monitoring cooperation unit constructs a stream processing pipeline utilizing an in-memory database. This unit continuously receives biological data packets arriving in milliseconds. This unit analyzes header information of the received packet and extracts numerical data from a payload. This unit stores the extracted data in a sliding window and calculates a real-time feature amount. This unit inputs the calculated feature amount to a lightweight anomaly detection model deployed on an edge side. This model adopts a one-dimensional convolutional neural network architecture. Input data to this model is a time-series tensor of a heart rate and a blood oxygen saturation for the latest five minutes. As a specific example of this input data, there are a heart rate array having 300 sampling points and the same number of blood oxygen saturation arrays. This model repeatedly applies a convolution operation and a pooling operation to the input tensor. This model outputs an anomaly occurrence probability using a sigmoid function. Output data from this model is an anomaly probability value in a range of zero to one and a classification label indicating a type of anomaly. As a specific example of this output data, there are a probability value of 0.95 and label data indicating an apnea attack. When the output probability value exceeds a set threshold value, the system immediately activates an interrupt handler. This handler transmits an alert message to the medical worker terminal using a push notification protocol. This handler simultaneously executes an API call that sets an emergency flag to an electronic medical record system. By this processing, the system shortens a latency from data reception to anomaly detection and notification to the utmost limit. The system enables a rapid medical intervention without overlooking a fatal state exacerbation. This technology provides extremely high value in use cases such as continuous monitoring of a patient transitioning from an intensive care unit to a general ward and a solitary death prevention system for an elderly person living alone.
Step 6: Information provision and feedback collection by a user interface. In this step, a user interface unit provides interface functions such as data input, plan confirmation, alert reception, and remote medical examination participation in the patient terminal and the medical worker terminal. The patient inputs a daily physical condition and a lifestyle using a smartphone application, and automatically transmits biological data using a wearable device, and the medical worker confirms an AI-generated report and plan using a personal computer, and performs a remote medical examination with the patient as necessary. An explanatory text and plan contents are automatically adjusted according to a comprehension level and an implementation status of the patient, an explanation is given to an elderly person in plain expressions, and a specialized explanation is given to a medical worker, thereby realizing optimal information provision according to user attributes. Specifically, in this step, the user interface unit establishes a WebSocket connection enabling bidirectional communication. This unit asynchronously captures an input event from a touch panel or a microphone of the patient terminal. This unit inputs the input voice data to a voice recognition engine and converts the voice data into text data. This unit transmits the input text data and a log of a selection operation to the server as a structured object. The server inputs the received feedback data to a natural language understanding model. This model extracts an emotional polarity and a degree of dissatisfaction with the plan from the text. Input data to this model is a free text input by the patient and a past plan execution history vector. As a specific example of this input data, there are text data indicating that exercise is too hard to continue, and a numerical vector indicating an execution rate of 30 percent. This model analyzes the input data and scores a modification request degree of the plan. Output data from this model is an emotion score, a modification request flag, and a parameter group for generating an alternative plan. As a specific example of this output data, there are an emotion score indicating negative, a flag of modification request ON, and a parameter for lowering an exercise intensity. The system feeds back the output parameters to the preventive medical plan proposal unit, and triggers recalculation of the plan. This unit dynamically redraws the recalculated plan on a screen of the terminal. By this processing, the system incorporates a user's reaction into a control loop inside the system in real time. The system evolves a static information presentation system into an adaptive dialogue system. This technology is applied to use cases such as a self-care support application for a chronic disease patient and digital therapeutics aimed at improving medication adherence.
Step 7: Security management and privacy protection. In this step, a security management unit performs encryption processing on all data communications and data storage, and implements security measures such as anonymization of patient information, access authority management, multi-factor authentication, audit log recording, and unauthorized access detection. When transmitting and receiving patient data, communication encryption by TLS is performed, AES encryption is performed on a database on the server, access authority is finely set for each medical worker, and a third party cannot browse data unless there is patient consent. A security audit log of the entire system is recorded, and an AI automatically detects a sign of unauthorized access or information leakage and notifies an administrator. Specifically, in this step, the security management unit implements an access control mechanism based on a zero-trust network architecture. This unit executes signature verification for all API requests. This unit strictly checks an expiration date and an issuer of a token. This unit enables a transparent data encryption function for each column of the database. This unit drives a key management service that automates rotation of an encryption key. This unit applies a differential privacy algorithm to an export request for patient data. This algorithm mathematically makes it difficult to identify an individual by adding Laplace noise to a dataset. This unit mirrors network traffic and inputs the network traffic to an intrusion detection system. This system includes a deep learning-based packet analysis model. Input data to this model is a feature vector including header information of a packet, a byte sequence of a payload, and statistical information of a session. As a specific example of this input data, there are a source port number, an entropy value of a payload, and the number of packets per unit time. This model calculates a degree of deviation from a normal traffic pattern. Output data from this model is an alert level indicating a sign of malware infection or data exfiltration, and a list of IP addresses to be blocked. As a specific example of this output data, there are a critical level alert and a specific external IP address. The system dynamically adds the output IP address to a blacklist of a firewall, and immediately blocks communication. By this processing, the system robustly protects sensitive medical data from increasingly sophisticated cyber attacks. The system provides a secure data utilization environment while satisfying compliance requirements. This technology becomes an essential security infrastructure in use cases such as a data sharing platform between medical institutions and a cloud-based electronic medical record system.

### (Specific Use Case)

For example, when the system of the present invention is applied to an elderly patient having a chronic heart disease, the medical record acquisition unit automatically acquires a past heart disease diagnosis history, multiple hospitalization histories, a cardiac catheterization treatment history, a medication history, allergy information, past electrocardiogram and echocardiogram image diagnosis data, a blood test result, a rehabilitation record, and the like of the patient from an electronic medical record system. The biological data acquisition unit acquires a daily blood pressure, heart rate, blood oxygen saturation, body weight, number of steps, sleep time, nighttime heart rate variability, peak heart rate during exercise, respiratory rate, body temperature, and the like in real time from a sphygmomanometer, an electrocardiograph, a pulse oximeter, a weight scale, and a wearable device installed in the patient's home, and transmits these data to the server. The genetic information acquisition unit acquires information such as a heart disease risk gene, a drug-metabolizing enzyme gene, a diabetes risk gene, and a dyslipidemia risk gene of the patient from a genetic testing database of a medical institution, and the environmental factor acquisition unit multilaterally acquires a smoking history, a drinking history, an exercise habit, a diet, a sleep habit, a stress level, a medication compliance status, an air pollution level of a residence, a temperature, a humidity, noise, a heat insulation performance of a house, an access status to a medical institution, an occupational environment (retired, at home during the day, family structure), and the like of the patient. The long-term memory management unit integrally accumulates all of these pieces of information in chronological order, and records in detail, for example, a blood pressure transition over the past five years, a seasonal variation in heart rate, changes in blood glucose level and body weight before and after a treatment intervention, a rehabilitation progress, a sleep state before and after hospitalization, a variation in health index accompanying a relocation or a change in family structure, a transition of a medication compliance status, an occurrence status of a side reaction after vaccination, and the like. Specifically, in the present embodiment, the system operates a plurality of data collection agents in parallel. The medical record acquisition unit connects to an electronic medical record server of a hospital using a standard protocol. This unit collectively downloads medical record data for the past ten years using an identifier of the patient as a key. This unit extracts important indices such as an ejection fraction of an echocardiogram and a BNP value from the downloaded data, and stores the important indices in a structured database. The biological data acquisition unit maintains a constant connection with a gateway installed in the patient's home. This unit receives potential data in millivolts transmitted from a wearable electrocardiograph at a sampling rate of 100 hertz. This unit applies a bandpass filter to the received waveform data to remove baseline wandering and myoelectric noise. The genetic information acquisition unit transmits a secure API request to an external genome database after referring to a consent profile of the patient. This unit extracts allele information related to a specific disease risk from the acquired gene sequence data. The environmental factor acquisition unit acquires data of a gyro sensor and an acceleration sensor from a dedicated application installed in a smartphone of the patient to estimate an activity amount. This unit acquires time-series data of a temperature, a humidity, an atmospheric pressure, and a PM2.5 concentration in a living area of the patient from an external environmental data provider. The long-term memory management unit maps these heterogeneous mixed data on the same time axis. This unit assigns a reliability score to each data point, and saves the data point in a distributed storage as a multidimensional time-series tensor. By this processing, the system comprehensively digitizes all variables affecting the health state of the patient. The system eliminates data silos and constructs a comprehensive analysis platform. This technology is extremely effective in use cases such as a readmission prevention program for a heart failure patient and comprehensive monitoring for preventing progression of frailty in an elderly person.

The generative AI processing unit integrally analyzes all of these data, a natural language processing AI extracts a disease risk and a treatment progress from a medical record, a time-series analysis AI detects an abnormal pattern and a seasonal variation from data such as a blood pressure, a heart rate, a body weight, and sleep, an image recognition AI extracts an abnormal finding from an electrocardiogram and an echocardiogram image, a causal inference AI analyzes a relationship between a genetic predisposition, a lifestyle, and an environmental factor and a health state, and a generative model AI predicts a future heart disease recurrence risk and symptom exacerbation risk. For example, an individual-specific pattern is extracted, such as a tendency for a blood pressure to easily increase in winter, a tendency for a body weight increase and a heart rate increase to be observed during a lack of exercise, a tendency for a blood pressure exacerbation to be observed during a period when a medication compliance rate decreases, and a tendency for a sleep quality to decrease and a heart rate variability to increase after relocation. Specifically, in the present embodiment, the generative AI processing unit drives a giant neural network based on a multimodal learning architecture. This network includes independent encoder groups that process each modality of text, time-series numerical value, and image. The natural language processing AI adopts a transformer-based architecture. Input data to this AI is a vector obtained by tokenizing a discharge summary text of an electronic medical record. This AI extracts an exacerbation episode of heart failure and a history of medication change from the text. The time-series analysis AI is a hybrid model combining an autoregressive integrated moving average model and a long short-term memory network. Input data to this AI is a daily variation tensor of a blood pressure, a body weight, and a heart rate for the past six months. This AI extracts a pattern in which a slight increase in body weight and an increase in heart rate synchronize. The image recognition AI adopts a residual network architecture. Input data to this AI is a frame image tensor of an echocardiogram moving image. This AI segments a hypokinesis region of a left ventricular wall in pixel units. The causal inference AI models a causal relationship between variables using a Bayesian network. Input data to this AI is a feature vector group output from each encoder. This AI specifies a causal path in which a temperature drop and an increase in salt intake cause a blood pressure increase. The generative model AI integrates these analysis results and calculates a future state transition probability. Output data from this model is a heart failure recurrence probability score within 30 days, a contribution degree vector of a risk factor, and an explanatory text indicating a basis of prediction. As a specific example of this output data, there are a recurrence probability of 78 percent, a vector indicating a high weight for body weight increase and forgetting to take medication, and a text pointing out a sign of fluid retention. The system inputs the output probability score to a threshold determination module, and determines the necessity of intervention. By this processing, the system realizes highly accurate risk prediction based on a causal relationship rather than a mere correlation. The system complements an empirical judgment of a doctor and prevents an oversight. This technology is applied to use cases such as an exacerbation prediction system for a chronic disease and a clinical decision support system that optimizes an intervention timing of a preventive intervention.

The preventive medical plan proposal unit automatically generates an individually optimized plan considering a living environment, a preference, a family structure, an economic situation, a religious constraint, and the like of the patient based on an analysis result of the generative AI processing unit, such as “strengthen a reduced-salt diet and aerobic exercise in winter, and recommend walking three times a week”, “thoroughly measure and record a blood pressure every morning, and automatically notify a medical worker when an abnormal value continues”, “improve a medication compliance rate by utilizing a medication alert function”, “recommend stretching and bathing before going to bed to improve sleep quality”, “propose an exercise program that can be tackled together with a family member”, “preferentially present a free or low-cost health program in consideration of an economic burden”, and “propose a meal plan in consideration of a religious constraint”. Specifically, in the present embodiment, the preventive medical plan proposal unit activates an evolutionary algorithm engine for solving a constrained optimization problem. This engine inputs a risk factor vector output from the generative AI processing unit and an attribute profile of the patient to an objective function. Input data to this engine is a medical requirement vector for lowering a heart failure recurrence risk, a categorical variable indicating an economic situation of the patient, and a binary flag indicating a religious constraint. As a specific example of this input data, there are a vector requesting salt restriction and aerobic exercise, a variable indicating a low-income group, and a flag indicating that pork intake is not possible. This engine generates an initial population consisting of combinations of thousands of types of intervention actions. This engine repeatedly applies crossover and mutation operators to search for an optimal solution that maximizes the objective function. This engine inputs the optimized action sequence to a large language model. This model generates a natural language text that is easy for the patient to understand and put into action using a prompt engineering technology. Output data from this model is a specific daily action instruction list, recipe data using alternative ingredients, and a support guide text for a family member. As a specific example of this output data, there are a text instructing body weight measurement immediately after waking up every morning, reduced-salt recipe data using chicken, and a text prompting a family member to confirm medication. The system synchronously distributes the output plan data to terminals of the patient and the family member. The system scores an execution status of the plan and uses the execution status as input data for the next optimization loop. By this processing, the system automatically generates a realistic plan satisfying both medical validity and an actual living situation of the patient. The system reduces an enormous amount of time for a medical worker to manually create a plan. This technology exhibits an extremely high effect in use cases such as a home medical care support system after discharge and an aggravation prevention program for a lifestyle-related disease.

The remote monitoring cooperation unit receives biological data in real time from a medical device or a wearable device in the patient's home, and sequentially transmits the biological data to the generative AI processing unit. The generative AI analyzes the received data in real time, and when detecting an abnormal value or an increase in risk, for example, when a heart rate exceeds 120 bpm, when a blood pressure exceeds 160/100, when a respiratory arrest event is detected during sleep, or when a blood glucose level exceeds 180 mg/dL, automatically issues an alert notification to a medical worker terminal, and automatically implements scheduling of a remote medical examination or an emergency response as necessary. Specifically, in the present embodiment, the remote monitoring cooperation unit constructs a lightweight publish-subscribe communication network between an edge device and a cloud server. This unit subscribes to electrocardiogram waveform data and blood oxygen saturation data transmitted every second from the wearable device of the patient. This unit buffers the received data stream in an in-memory time-series database. This unit cuts out the buffered data with a certain window size, and transfers the data to the generative AI processing unit. The generative AI processing unit executes inference of an autoencoder model specialized for anomaly detection in real time. Input data to this model is an electrocardiogram waveform tensor and a respiratory waveform tensor for the latest one minute. As a specific example of this input data, there are an electrocardiogram array having 6000 data points and the same number of respiratory waveform arrays. This model compresses an input tensor into a latent space, and restores the input tensor to an original waveform again. This model calculates a mean square error between the input waveform and the restored waveform. Output data from this model is an anomaly score based on a reconstruction error and a classification vector indicating a type of anomaly. As a specific example of this output data, there are an anomaly score greatly exceeding a threshold value and a classification vector indicating ventricular fibrillation. When detecting that the output anomaly score exceeds an emergency threshold value, the system immediately activates an event-driven alert manager. This manager transmits a high-priority push notification to a smartphone of an attending doctor. This manager simultaneously automatically transmits an API request to which position information of the patient and the latest vital data are added to an emergency transport system. By this processing, the system instantaneously detects a fatal arrhythmia or an attack of acute heart failure, and automatically activates a chain of survival. The system completely eliminates a time lag caused by human monitoring. This technology provides an indispensable safety net in use cases such as home hospice care for a patient with severe heart disease and an early discharge support program for a postoperative patient.

The user interface unit is configured such that, in the patient terminal and the medical worker terminal, the patient inputs a daily physical condition and a lifestyle using a smartphone application, and automatically transmits biological data using a wearable device, and the medical worker confirms an AI-generated report and plan, and performs a remote medical examination with the patient as necessary. An explanatory text and plan contents are automatically adjusted according to a comprehension level and an implementation status of the patient, an explanation is given to an elderly person in plain expressions, and a specialized explanation is given to a medical worker, thereby realizing optimal information provision according to user attributes. Specifically, in the present embodiment, the user interface unit provides a front-end application based on a reactive programming paradigm. This unit renders an accessibility-compatible screen using large buttons and a high-contrast color scheme in the patient terminal. This unit holds an answer to a physical condition questionnaire input by the patient and a flag state of a medication check in a state management library. When detecting a change in state, this unit immediately executes asynchronous communication to a back-end server. This unit generates a dashboard component that displays a list of real-time data of a plurality of patients in the medical worker terminal. This unit parses and displays report data created by the generative AI. This unit inputs attribute information of a user to a determination module. Input data to this module is an age, an occupation, and a past system usage history vector of the user. As a specific example of this input data, there are age data of 80 years old, an occupation flag indicating a patient, and a history vector indicating that a usage frequency is low. This module determines an optimal display mode based on the input data. Output data from this module is a control parameter designating a display mode and a prompt variable for adjusting a difficulty level of a text. As a specific example of this output data, there are a parameter designating a senior mode and a prompt variable excluding a technical term. The system dynamically reconstructs a screen layout and a text expression based on the output parameters. By this processing, the system provides an optimal operation experience to all users from an elderly patient with low IT literacy to a specialist seeking advanced information analysis. The system reduces input errors and improves data quality of the entire system. This technology is applied to use cases such as a regional medical network system in which multiple professions cooperate and a patient-participatory personal health record application.

The security management unit performs encryption processing on all data communications and data storage, and implements security measures such as anonymization of patient information, access authority management, multi-factor authentication, audit log recording, and unauthorized access detection. Specifically, in the present embodiment, the security management unit operates an authentication infrastructure incorporating a zero-knowledge proof protocol. This unit generates a temporary session key using an elliptic curve Diffie-Hellman key exchange algorithm for all communication sessions between the patient terminal and the server. This unit encrypts a payload using the generated key. This unit applies a salted hash function to a direct identifier such as a name or an address of a patient stored in a database to convert the direct identifier into an irreversible token. This unit evaluates an attribute-based access control policy in response to an access request from a medical worker. This unit enforces a multi-factor authentication process combining a smart card and biometric authentication. This unit records all data read/write operations executed in the system in a tamper-proof blockchain-based audit log system. This unit drives a machine learning-based intrusion detection agent that constantly monitors network traffic and a system log. Input data to this agent is a feature vector indicating an IP address of an access source, a frequency of requests, and a type of requested data. As a specific example of this input data, there are an unusual overseas IP address and frequency data requesting a large amount of medical record data in a short time. This agent compares an input vector with a normal profile to calculate a Mahalanobis distance. Output data from this agent is a score indicating a probability of unauthorized access and an identifier of a corresponding session. As a specific example of this output data, there are an unauthorized access probability of 99 percent and a character string of a session ID. When the output score exceeds a threshold value, the system immediately discards the corresponding session and automatically transmits an incident report to an administrator. By this processing, the system completely satisfies strict privacy protection requirements for medical information. The system minimizes a data leakage risk due to a ransomware attack or an internal crime. This technology becomes an essential function in use cases such as a cloud-based electronic medical record system and a medical data bank that shares data among a plurality of research institutions.

As a specific example of a prompt sentence to be read by the generative AI, “Based on the following patient data, predict a future heart disease recurrence risk, and generate a lifestyle improvement plan for risk reduction. Patient data: age 75, male, past medical history: myocardial infarction and high blood pressure, genetic information: heart disease risk gene positive, lifestyle: smoking history present, exercise habit absent, diet: high-fat diet, latest blood pressure value: 155/98, latest blood glucose level: 145 mg/dL, residence: urban area, occupation: retired, family structure: living with a spouse, economic status: living on a pension, preference: mainly Japanese food, religious restriction: specific meat not allowed, medication compliance rate: 80%, sleep time: 5 hours, stress level high, blood pressure, heart rate, body weight, sleep, exercise, and medication data for the past three years are attached in chronological order.” and the like can be cited. Specifically, in the present embodiment, the system drives a prompt engineering module to dynamically construct an input text to a large language model. The module executes a process of embedding structured data of the patient extracted from a database into a natural language template. The module concatenates multidimensional data such as an age, a sex, a past medical history, genetic information, a lifestyle, a latest vital sign, an environmental factor, and a medication compliance rate of the patient as a character string. The module converts chronological data for the past three years into a text indicating a statistical summary value or a trend, and adds the text to the prompt. As a specific example of the prompt sentence generated by the module, text data of “Based on the following patient data, predict a future heart disease recurrence risk, and generate a lifestyle improvement plan for risk reduction. Patient data: age 75, male, past medical history: myocardial infarction and high blood pressure, genetic information: heart disease risk gene positive, lifestyle: smoking history present, exercise habit absent, diet: high-fat diet, latest blood pressure value: 155 over 98, latest blood glucose level: 145 milligrams per deciliter, residence: urban area, occupation: retired, family structure: living with a spouse, economic status: living on a pension, preference: mainly Japanese food, religious restriction: specific meat not allowed, medication compliance rate: 80 percent, sleep time: 5 hours, stress level high, blood pressure, heart rate, body weight, sleep, exercise, and medication data for the past three years are attached in chronological order.” is constructed. The system inputs the constructed prompt sentence to an encoder of the large language model. The model analyzes a context of the input text using a self-attention mechanism. Output data from the model is a structured text including a quantitative evaluation of a recurrence risk, a list of specific improvement actions, and a motivation improvement message for the patient. As a specific example of the output data, an evaluation result indicating a high recurrence risk, an instruction to limit a salt intake to less than 6 grams per day, and a proposal of walking together with the spouse exist. The system parses the output text and renders the output text on a screen via a user interface unit. By this process, the system automates advanced reasoning integrating complex medical data and a social background of the patient. The system imitates a thinking process of a medical specialist and provides high-quality personalized medicine. The present technology is applied to a use case such as a medical examination support system for a family doctor or a personalized healthcare application for a patient.

### Application Example 1

The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

An embodiment of the present invention is configured as an advanced care support system that multidimensionally and chronologically collects and integrates a health condition, a living situation, an environmental factor, a care history, a medication status, a lifestyle, and the like of a care receiver, automatically generates and proposes an individually optimized preventive care and life support plan using a generative AI, and further unitarily realizes remote monitoring, automatic notification at the time of abnormality, and emergency response. Hereinafter, each component and its specific function and process will be described in more detail and specifically. Specifically, the care support system according to the present embodiment operates as a distributed processing platform constructed on a cloud computing environment. The system includes a data ingest engine that processes streaming data asynchronously transmitted from a plurality of data collection nodes. The system cooperates with an IoT sensor group that acquires biological information and environmental information of the care receiver. The system normalizes the collected data and converts the collected data into a multidimensional tensor data structure. The system inputs the converted tensor data to a hybrid AI engine including a large language model and a graph neural network. Input data to the AI engine is a past care record text, a real-time vital sign array, and a sensor data vector of a living environment of the care receiver. As a specific example of the input data, a daily report text input by a visiting care worker, a heart rate array measured at one-minute intervals, and a numerical vector indicating an indoor temperature and humidity exist. The AI engine calculates the input data in a high-dimensional space, and extracts a sign of a state change of the care receiver. Output data from the AI engine is a probability score indicating a future care need level deterioration risk, structured data of a recommended care intervention plan, and an alert control command at the time of abnormality detection. As a specific example of the output data, a score of a fall risk of 80 percent, plan data proposing installation of a handrail or addition of rehabilitation, and a command to activate an emergency call system exist. The system distributes the output plan data to a terminal of a care manager, and executes an automatic notification process based on the alert control command. By this process, the system fundamentally improves a conventional care plan formulation process depending on an empirical rule to a data-driven scientific approach. The system realizes an improvement in QOL and prevention of aggravation of the care receiver while significantly reducing a work burden on a care staff. The present technology plays a core role in a use case such as a resident management system in a special nursing home for the elderly or a home care support platform in a comprehensive community support center.

The care receiver information acquisition unit automatically acquires health records, a chronic disease history, a fall history, a fracture history, a hospitalization history, medication details, allergy information, past illness information, a surgery history, a vaccination history, a past infectious disease history, a rehabilitation record, a nutritional status evaluation, a swallowing function evaluation, a bedsore occurrence history, and the like for each care receiver from various information sources such as an electronic medical record, a care record, a home-visit nursing record, a rehabilitation record, a medication management application, a nutrition management system, and a bedsore management system. For example, when there is a past history of a heart disease or a stroke, a diagnosis date, a treatment progress, medication details, a recurrence history, rehabilitation details, a follow-up observation record after discharge, and the like thereof are recorded in detail, and regarding the fall history, a fall occurrence date and time, a place, a cause, response details after the fall, presence or absence of a fracture or hospitalization, an implementation status of a fall prevention measure, and the like are acquired in chronological order. Regarding the medication details, a type of a prescription drug, a dose, a medication schedule, a medication compliance rate, a record of forgotten medication or incorrect medication, a drug change history, a side effect occurrence status, presence or absence of a drug allergy, and the like are comprehensively managed. Furthermore, as the nutritional status evaluation, a serum albumin level, a BMI, a body weight change, a food intake, presence or absence of difficulty in oral intake, a usage status of tube feeding or intravenous nutrition, and the like are acquired, and as the swallowing function evaluation, a swallowing screening test result, an aspiration pneumonia onset history, a change history of a meal form, and the like are recorded. Specifically, the care receiver information acquisition unit drives a dedicated API gateway for cooperating with a plurality of external systems. The unit periodically issues a data extraction query to an electronic medical record system, a long-term care insurance billing system, and a database of a home-visit nursing station using a secure authentication token. The unit parses the acquired raw data, and extracts an important medical/care entity from an unstructured text using a natural language processing model. The unit links the extracted data to an identifier unique to the care receiver, and maps the extracted data to each table of a relational database. The unit generates a text vector of a diagnosis code, an onset date, and treatment details for a past history of a heart disease or a stroke. The unit generates a time stamp of an occurrence date and time, a categorical variable indicating a place, and a text vector indicating a cause for the fall history. The unit generates a drug identification code, numerical data indicating a dose, and percentage data indicating a medication compliance rate for the medication details. The unit generates chronological array data of a serum albumin level and a BMI for the nutritional status evaluation. The unit generates a score vector of a screening test for the swallowing function evaluation. The system integrates these generated multidimensional data, and constructs a comprehensive feature amount tensor covering a current state and a past history of the care receiver. As a specific example of input data to the feature amount tensor, a binary flag indicating a past history of cerebral infarction, an integer value indicating the number of falls in the past year, and a floating-point array indicating a transition of the BMI exist. The system transfers the constructed feature amount tensor to a subsequent generative AI processing unit. By this process, the system integrates fragmentary care and medical information existing in a distributed manner into one computable data structure. The system prevents an oversight or a transmission omission of information, and establishes a foundation for highly accurate risk prediction by the AI. The present technology is applied to a use case such as an information sharing platform in a home care case in which a plurality of service providers intervene, or an assessment automation system for a new resident.

The activities of daily living data acquisition unit acquires a walking ability (independent, cane use, walker, wheelchair), an excretion independence level (independent, partial assistance, full assistance), a food intake status (independent, assistance, tube feeding), a bathing and changing clothes independence level, an independence level of getting up from a bed or standing up, an independence level of moving to a toilet, a stair climbing ability, an outdoor mobility ability, an independence level of shopping or cooking, an independence level of money management or medication management, and the like from a record of a care staff, a sensor, a motion capture device, a bed sensor, a toilet sensor, a door opening/closing sensor, a GPS device, and the like. For example, unsteadiness during walking or a fall risk is detected by an acceleration sensor or a gyro sensor, the number of toilet uses or an excretion independence level is automatically recorded by a toilet sensor or an excretion recording application, a food intake or presence or absence of meal assistance is input by a staff using a tablet terminal, outdoor movement or an outing frequency is grasped by a GPS device, and an independence level of money management or medication management is periodically evaluated by a family member or a staff. Specifically, the acquisition unit converts an analog signal obtained from various sensors into digital data. The acquisition unit generates a chronological array of an acceleration and an angular velocity at a sampling rate of 100 hertz. The acquisition unit applies a low-pass filter to the generated chronological array to remove high-frequency noise. The acquisition unit divides the noise-removed chronological array by a window size of a certain time. The acquisition unit constructs the divided data as a three-dimensional tensor. The acquisition unit inputs the constructed three-dimensional tensor to a deep convolutional neural network. An input to the deep convolutional neural network is a multidimensional array having a time axis, a sensor axis, and a feature amount axis. The deep convolutional neural network extracts spatial and temporal features, and generates a 256-dimensional feature amount vector. The acquisition unit inputs the extracted feature amount vector to a support vector machine via a fully connected layer. The support vector machine outputs a classification label of a walking state. The classification label indicates a specific state such as normal walking, shuffling walking, unsteadiness, or a fall sign. The acquisition unit calculates a fall risk score based on an output probability of the classification label. The fall risk score is expressed as a continuous value from zero to one hundred. When the fall risk score exceeds a preset safety threshold, the acquisition unit immediately transmits a trigger signal to a subsequent warning processing module. Thereby, the system realizes objective and highly accurate motion analysis that does not rely on human visual observation. The system significantly reduces manual recording work by a care staff. The system simultaneously achieves an increase in speed by real-time processing of sensor data and an improvement in accuracy of state determination by a machine learning model. The present technology is widely applied to a fall prevention monitoring system in a facility for the elderly or an automatic evaluation platform for a motor function in home rehabilitation.

The vital data acquisition unit acquires a blood pressure, a heart rate, a body temperature, a blood oxygen saturation, a respiratory rate, a body weight, a body fat percentage, a blood glucose level, electrocardiogram data, a breathing pattern, a sleep apnea event, an activity amount, the number of steps, a calorie consumption, a resting heart rate, a maximum heart rate, an exercise heart rate, a nocturnal heart rate variability, and the like in real time from a home medical device, a wearable device, a smart watch, an activity meter, a weight scale, a body composition meter, a blood glucose level measuring device, an electrocardiograph, a respiration sensor, a sleep sensor, and the like. For example, vital data acquired in all scenes of daily life, such as a blood pressure measurement value and a heart rate every morning, a heart rate variability during sleep at night, an activity amount and the number of steps during the day, a change in body weight and body fat percentage on weekends, a postprandial blood glucose level transition, an abnormal value of a respiratory rate or a blood oxygen saturation, an abnormality of an electrocardiogram waveform, and detection of a sleep apnea event, are automatically collected and accumulated in chronological order. Specifically, the acquisition unit receives biological signals asynchronously transmitted from a plurality of wearable devices via a wireless communication interface. The acquisition unit synchronizes time stamps of the received biological signals in units of milliseconds using a network time protocol. The acquisition unit automatically complements a missing value of data caused by a communication error by a linear interpolation algorithm. The acquisition unit normalizes the complemented chronological data by a standardization process. The acquisition unit inputs the normalized chronological data to a long short-term memory network. The long short-term memory network has learned normal fluctuation patterns of a heart rate, a respiratory rate, and a blood oxygen saturation for the past seven days in advance. An input to the long short-term memory network is a 128-dimensional chronological feature vector. The long short-term memory network calculates a degree of divergence between the input data and the learned pattern. The long short-term memory network outputs a score indicating an abnormality occurrence probability in the next 24 hours. The abnormality occurrence probability score takes a continuous value between zero and one. When the abnormality occurrence probability score exceeds a confidence threshold, the acquisition unit generates an abnormality detection flag. The acquisition unit immediately transfers the abnormality detection flag to the remote monitoring cooperation unit. Thereby, the system captures a sudden biological fluctuation in real time. The system enables objective abnormality detection that does not depend on a human empirical rule or subjectivity. The system realizes highly accurate monitoring while suppressing consumption of calculation resources by sharing primary processing on an edge device side and deep learning processing on a server side. The present technology is applied to an early detection system for an acute disease in telemedicine or an automatic screening device for sleep apnea syndrome.

The cognitive function evaluation data acquisition unit acquires regular dementia evaluation scores (such as MMSE, HDS-R, CDR, FAST, and MoCA), AI automatic evaluations from daily conversation and behavior patterns, observation records of family members and staff, and signs of cognitive function decline (such as forgetfulness, wandering, judgment decline, motivation decline, aphasia, agnosia, apraxia, and disorientation). For example, a monthly cognitive function test result is recorded, contents and a reaction speed of a daily conversation are analyzed by a voice recognition AI, wandering or an abnormal behavior is detected by a monitoring camera or a sensor, a change noticed by a family member or a staff is input by an application, and the AI automatically determines a progression degree or a change tendency by comparing with a past cognitive function evaluation. Specifically, the acquisition unit includes a multimodal artificial intelligence architecture integrating a voice recognition model and a natural language processing model. The acquisition unit converts voice waveform data acquired from a microphone into frequency domain data by fast Fourier transform. The acquisition unit extracts the converted data as a mel-frequency cepstrum coefficient. The acquisition unit inputs the extracted acoustic feature amount to a recurrent neural network-based voice recognition model. The voice recognition model outputs utterance contents as highly accurate text data. The acquisition unit tokenizes the text data by morphological analysis. The acquisition unit inputs the tokenized array to a transformer-based natural language processing model. An input to the natural language processing model is an addition value of a 512-dimensional word embedding vector and a positional encoding. The natural language processing model analyzes a context using a self-attention mechanism. The natural language processing model outputs a cognitive function score indicating logical consistency of an utterance or diversity of a vocabulary. The cognitive function score is expressed as a multidimensional probability distribution. The acquisition unit inputs an image tensor indicating a facial expression or an eye movement acquired from a camera to a convolutional neural network. The convolutional neural network outputs a behavior feature vector indicating an emotional state or a reaction delay. The acquisition unit combines the cognitive function score and the behavior feature vector. The acquisition unit inputs the combined vector to a gradient boosting decision tree. The gradient boosting decision tree outputs a final evaluation label indicating a decline degree of a cognitive function. The acquisition unit stores the final evaluation label in the long-term memory management unit. Thereby, the system complements a regular test by a medical specialist. The system realizes early detection of a minute cognitive function change by daily continuous evaluation. The present technology is applied to an early detection system for dementia or an automatic adjustment algorithm for an individual care plan in a care facility.

The living environmental factor acquisition unit acquires steps and handrail installation status in a residence, living alone or living together, presence or absence of a pet, a temperature and humidity of a residence, noise, a heat insulation performance of a house, access status to a neighboring medical institution, a disaster risk, a surrounding barrier-free status, a house renovation history, a family structure, an interaction frequency with a neighboring resident, a regional monitoring system, a care service provision status of a local government, and the like. For example, steps and a handrail installation place are acquired from a house drawing or field survey data, environmental data such as a temperature, a humidity, and noise are automatically acquired from an IoT sensor or an external weather database, living alone or living together, a family structure, and presence or absence of a pet are acquired from a family information database, and an interaction frequency with a neighboring resident and a regional monitoring system are acquired from a database of a comprehensive community support center. Specifically, the acquisition unit continuously collects heterogeneous data from various environmental sensor groups and an external weather application programming interface. The acquisition unit maps the collected data to a common three-dimensional spatial coordinate system. The acquisition unit generates three-dimensional point cloud data indicating a height of a step or a position of a handrail in a residence using distance data obtained from a laser sensor. The acquisition unit inputs the three-dimensional point cloud data to a graph neural network. An input to the graph neural network is spatial graph structure data in which a feature point in a space is a node and a physical adjacency relationship is an edge. The graph neural network outputs a heat map tensor indicating a physical danger degree such as a fall in each area in the residence. The acquisition unit inputs chronological environmental data such as a temperature, a humidity, and a noise level to a multilayer perceptron. The multilayer perceptron outputs an environmental stress score indicating a heatstroke risk or a sleep inhibition factor. The acquisition unit integrates the heat map tensor and the environmental stress score by a tensor combination operation. The acquisition unit generates an integrated environmental risk vector. The acquisition unit transmits the environmental risk vector to a subsequent generative artificial intelligence processing unit. Thereby, the system integrally evaluates a structural risk of a static living environment and a change in a dynamic weather condition. The system quantifies a complex environmental risk that is difficult to grasp by human intuition or visual survey. The system automates an integration processing process of heterogeneous data, and significantly improves calculation efficiency. The present technology is applied to an automatic environmental control system for a smart home for the elderly or an architecture support system that proposes an optimal place for barrier-free renovation.

The care history acquisition unit records a usage status of home visit care and day service, a rehabilitation consultation history, past care accidents and near-miss cases, a change history of a care plan, a replacement history of a care staff, a satisfaction evaluation of a care service, a usage status of a long-term care insurance service, a transition of a care certification category, a care benefit record, a care consultation history, a request or a complaint from a family member, and the like. For example, a usage history of home visit care three times a week, a usage of day service twice a month, details and a frequency of rehabilitation, details of a fall accident or a near-miss case that occurred in the past, a reason or an effect of a care plan change, handover details at the time of staff replacement, a service satisfaction questionnaire result, a change history of a care certification category, a care benefit record, details of a request or a complaint from a family member, and the like are managed in detail. Specifically, the acquisition unit converts a care record or a near-miss report recorded as unstructured text data into machine-readable structured data. The acquisition unit extracts a named entity from the text data using a natural language processing technology. The acquisition unit inputs the extracted named entity to a pre-trained word embedding model. An input to the word embedding model is a tensor including an index array of a word and context information. The word embedding model outputs a 768-dimensional dense vector. The acquisition unit executes a cosine similarity calculation on the generated dense vector group. The acquisition unit clusters past events having a high similarity using a K-means algorithm. The acquisition unit constructs a causal relationship graph indicating an effect brought about by a specific care intervention based on a clustering result. The acquisition unit calculates a transition probability between nodes of the causal relationship graph using a Bayesian network. The acquisition unit updates the graph using the calculated transition probability as a weight. The acquisition unit stores the updated causal relationship graph in a graph database. Thereby, the system automatically extracts useful knowledge or a sign pattern of an accident from a huge amount of past records. The system realizes objective history analysis that does not depend on a personal experience or memory of a care staff. The system significantly reduces a calculation cost of a text search, and minimizes a latency of an information search. The present technology is applied to a prediction alert system for a care accident or a data-driven education support system for a new care staff.

The medication status acquisition unit acquires presence or absence of forgotten medication or incorrect medication, a medication compliance rate, an operation status of a medication alert, a side effect occurrence status of a drug, a drug change history, presence or absence of a drug allergy, a drug cost, a storage status of a drug, a remaining amount management of a drug, a medication guidance history, and the like from a medication support device or a medication record application. For example, a medication support device records a medication time, automatically records when there is forgotten medication or incorrect medication, and manages in detail whether a medication alert operated normally, a side effect occurrence status after a drug change, an automatic notification when a remaining amount of a drug becomes low, management of a drug cost, a storage status of a drug, a medication guidance history, and the like. Specifically, the acquisition unit analyzes an event log transmitted from the medication support device in real time. The acquisition unit extracts a medication time, a type of a drug, and a medication completion flag from the event log. The acquisition unit converts the extracted data into a chronological binary matrix. The acquisition unit inputs the binary matrix to a Markov chain model. An input to the Markov chain model is a transition probability matrix of a medication state for the past 30 days and lifestyle rhythm data of a patient. The Markov chain model outputs a prediction probability of forgotten medication at a next medication timing. The prediction probability is expressed as numerical data from zero to one hundred percent. When the prediction probability exceeds a set threshold, the acquisition unit generates an advance warning alert. The acquisition unit transmits the advance warning alert to a terminal of the patient and a terminal of a care staff. The acquisition unit inputs remaining amount data of the drug to an inventory management algorithm. The inventory management algorithm calculates an optimal reorder date based on a past consumption pace and a predicted medication schedule. Thereby, the system prevents a decline in medication compliance in advance. The system reduces a serious health hazard caused by an overdose or forgotten medication of a drug. The system achieves business efficiency improvement by automation of inventory management and ordering business. The present technology is applied to a medication management system for a chronic disease patient or a prescription optimization module in an online medical examination platform.

The lifestyle information acquisition unit acquires meal contents and calorie intake, the number of excretions and presence or absence of incontinence, a sleep time and the number of mid-wakefulness, an activity amount and an exercise habit, a hobby activity and a social participation status, a daytime whereabouts and a movement history, the number of bathing, an outing frequency, a housework implementation status, an independence level of shopping or cooking, a communication frequency with a friend or a family member, a viewing/listening time of a television or a radio, a reading time of a newspaper or a book, a participation status in a religious activity or a regional activity, and the like from a sensor, an application, or a staff record. For example, it is possible to record meal contents with a photograph and estimate a nutrient by an AI, automatically record the number of toilet uses or incontinence by an excretion sensor, measure a sleep time or the number of mid-wakefulness by a sleep sensor, acquire the number of steps or an exercise intensity by an activity meter, record a hobby activity or an outing frequency by an application, evaluate a housework implementation status or an independence level of shopping/cooking by a staff, or analyze a communication frequency with a friend or a family member by a voice recognition AI. Specifically, the acquisition unit includes a multimodal data processing pipeline that links an image recognition artificial intelligence and a behavior recognition artificial intelligence. The acquisition unit resizes and normalizes image data of a meal acquired from a camera. The acquisition unit inputs the preprocessed image tensor to a deep convolutional neural network. An input to the deep convolutional neural network is a 224-pixel square three-channel image tensor. The deep convolutional neural network segments a food material region in the image in units of pixels. The deep convolutional neural network outputs structured data indicating an estimated weight of each food material and a nutrient content such as a calorie and a protein. The acquisition unit performs fast Fourier transform on three-axis acceleration data obtained from an activity meter. The acquisition unit inputs a feature amount in a frequency domain to a random forest classifier. The random forest classifier outputs a behavior category label such as sleep, walking, or housework. The acquisition unit integrates the nutrient content data and the behavior category label. The acquisition unit calculates an index value indicating an income and expenditure balance between an energy intake and a consumption per day. The acquisition unit transmits the index value to the long-term memory management unit. Thereby, the system realizes accurate and objective collection of lifestyle information that does not rely on self-reporting. The system enables highly accurate grasping of a lifestyle pattern by integrating multimodal data. The present technology is applied to a personalized nutrition guidance system or an activity amount monitoring platform for frailty prevention.

The long-term memory management unit integrally accumulates all of these pieces of information in chronological order, and records and manages in detail long-term changes in a health condition and a living situation for each care receiver, fluctuations in health indicators accompanying a specific event (such as hospitalization, a fall, a change in family structure, a house renovation, a change in care service, an occurrence of a disaster, or an epidemic of an infectious disease), an effect of care intervention, a seasonal variation and a change in life rhythm, and a change in social isolation and economic situation. For example, the long-term memory management unit records in detail a blood pressure transition over the past five years, a change in cognitive function score, a transition of a walking ability and ADL, a functional change before and after rehabilitation intervention, a correlation between a fall history and a living environment, a change in medication compliance rate, a seasonal variation in sleep time and activity amount, a change in health indicator accompanying a change in family structure or care service, a deterioration in health condition at the time of occurrence of a disaster, a change in life rhythm at the time of an epidemic of an infectious disease, and the like. Specifically, the management unit adopts a hybrid storage architecture combining a distributed time-series database and a graph database. The management unit links heterogeneous data asynchronously received from each acquisition unit with a common patient identifier and a time stamp. The management unit compresses and stores the time-series data in a columnar format to optimize a storage capacity. The management unit expresses a relationship between a specific event and a fluctuation in health indicator as a node and an edge of the graph database. The management unit executes a correlation analysis between data in a high-dimensional vector space. The management unit performs dimensionality reduction of multidimensional data using a principal component analysis algorithm. The management unit executes anomaly detection using an isolation forest algorithm in the dimensionality-reduced feature space. The anomaly detection algorithm detects a singular point deviating from a seasonal variation or a long-term change in life rhythm. The management unit provides an index indicating the singular point to the generative artificial intelligence processing unit. Thereby, the system achieves both long-term data accumulation in units of several years and high-speed search query processing. The system maintains data integrity while optimizing a physical capacity of a data storage. The system realizes comprehensive history management exceeding a limit of human memory capacity. The present technology is applied to a management platform for a lifelong health record and a large-scale data analysis infrastructure for an epidemiological survey.

The generative AI processing unit comprehensively analyzes all the above-described data, a natural language processing AI extracts a risk factor and a progress from a medical/care record, a time-series analysis AI detects a change and an abnormal pattern in vitals, ADL, a cognitive function, and lifestyle information, an image recognition AI extracts a risk factor from an image of a meal content, a behavior pattern, and a housing environment, a causal inference AI analyzes a relationship between a living environment, a care history, and a medication status, and a health condition, and a generative model AI predicts a future fall risk, dementia progression risk, living function decline risk, dehydration or infectious disease risk, social isolation risk, economic hardship risk, and the like. For example, the AI automatically extracts a declining tendency of a walking ability and a cognitive function, a change in medication compliance rate, a physical condition fluctuation for each season, a correlation between a fall history and a living environment, a relationship between lack of sleep and cognitive function decline, a relationship between social isolation and a depressive tendency, a relationship between deterioration of an economic situation and decline of a nutritional status, and the like, and learns an individual-specific pattern. Specifically, the processing unit includes an ensemble learning architecture integrating a plurality of specialized artificial intelligence models. The processing unit inputs the time-series data extracted from the long-term memory management unit to a transformer-based time-series analysis model. An input to the time-series analysis model is a multidimensional time-series tensor including vital signs and a life activity amount for the past one month. The time-series analysis model learns a long-term dependency relationship between data using a self-attention mechanism. The time-series analysis model outputs a transition prediction of a risk score indicating a future deterioration of a health condition. The processing unit inputs text data of a medical record to a large language model. An input to the large language model is a prompted text sequence of a past medical history and a current symptom of the patient. The large language model outputs a structured list extracting a risk factor of a potential complication. The processing unit executes a causal inference algorithm using a Bayesian network. The processing unit calculates a strength of a causal relationship between a living environmental factor and a change in health condition as a probability value. The processing unit integrates these outputs and inputs them to a generative adversarial network-based generative model. The generative model outputs a probability distribution of a fall risk, a dementia progression risk, and a social isolation risk. When the probability distribution exceeds a predetermined warning threshold, the processing unit transmits an analysis result vector to the preventive care plan proposal unit. Thereby, the system realizes an advanced predictive analysis exceeding a mere statistical aggregation of data. The system quantitatively separates and evaluates complexly intertwined risk factors. The system executes a large-scale inference task at high speed by parallel processing of computational resources. The present technology is applied to a risk stratification system in preventive medicine and a decision support system for personalized medicine.

The preventive care plan proposal unit automatically generates an individually optimized plan considering a living environment, a preference, a family structure, an economic situation, a religious restriction, a social background, and the like of the care receiver, such as elimination of steps and handrail installation in a living environment, introduction of walking training and balance exercise, a brain training and conversation program for suppressing dementia progression, introduction of a medication support device, monitoring enhancement by care staff, life rhythm adjustment for sleep improvement, meal content review and water intake promotion, recommendation of hobby activities and social participation, enhancement of cooperation with a family and a community, proposal of an economic support measure, promotion of community participation for preventing social isolation, and enhancement of a safety confirmation system at the time of a disaster, based on an analysis result of the generative AI processing unit. For example, the preventive care plan proposal unit proposes a combination of various preventive care and life support measures, such as enhancement of remote monitoring and an emergency call system for an elderly person living alone, introduction of a dementia prevention program when there is a cognitive function decline tendency, enhancement of a house renovation and walking training when a fall risk is high, introduction of a medication support device when there are many forgotten medications, proposal of a sleep improvement program when there is a sleep disorder, utilization of a dietary supplement and a meal support service when a food intake amount is small, recommendation of community activities and volunteer participation when there is a social isolation tendency, proposal of utilization of a public support system when there is an economic hardship, and enhancement of a safety confirmation system and an evacuation support measure at the time of a disaster. Specifically, the proposal unit includes a plan generation engine combining a reinforcement learning algorithm and a large language model. The proposal unit defines the analysis result vector received from the generative artificial intelligence processing unit as a state space in a Markov decision process. The proposal unit sets a past care intervention history and an improvement degree of a health condition obtained as a result thereof as a reward function. The proposal unit searches for an optimal sequence of intervention actions that maximizes a reward by a reinforcement learning agent using a Q-learning algorithm. The proposal unit inputs the searched sequence of intervention actions to the large language model. An input to the large language model is a context vector including a code sequence of the intervention action and profile information of the patient. The large language model outputs text data of the individually optimized plan described in a natural language. The output plan includes specific contents of a recommended house renovation, a schedule of walking training, and an introduction procedure of a medication support device. The proposal unit converts the generated plan into a hypertext markup language format in accordance with a display format of a medical worker terminal. The proposal unit transmits the converted data from the server to the terminal via a secure communication protocol. Thereby, the system automatically generates a plan perfectly adapted to individual characteristics of the patient, rather than a uniform care plan. The system significantly reduces a time required for a plan creation work of a care manager. The system improves a quality of the plan by continuously learning past success cases. The present technology is applied to a care plan creation support system in a nursing care insurance system and an automatic construction platform for a rehabilitation program.

The remote monitoring cooperation unit receives biological data and lifestyle information in real time from a home medical device, a wearable device, a monitoring camera, a fall sensor, a door opening/closing sensor, a sleep sensor, a wandering detection sensor, an emergency call button, a GPS device, and the like of the care receiver, and sequentially transmits the biological data and the lifestyle information to the generative AI processing unit. The generative AI analyzes the received data in real time, automatically issues an alert notification to a care staff or a family member in the event of an abnormality, for example, when a blood pressure or a heart rate rapidly increases, when a fall sensor is activated, when a respiratory arrest is detected during sleep, when forgotten medications continue, when wandering or an abnormal behavior is detected, when a door opening/closing sensor is activated at midnight, or when an emergency call button is pressed, and automatically schedules a remote medical examination or an emergency response as necessary. For example, when an elderly person living alone falls at night, the generative AI can immediately notify a family member or a care staff, arrange emergency transportation or a remote medical examination as necessary, and when wandering is detected, track position information with a GPS device and notify a family member or a community monitoring network. Specifically, the cooperation unit adopts a distributed processing architecture fusing an edge computing technology and a cloud computing technology. The cooperation unit executes primary filtering of the biological data and the lifestyle information in an edge gateway arranged in the vicinity of each sensor device. The cooperation unit transmits stream data from which noise has been removed to a stream processing engine on a cloud server. The stream processing engine analyzes the received data in real time by micro-batch processing. The cooperation unit inputs the data to be analyzed to an anomaly detection algorithm. An input to the anomaly detection algorithm is a heart rate variability for the latest five minutes and a three-dimensional vector of an acceleration sensor. The anomaly detection algorithm calculates a Mahalanobis distance from a normal state. The anomaly detection algorithm outputs a binary flag indicating an occurrence of an abnormality when the Mahalanobis distance exceeds a dynamically set threshold. Upon receiving the binary flag, the cooperation unit immediately generates an alert message. The cooperation unit transmits the alert message to a mobile terminal of the care staff using a push notification protocol. The cooperation unit simultaneously calls an application programming interface of a remote medical examination system. The cooperation unit automatically establishes a video call session. Thereby, the system minimizes a human intervention delay for an emergency situation. The system realizes low-latency communication while optimizing consumption of a network bandwidth. The present technology is applied to an emergency call system for an elderly person living alone and a patient monitoring system in an intensive care unit.

As described above, the embodiment of the present invention is an extremely practical and highly scalable care support system capable of responding to all needs in a care site, such as integrally managing multidimensional and chronological health and lifestyle data for each care receiver, automatically generating an individually optimized preventive care and life support plan with a generative AI as a core, real-time remote monitoring, automatic notification and emergency response at the time of an abnormality, response to social isolation and economic hardship, and enhancement of a safety confirmation system at the time of a disaster, and greatly contributes to reduction of a burden on a care site, improvement of QOL of a care receiver, prevention of a care accident, promotion of community-based comprehensive care, and solution of a social issue. Specifically, the system realizes high scalability and fault tolerance by linking a plurality of microservices in a distributed computing environment. The system integrates multidimensional data collected by each acquisition unit into a central data lake. The system constructs a data pipeline centered on the generative artificial intelligence processing unit. The system automates all processes of data collection, analysis, prediction, and plan proposal. The system actively executes control of a physical device and establishment of a communication session based on an inference result of a machine learning model. The system breaks through a limit of human cognitive ability and manual information processing. The system reduces a latency of data processing to a millisecond unit. The system reduces unnecessary medical intervention by improving prediction accuracy. The system optimizes energy efficiency by dynamically allocating computational resources of the entire system. The present technology is widely applied to a community-based comprehensive care platform in a smart city and construction of a next-generation healthcare information infrastructure.

### (System Configuration)

The system according to the present embodiment includes a care receiver information acquisition unit, an activities of daily living data acquisition unit, a vital data acquisition unit, a cognitive function evaluation data acquisition unit, a living environmental factor acquisition unit, a care history acquisition unit, a medication status acquisition unit, a lifestyle information acquisition unit, a long-term memory management unit, a generative AI processing unit, a preventive care plan proposal unit, and a remote monitoring cooperation unit.

The care receiver information acquisition unit automatically acquires health records, a chronic disease history, a fall history, a fracture history, a hospitalization history, medication details, allergy information, a past illness, a surgery history, a vaccination history, an infectious disease history, a rehabilitation record, a nutritional status evaluation, a swallowing function evaluation, a bedsore occurrence history, and the like for each care receiver from various information sources such as an electronic medical record, a care record, a home-visit nursing record, a rehabilitation record, a medication management application, a nutrition management system, and a bedsore management system. For example, when there is a past illness of a heart disease or a stroke, the care receiver information acquisition unit records in detail a diagnosis date, a treatment progress, medication details, a recurrence history, rehabilitation contents, and a follow-up observation record after discharge, acquires an occurrence date and time, a place, a cause, response contents after a fall, presence or absence of a fracture or hospitalization, and an implementation status of a fall prevention measure in chronological order for a fall history, comprehensively manages a type of prescription drug, a dose, a medication schedule, a medication compliance rate, a record of forgotten medication or incorrect medication, a drug change history, a side effect occurrence status, and presence or absence of a drug allergy for medication details, acquires a serum albumin level, a BMI, a weight change, a food intake amount, presence or absence of difficulty in oral intake, and a usage status of tube feeding or intravenous nutrition as a nutritional status evaluation, and records a swallowing screening test result, an aspiration pneumonia onset history, and a change history of a meal form as a swallowing function evaluation. Specifically, the acquisition unit includes a data crawler that asynchronously extracts data from a plurality of heterogeneous databases. The acquisition unit applies a natural language processing pipeline to the extracted text data. The acquisition unit executes morphological analysis and syntactic analysis. The acquisition unit normalizes synonyms with reference to a medical term dictionary. The acquisition unit inputs the normalized text data to an information extraction model. An input to the information extraction model is a tokenized text sequence of an electronic medical record. The information extraction model outputs a disease name, an onset date, and treatment contents as a key-value pair. The acquisition unit constructs a knowledge graph using the extracted structured data. The acquisition unit arranges a patient, a disease, and a drug as nodes of the knowledge graph. The acquisition unit defines a relationship between the nodes as an edge. The acquisition unit stores the knowledge graph in a graph database. The acquisition unit executes a query to the knowledge graph in a subsequent analysis process. Thereby, the system converts various medical records having different formats into a unified data structure. The system dramatically improves a data search speed and reference efficiency. The system completely eliminates a manual data input error. The present technology is applied to improvement of interoperability of an electronic medical record system and construction of a medical big data analysis infrastructure.

The activities of daily living data acquisition unit acquires a walking ability (independent, cane use, walker, wheelchair), an excretion independence level (independent, partial assistance, full assistance), a food intake status (independent, assistance, tube feeding), a bathing and changing clothes independence level, an independence level of getting up from a bed and standing up motion, an independence level of moving to a toilet, a stair climbing ability, an outdoor moving ability, an independence level of shopping and cooking, an independence level of money management and medication management, and the like from a record of a care staff, a sensor, a motion capture device, a bed sensor, a toilet sensor, a door opening/closing sensor, a GPS device, and the like. For example, staggering during walking and a fall risk are detected by an acceleration sensor or a gyro sensor, the number of toilet uses and an excretion independence level are automatically recorded by a toilet sensor or an excretion record application, a food intake amount and presence or absence of meal assistance are input by a staff using a tablet terminal, outdoor movement and an outing frequency are grasped by a GPS device, and an independence level of money management and medication management is regularly evaluated by a family member or a staff. Specifically, the acquisition unit converts an analog signal obtained from various sensors into digital data. The acquisition unit generates a time-series array of an acceleration and an angular velocity at a sampling rate of 100 hertz. The acquisition unit applies a low-pass filter to the generated time-series array to remove high-frequency noise. The acquisition unit divides the noise-removed time-series array by a window size of a certain time. The acquisition unit constructs the divided data as a three-dimensional tensor. The acquisition unit inputs the constructed three-dimensional tensor to a deep convolutional neural network. An input to the deep convolutional neural network is a multidimensional array having a time axis, a sensor axis, and a feature amount axis. The deep convolutional neural network extracts spatial and temporal features and generates a 256-dimensional feature amount vector. The acquisition unit inputs the extracted feature amount vector to a support vector machine via a fully connected layer. The support vector machine outputs a classification label of a walking state. The classification label indicates a specific state such as normal walking, shuffling walking, staggering, or a fall sign. The acquisition unit calculates a fall risk score based on an output probability of the classification label. The fall risk score is expressed as a continuous value from zero to one hundred. When the fall risk score exceeds a preset safety threshold, the acquisition unit immediately transmits a trigger signal to a subsequent warning processing module. Thereby, the system realizes objective and highly accurate motion analysis that does not rely on human visual observation. The system significantly reduces a manual recording work by a care staff. The system simultaneously achieves speedup by real-time processing of sensor data and accuracy improvement of state determination by a machine learning model. The present technology is widely applied to a fall prevention monitoring system in an elderly facility and an automatic evaluation platform for a motor function in home rehabilitation.

The vital data acquisition unit acquires a blood pressure, a heart rate, a body temperature, a blood oxygen saturation, a respiratory rate, a body weight, a body fat percentage, a blood glucose level, electrocardiogram data, a respiration pattern, a sleep apnea event, an activity amount, the number of steps, calorie consumption, a resting heart rate, a maximum heart rate, an exercise heart rate, a nighttime heart rate variability, and the like in real time from a home medical device, a wearable device, a smart watch, an activity meter, a weight scale, a body composition meter, a blood glucose level measuring device, an electrocardiograph, a respiration sensor, a sleep sensor, and the like. For example, the vital data acquisition unit automatically collects vital data acquired in all scenes of daily life, such as a blood pressure measurement value and a heart rate every morning, a heart rate variability during sleep at night, an activity amount and the number of steps during the day, a change in body weight and body fat percentage on weekends, a postprandial blood glucose level transition, an abnormal value of a respiratory rate and a blood oxygen saturation, an abnormality of an electrocardiogram waveform, and detection of a sleep apnea event, and accumulates the vital data in chronological order. Specifically, the acquisition unit receives biological signals asynchronously transmitted from a plurality of wearable devices via a wireless communication interface. The acquisition unit synchronizes time stamps of the received biological signals in a millisecond unit using a network time protocol. The acquisition unit automatically complements a missing value of data caused by a communication error by a linear interpolation algorithm. The acquisition unit normalizes the complemented time-series data by a standardization process. The acquisition unit inputs the normalized time-series data to a long short-term memory network. The long short-term memory network has learned in advance a normal fluctuation pattern of a heart rate, a respiratory rate, and a blood oxygen saturation for the past seven days. An input to the long short-term memory network is a 128-dimensional time-series feature vector. The long short-term memory network calculates a degree of divergence between the input data and the learned pattern. The long short-term memory network outputs a score indicating an abnormality occurrence probability in the next 24 hours. The abnormality occurrence probability score takes a continuous value between zero and one. When the abnormality occurrence probability score exceeds a confidence threshold, the acquisition unit generates an anomaly detection flag. The acquisition unit immediately transfers the anomaly detection flag to the remote monitoring cooperation unit. Thereby, the system captures a sudden biological fluctuation in real time. The system enables objective anomaly detection that does not depend on a human rule of thumb or subjectivity. The system realizes highly accurate monitoring while suppressing consumption of computational resources by sharing primary processing on an edge device side and deep learning processing on a server side. The present technology is applied to an early detection system for an acute disease in telemedicine and an automatic screening device for sleep apnea syndrome.

The cognitive function evaluation data acquisition unit acquires regular dementia evaluation scores (MMSE, HDS-R, CDR, FAST, MoCA, etc.), AI automatic evaluations from daily conversation and behavior patterns, observation records of family members and staff, and signs of cognitive function decline (forgetfulness, wandering, decreased judgment, decreased motivation, aphasia, agnosia, apraxia, disorientation, etc.). For example, a monthly cognitive function test result is recorded, the content and reaction speed of daily conversation are analyzed by a voice recognition AI, wandering and abnormal behavior are detected by a monitoring camera or a sensor, changes noticed by family members and staff are input via an application, and the AI automatically determines the degree of progression and change tendency by comparing with past cognitive function evaluations. Specifically, this acquisition unit includes a multimodal artificial intelligence architecture integrating a voice recognition model and a natural language processing model. This acquisition unit converts voice waveform data acquired from a microphone into frequency domain data by fast Fourier transform. This acquisition unit extracts the converted data as Mel-frequency cepstral coefficients. This acquisition unit inputs the extracted acoustic feature amounts into a recurrent neural network-based voice recognition model. The voice recognition model outputs the utterance content as highly accurate text data. This acquisition unit tokenizes the text data by morphological analysis. This acquisition unit inputs the tokenized array into a transformer-based natural language processing model. The input to the natural language processing model is an addition value of a 512-dimensional word embedding vector and positional encoding. The natural language processing model analyzes the context using a self-attention mechanism. The natural language processing model outputs a cognitive function score indicating the logical consistency of the utterance and the diversity of vocabulary. The cognitive function score is expressed as a multidimensional probability distribution. This acquisition unit inputs an image tensor indicating facial expressions and line-of-sight movements acquired from a camera into a convolutional neural network. The convolutional neural network outputs a behavioral feature vector indicating an emotional state and a reaction delay. This acquisition unit combines the cognitive function score and the behavioral feature vector. This acquisition unit inputs the combined vector into a gradient boosting decision tree. The gradient boosting decision tree outputs a final evaluation label indicating the degree of decline in cognitive function. This acquisition unit stores the final evaluation label in the long-term memory management unit. Thereby, this system complements regular tests by a specialist. This system realizes early detection of minute cognitive function changes through daily continuous evaluation. This technology is applied to an early detection system for dementia and an automatic adjustment algorithm for an individual care plan in a care facility.

The living environmental factor acquisition unit acquires steps and handrail installation status in a residence, living alone or living together, presence or absence of a pet, temperature and humidity of a residence, noise, heat insulation performance of a house, access status to a neighboring medical institution, disaster risk, surrounding barrier-free status, house renovation history, family structure, frequency of interaction with neighboring residents, regional monitoring system, care service provision status of a local government, and the like. For example, steps and handrail installation locations are acquired from a house drawing or field survey data, environmental data such as temperature, humidity, and noise are automatically acquired from an IoT sensor or an external weather database, living alone or living together, family structure, and presence or absence of a pet are acquired from a family information database, and the frequency of interaction with neighboring residents and the regional monitoring system are acquired from a database of a community comprehensive support center. Specifically, this acquisition unit continuously collects heterogeneous data from a diverse group of environmental sensors and an external weather application programming interface. This acquisition unit maps the collected data to a common three-dimensional spatial coordinate system. This acquisition unit generates three-dimensional point cloud data indicating the height of steps and the position of handrails in the residence using distance data obtained from a laser sensor. This acquisition unit inputs the three-dimensional point cloud data into a graph neural network. The input to the graph neural network is spatial graph structure data in which feature points in space are nodes and physical adjacency relationships are edges. The graph neural network outputs a heatmap tensor indicating a physical risk level such as a fall in each area in the residence. This acquisition unit inputs chronological environmental data such as temperature, humidity, and noise level into a multilayer perceptron. The multilayer perceptron outputs an environmental stress score indicating a heatstroke risk and a sleep inhibition factor. This acquisition unit integrates the heatmap tensor and the environmental stress score by a tensor combination operation. This acquisition unit generates an integrated environmental risk vector. This acquisition unit transmits the environmental risk vector to the subsequent generative artificial intelligence processing unit. Thereby, this system integrally evaluates the structural risk of the static living environment and the change in dynamic weather conditions. This system quantifies a complex environmental risk that is difficult to grasp by human intuition or visual inspection. This system automates the integration processing process of heterogeneous data and significantly improves calculation efficiency. This technology is applied to an automatic environmental control system for a smart home for the elderly and an architectural support system that proposes an optimal location for barrier-free renovation.

The care history acquisition unit records a usage status of home visit care and day service, a rehabilitation consultation history, past care accidents and near-miss cases, a care plan change history, a care staff replacement history, a care service satisfaction evaluation, a long-term care insurance service usage status, a transition of care certification category, a care benefit record, a care consultation history, requests and complaints from family members, and the like. For example, a history of using home visit care three times a week, using day service twice a month, the content and frequency of rehabilitation, details of fall accidents and near-misses that occurred in the past, reasons and effects of care plan changes, handover contents at the time of staff replacement, service satisfaction questionnaire results, a change history of care certification category, a care benefit record, contents of requests and complaints from family members, and the like are managed in detail. Specifically, this acquisition unit converts care records and near-miss reports recorded as unstructured text data into machine-readable structured data. This acquisition unit extracts named entities from the text data using natural language processing technology. This acquisition unit inputs the extracted named entities into a pre-trained word embedding model. The input to the word embedding model is a tensor including an index array of words and context information. The word embedding model outputs a 768-dimensional dense vector. This acquisition unit executes a cosine similarity calculation on the generated dense vector group. This acquisition unit clusters past events with high similarity using a K-means algorithm. This acquisition unit constructs a causal relationship graph indicating the effect brought about by a specific care intervention based on the clustering result. This acquisition unit calculates a transition probability between nodes of the causal relationship graph using a Bayesian network. This acquisition unit updates the graph using the calculated transition probability as a weight. This acquisition unit stores the updated causal relationship graph in a graph database. Thereby, this system automatically extracts useful knowledge and accident sign patterns from a vast amount of past records. This system realizes objective history analysis that does not depend on the personal experience or memory of the care staff. This system significantly reduces the calculation cost of text search and minimizes the latency of information search. This technology is applied to a predictive alert system for care accidents and a data-driven education support system for new care staff.

The medication status acquisition unit acquires presence or absence of forgotten medication or incorrect medication, a medication compliance rate, an operation status of a medication alert, an occurrence status of a drug side effect, a drug change history, presence or absence of a drug allergy, a drug cost, a drug storage status, a drug remaining amount management, a medication guidance history, and the like from a medication support device or a medication record application. For example, the medication support device records a medication time, automatically records when there is forgotten medication or incorrect medication, and manages in detail whether the medication alert operated normally, the occurrence status of side effects after a drug change, an automatic notification when the remaining amount of the drug is low, management of the drug cost, the drug storage status, the medication guidance history, and the like. Specifically, this acquisition unit analyzes an event log transmitted from the medication support device in real time. This acquisition unit extracts a medication time, a drug type, and a medication completion flag from the event log. This acquisition unit converts the extracted data into a chronological binary matrix. This acquisition unit inputs the binary matrix into a Markov chain model. The input to the Markov chain model is a transition probability matrix of the medication state for the past 30 days and lifestyle rhythm data of the patient. The Markov chain model outputs a predicted probability of forgotten medication at the next medication timing. The predicted probability is expressed as numerical data from 0 to 100 percent. This acquisition unit generates an advance warning alert when the predicted probability exceeds a set threshold. This acquisition unit transmits the advance warning alert to the terminal of the patient and the terminal of the care staff. This acquisition unit inputs the remaining amount data of the drug into an inventory management algorithm. The inventory management algorithm calculates an optimal reorder date based on a past consumption pace and a predicted medication schedule. Thereby, this system prevents a decline in medication compliance in advance. This system reduces serious health damage caused by drug overdose or forgotten medication. This system achieves operational efficiency through automation of inventory management and ordering operations. This technology is applied to a medication management system for chronic disease patients and a prescription optimization module in an online medical examination platform.

The lifestyle information acquisition unit acquires meal contents and calorie intake, the number of excretions and presence or absence of incontinence, a sleep time and the number of mid-wakefulness, an activity amount and an exercise habit, hobby activities and social participation status, a daytime whereabouts and movement history, the number of bathing, an outing frequency, a housework implementation status, an independence level of shopping and cooking, a communication frequency with friends and family members, a viewing time of television and radio, a reading time of newspapers and books, a participation status in religious activities and community activities, and the like from a sensor, an application, or a staff record. For example, it is possible to record meal contents with a photograph and have an AI estimate nutrients, automatically record the number of toilet uses and incontinence with an excretion sensor, measure a sleep time and the number of mid-wakefulness with a sleep sensor, acquire the number of steps and exercise intensity with an activity meter, record hobby activities and outing frequency with an application, have a staff evaluate a housework implementation status and an independence level of shopping and cooking, and analyze a communication frequency with friends and family members with a voice recognition AI. Specifically, this lifestyle information acquisition unit collects raw data asynchronously transmitted from a plurality of heterogeneous sensor groups and a mobile terminal. This lifestyle information acquisition unit inputs the collected raw data into a normalization processing module. This normalization processing module maps image data, chronological waveform data, and natural language text data to different feature amount spaces, respectively. This lifestyle information acquisition unit inputs image data of a meal into a convolutional neural network. This convolutional neural network segments a region of food ingredients from the input image tensor. This convolutional neural network outputs an estimated weight and nutrient composition of each food ingredient as a multidimensional vector. This lifestyle information acquisition unit inputs chronological array data indicating a change in capacitance acquired from an excretion sensor into a recurrent neural network. This recurrent neural network outputs an occurrence probability of an excretion event as a score. This lifestyle information acquisition unit converts conversation voice into text data using a voice recognition module. This voice recognition module inputs the converted text data into a large language model. This large language model outputs an emotional polarity of conversation and a quality of communication as a numerical vector. This system stores these multidimensional feature amount vectors in an integrated database together with a time stamp. With this configuration, this system quantifies the collection of lifestyle information that has depended on human subjective evaluation. This system dramatically improves the accuracy of data collection. This system significantly reduces the burden of recording work on the care staff. This technology is applied to daily monitoring in an elderly facility and objective evaluation of a lifestyle rhythm in home care.

The long-term memory management unit integrally accumulates all of these pieces of information in chronological order, and records and manages in detail long-term changes in health status and living conditions for each care receiver, fluctuations in health indicators accompanying specific events (hospitalization, fall, change in family structure, house renovation, care service change, disaster occurrence, infectious disease epidemic, etc.), effects of care intervention, seasonal variations and changes in lifestyle rhythm, social isolation and changes in economic status, and the like. For example, blood pressure transition over the past five years, changes in cognitive function scores, transitions in walking ability and ADL, functional changes before and after rehabilitation intervention, correlation between fall history and living environment, changes in medication compliance rate, seasonal variations in sleep time and activity amount, changes in health indicators accompanying changes in family structure and care services, deterioration of health status at the time of disaster occurrence, changes in lifestyle rhythm at the time of infectious disease epidemic, and the like are recorded in detail. Specifically, this long-term memory management unit constructs multidimensional chronological data using a distributed graph database. This long-term memory management unit sets an identifier of the care receiver as a root node. This long-term memory management unit generates a graph structure in which each health indicator and life event are connected by an edge. This long-term memory management unit synchronizes data having different sampling rates on a time axis. This long-term memory management unit applies a spline interpolation algorithm to missing values. This long-term memory management unit divides past history data by a fixed-length time window. This long-term memory management unit inputs the divided chronological array data into an autoregressive moving average model and a long short-term memory network. This long short-term memory network extracts a hidden state vector from the input chronological array data. This long short-term memory network outputs a feature amount tensor indicating a seasonal variation and a long-term trend. This long-term memory management unit extracts data sections before and after using an occurrence time of a specific event as a trigger. This long-term memory management unit calculates a statistically significant difference between the extracted data sections. This system speeds up inference processing of a causal relationship using this graph-structured chronological data. This system improves a search speed of a correlation between complex events, which has been difficult with a conventional relational database. With this configuration, this system quantitatively executes long-term effect measurement of care intervention. This technology is applied to a progression prediction system for chronic diseases and an effect determination system for rehabilitation.

The generative AI processing unit comprehensively analyzes all the above-mentioned data, a natural language processing AI extracts risk factors and progress from medical and care records, a time-series analysis AI detects changes and abnormal patterns in vitals, ADL, cognitive function, and lifestyle information, an image recognition AI extracts risk factors from images of meal contents, behavior patterns, and housing environment, a causal inference AI analyzes relationships between living environment, care history, medication status, and health status, and a generative model AI predicts a future fall risk, dementia progression risk, living function decline risk, dehydration or infectious disease risk, social isolation risk, economic hardship risk, and the like. For example, the AI automatically extracts a decline tendency in walking ability and cognitive function, a change in medication compliance rate, a physical condition fluctuation for each season, a correlation between fall history and living environment, a relationship between lack of sleep and cognitive function decline, a relationship between social isolation and depressive tendency, a relationship between deterioration of economic status and decline in nutritional status, and the like, and learns an individual-specific pattern. Specific examples of a prompt sentence to be read by the generative AI include “Based on the following care receiver data, predict a fall risk and a dementia progression risk, and generate a life support and preventive care plan for risk reduction. Care receiver data: age 83, female, past medical history: osteoporosis, high blood pressure, and fall history, ADL: walking ability 2 (using a cane), excretion independence level: partial assistance, dementia evaluation: MMSE 18 points, vitals: blood pressure 155/95, heart rate 102, sleep time 4 hours, forgotten medication twice a week, living environment: many steps and living alone, care history: home visit care three times a week, lifestyle information: low food intake and decreased activity amount, all data for the past year attached in chronological order.” and the like. Specifically, this generative AI processing unit adopts an ensemble learning architecture integrating a plurality of specialized neural networks. This generative AI processing unit includes a natural language processing module, a time-series analysis module, an image recognition module, and a causal inference module. This natural language processing module implements a transformer-based large language model. This natural language processing module tokenizes text data of medical records to generate an input tensor. This natural language processing module calculates contextual dependencies using a self-attention mechanism. This natural language processing module outputs structured data in which entities indicating risk factors are extracted. This time-series analysis module inputs a chronological array of vital data into a one-dimensional convolutional neural network. This one-dimensional convolutional neural network outputs an occurrence probability of an abnormal pattern as a score. This causal inference module calculates a conditional probability between living environment data and health status data using a Bayesian network. This generative AI processing unit inputs feature amount vectors output from these respective modules into a combination layer. This combination layer inputs the integrated multidimensional feature amount tensor into a generative model. This generative model is configured using a generative adversarial network or a diffusion model. This generative model outputs a probability distribution indicating a transition of future health status. This generative model outputs a fall risk and a dementia progression risk as a continuous value score from 0 to 1. This system compares the output risk score with a predetermined threshold. This system triggers subsequent plan proposal processing when the threshold is exceeded. With this configuration, this system specifies a minute correlation in a high-dimensional space that cannot be discovered by human intuition. This system significantly improves the accuracy of risk prediction compared to conventional methods. This technology is applied to individualized risk evaluation in preventive medicine and a resource optimal allocation system in a care facility.

The preventive care plan proposal unit automatically generates an individually optimized plan considering the living environment, preferences, family structure, economic status, religious restrictions, social background, and the like of the care receiver, such as elimination of steps and installation of handrails in the living environment, introduction of walking training and balance exercise, brain training and conversation programs for suppressing dementia progression, introduction of a medication support device, monitoring enhancement by care staff, lifestyle rhythm adjustment for sleep improvement, meal content review and water intake promotion, recommendation of hobby activities and social participation, strengthening of cooperation with family members and the community, proposal of economic support measures, promotion of community participation for preventing social isolation, and strengthening of a safety confirmation system at the time of disaster, based on an analysis result of the generative AI processing unit. For example, various preventive care and life support measures are combined and proposed, such as strengthening of remote monitoring and an emergency call system for an elderly person living alone, introduction of a dementia prevention program when there is a cognitive function decline tendency, strengthening of house renovation and walking training when a fall risk is high, introduction of a medication support device when there is much forgotten medication, proposal of a sleep improvement program when there is a sleep disorder, utilization of dietary supplements and meal support services when food intake is low, recommendation of community activities and volunteer participation when there is a social isolation tendency, proposal of utilization of a public support system when there is economic hardship, and strengthening of a safety confirmation system and evacuation support measures at the time of disaster. Specific examples of a prompt sentence to be read by the generative AI include “Based on the following health, lifestyle, and environmental data of a care receiver, generate a specific preventive care and life support plan in Japanese for reducing a fall risk and a dementia progression risk. Data: age 80, male, past medical history: diabetes, high blood pressure, and fall history, ADL: walking ability 3 (using a walker), excretion independence level: independent, dementia evaluation: MMSE 20 points, vitals: blood pressure 150/90, heart rate 95, sleep time 5 hours, forgotten medication once a week, living environment: few steps and living together, care history: day service twice a week, lifestyle information: slightly decreased activity amount and presence of hobby activities, all data for the past two years attached in chronological order.” and the like. Specifically, this preventive care plan proposal unit includes an inference engine implementing a reinforcement learning algorithm. This preventive care plan proposal unit defines the risk score output from the generative AI processing unit and a profile vector of the care receiver as a state space. This preventive care plan proposal unit defines a list of providable care services and life support measures as an action space. This preventive care plan proposal unit executes a simulation based on a Markov decision process. This preventive care plan proposal unit calculates an expected reward value for each combination of support measures. This expected reward value is evaluated by an objective function that optimizes a trade-off between a risk reduction effect and a cost. This preventive care plan proposal unit selects a combination of support measures that maximizes the expected reward value as an optimal policy. This preventive care plan proposal unit inputs the selected optimal policy into a large language model. This large language model converts a parameter group of the optimal policy into natural language text data. This large language model outputs an individually optimized plan in a format easy for the care receiver and family members to understand. This system transmits the output plan to a display control unit of a medical worker terminal. With this configuration, this system instantaneously derives a computationally optimal solution from among care services having a vast number of combinations. This system standardizes plan creation work that has depended on the personal experience of a care manager. This system dramatically shortens calculation time required for plan creation. This technology is applied to an automatic care plan creation support system in a public long-term care insurance system and a health promotion program proposal system of a private insurance company.

The remote monitoring cooperation unit receives biological data and lifestyle information in real time from a home medical device, a wearable device, a monitoring camera, a fall sensor, a door opening/closing sensor, a sleep sensor, a wandering detection sensor, an emergency call button, a GPS device, and the like of the care receiver, and sequentially transmits the biological data and the lifestyle information to the generative AI processing unit. The generative AI analyzes the received data in real time, and automatically issues an alert notification to a care staff or a family member in the event of an abnormality, such as when blood pressure or heart rate rises sharply, when a fall sensor operates, when respiratory arrest is detected during sleep, when forgotten medication continues, when wandering or abnormal behavior is detected, when a door opening/closing sensor operates late at night, or when an emergency call button is pressed, and automatically schedules a remote medical examination or an emergency response as necessary. For example, when an elderly person living alone falls at night, it is possible to immediately notify family members and care staff, arrange emergency transportation and a remote medical examination as necessary, and when wandering is detected, track location information with a GPS device and notify family members and a regional monitoring network. Specific examples of a prompt sentence to be read by the generative AI include “Analyze the following real-time biological data and lifestyle information, and when an abnormal value or an increase in risk is detected, generate contents to be notified to care staff and family members and recommended countermeasures in Japanese. Data: blood pressure 160/100, heart rate 110, fall sensor operation, sleep time 3 hours, forgotten medication twice in a row, wandering detection sensor operation, all data for the past week attached in chronological order.” and the like. Specifically, this remote monitoring cooperation unit adopts a hybrid processing architecture fusing edge computing technology and cloud computing technology. This remote monitoring cooperation unit asynchronously receives raw data transmitted from each sensor device using a message queuing protocol. This remote monitoring cooperation unit temporarily buffers the received streaming data in an in-memory database. This remote monitoring cooperation unit inputs the buffered chronological array data into a lightweight neural network for abnormality detection. This lightweight neural network has an autoencoder structure. This lightweight neural network compresses the input chronological array data into a low-dimensional latent space. This lightweight neural network restores the compressed data to the original dimension. This lightweight neural network calculates a reconstruction error between the input data and the restored data. This remote monitoring cooperation unit determines an abnormal event when the reconstruction error exceeds a dynamically set threshold. This remote monitoring cooperation unit immediately transfers flag data indicating the occurrence of the abnormal event and sensor data of the corresponding section to the generative AI processing unit. This generative AI processing unit analyzes the transferred data and outputs a score indicating a degree of urgency and text data of recommended countermeasures. This system executes routing processing of notification based on the output urgency score. This system automatically executes an API call to an emergency request system when the degree of urgency is high. With this configuration, this system minimizes consumption of a communication band accompanying constant monitoring. This system shortens latency from occurrence of an abnormality to notification to a millisecond unit. This technology is applied to a solitary death prevention system for elderly people living alone and a patient monitoring system in an intensive care unit in a hospital.

As described above, the system according to the present embodiment is an extremely practical and highly expandable care support system in which each unit cooperates to integrally manage and analyze diverse medical, health, lifestyle, and environmental data for each care receiver, and realizes automatic generation of an individually optimized preventive care and life support plan, real-time remote monitoring, automatic notification and emergency response at the time of abnormality, response to social isolation and economic hardship, strengthening of a safety confirmation system at the time of disaster, and the like with a generative AI as a core. Specifically, this system is implemented as a distributed processing system in which a plurality of independent microservices cooperatively operate on a container orchestration infrastructure. This system adopts a gRPC protocol for data communication between respective processing units. This system speeds up serialization processing of data. This system includes an auto-scaling function that dynamically adds a calculation node in response to an increase in calculation load accompanying an increase in care receivers. This system offloads inference processing of the generative AI to a dedicated tensor processing unit cluster. This system parallelizes forward propagation calculation of a deep learning model. This system maximizes processing throughput of the entire system. With this configuration, this system realizes a new computer paradigm of data-driven predictive care intervention beyond mere computerization of business. This system computationally guarantees optimal allocation of medical and care resources. This system exhibits a remarkable technical effect of reducing care costs of the entire society. This technology is applied to a national-scale medical information infrastructure system and an elderly support platform in a smart city.

### (Implementation Steps)

Step 1: Collection of multidimensional care receiver data In this step, the care receiver information acquisition unit automatically acquires health records, a chronic disease history, a fall history, a fracture history, a hospitalization history, medication details, allergy information, past illness information, a surgery history, a vaccination history, an infectious disease history, a rehabilitation record, a nutritional status evaluation, a swallowing function evaluation, a bedsore occurrence history, and the like from various information sources such as an electronic medical record, a care record, a home visit nursing record, a rehabilitation record, a medication management application, a nutrition management system, and a bedsore management system; the activities of daily living data acquisition unit acquires a walking ability, an excretion independence level, a food intake status, a bathing and changing clothes independence level, an independence level of getting up and standing up from a bed, an independence level of moving to a toilet, a stair climbing ability, an outdoor mobility ability, an independence level of shopping and cooking, an independence level of money management and medication management, and the like from a record of a care staff, a sensor, a motion capture device, a bed sensor, a toilet sensor, a door opening/closing sensor, a GPS device, and the like; the vital data acquisition unit acquires a blood pressure, a heart rate, a body temperature, a blood oxygen saturation, a respiratory rate, a body weight, a body fat percentage, a blood glucose level, electrocardiogram data, a respiration pattern, a sleep apnea event, an activity amount, the number of steps, calorie consumption, a resting heart rate, a maximum heart rate, an exercise heart rate, a nighttime heart rate variability, and the like in real time from a home medical device, a wearable device, a smart watch, an activity meter, a weight scale, a body composition meter, a blood glucose level measuring device, an electrocardiograph, a respiration sensor, a sleep sensor, and the like; the cognitive function evaluation data acquisition unit acquires regular dementia evaluation scores, AI automatic evaluations from daily conversation and behavior patterns, observation records of family members and staff, and signs of cognitive function decline; the living environmental factor acquisition unit acquires steps and handrail installation status in a residence, living alone or living together, presence or absence of a pet, temperature and humidity of a residence, noise, heat insulation performance of a house, access status to a surrounding medical institution, a disaster risk, a surrounding barrier-free status, a house renovation history, a family structure, an interaction frequency with neighbors, a regional monitoring system, a care service provision status of a local government, and the like; the care history acquisition unit records a usage status of home visit care and day service, a rehabilitation consultation history, past care accidents and near-miss cases, a care plan change history, a care staff replacement history, a care service satisfaction evaluation, a long-term care insurance service usage status, a transition of a care certification category, a care benefit record, a care consultation history, requests and complaints from family members, and the like; the medication status acquisition unit acquires presence or absence of forgotten medication or incorrect medication, a medication compliance rate, an operation status of a medication alert, an occurrence status of a drug side effect, a drug change history, presence or absence of a drug allergy, a drug cost, a drug storage status, a drug remaining amount management, a medication guidance history, and the like from a medication support device or a medication record application; and the lifestyle information acquisition unit acquires meal contents and calorie intake, the number of excretions and presence or absence of incontinence, a sleep time and the number of mid-wakefulness, an activity amount and an exercise habit, hobby activities and social participation status, a daytime whereabouts and movement history, the number of bathing, an outing frequency, a housework implementation status, an independence level of shopping and cooking, a communication frequency with friends and family members, a viewing time of television and radio, a reading time of newspapers and books, a participation status in religious activities and community activities, and the like from a sensor, an application, or a staff record. Specifically, in this step, the system activates a data pipeline that executes data extraction, transformation, and loading processes from heterogeneous data sources. The care receiver information acquisition unit issues an SQL query to a database of the electronic medical record system. The care receiver information acquisition unit extracts structured medical record data. The activities of daily living data acquisition unit receives a time-series tensor of three-dimensional coordinates output from the motion capture device. The activities of daily living data acquisition unit inputs the three-dimensional coordinate data to a skeleton estimation algorithm. The skeleton estimation algorithm outputs a joint angle and a moving speed as a feature vector. The vital data acquisition unit receives waveform data of a biological signal from the wearable device via Bluetooth communication. The vital data acquisition unit applies a fast Fourier transform to the waveform data. The vital data acquisition unit extracts a feature array in a frequency domain. The cognitive function evaluation data acquisition unit inputs an acoustic feature and a linguistic feature extracted from voice data to a support vector machine. The support vector machine outputs a continuous value score indicating a degree of cognitive function decline. The living environmental factor acquisition unit acquires spatial data from an external geographic information system. The living environmental factor acquisition unit converts the spatial data into a geohash code. The system maps these various formats of data to a common data schema. The system executes a preprocessing module that performs complementation of missing values and removal of outliers. With this configuration, the system automatically constructs a high-quality machine learning dataset from noisy real-environment data. The system ensures the accuracy of subsequent AI analysis. This technology is applied to a health management application utilizing multimodal data and a subject data collection system in a clinical trial.
Step 2: Time-series data accumulation by long-term memory management In this step, the long-term memory management unit integrally accumulates all of the information in chronological order, and records and manages in detail long-term changes in a health condition and a living situation for each care receiver, fluctuations in health indicators associated with specific events (such as hospitalization, a fall, a change in family structure, a house renovation, a care service change, a disaster occurrence, and an infectious disease epidemic), effects of care intervention, seasonal variations and changes in life rhythm, and changes in social isolation and economic conditions. For example, a blood pressure transition over the past five years, a change in cognitive function score, a transition of walking ability and ADL, a functional change before and after rehabilitation intervention, a correlation between a fall history and a living environment, a change in medication compliance rate, a seasonal variation in sleep time and activity amount, a change in health indicators associated with a change in family structure or care service, a deterioration in health condition at the time of a disaster occurrence, a change in life rhythm at the time of an infectious disease epidemic, and the like are recorded in detail. Specifically, in this step, the long-term memory management unit executes a process of writing the collected normalized data to a distributed time-series database. The long-term memory management unit assigns a high-precision timestamp to each data point. The long-term memory management unit sets a partition key according to the type of data. The long-term memory management unit distributes and arranges the data in a plurality of storage nodes. The long-term memory management unit applies a data compression algorithm when writing the data. The long-term memory management unit suppresses consumption of storage capacity. The long-term memory management unit periodically executes a data aggregation job as a background process. The data aggregation job downsamples high-resolution data in units of seconds into statistical values (average, variance, maximum value, minimum value) in units of hours or days. The long-term memory management unit moves the downsampled data to a storage tier for long-term preservation. The long-term memory management unit indexes flag data indicating the occurrence of a specific event. The long-term memory management unit speeds up event-driven data retrieval. With this configuration, the system maintains a query response time for petabyte-class time-series data on the order of milliseconds. The system guarantees data continuity over a long period of time. The system dramatically improves data read/write performance. This technology is applied to a data management system of a large-scale sensor network and an accumulation system of high-frequency trading data in a financial market.
Step 3: Integrated analysis and risk prediction by generative AI In this step, the generative AI processing unit comprehensively analyzes all the above data, a natural language processing AI extracts a risk factor and a progress from medical and care records, a time-series analysis AI detects a change and an abnormal pattern in vitals, ADL, cognitive function, and lifestyle information, an image recognition AI extracts a risk factor from images of meal contents, behavior patterns, and a housing environment, a causal inference AI analyzes a relationship between a living environment, a care history, a medication status, and a health condition, and a generative model AI predicts a future fall risk, dementia progression risk, living function decline risk, dehydration or infectious disease risk, social isolation risk, economic hardship risk, and the like. For example, the AI automatically extracts a declining tendency of walking ability and cognitive function, a change in medication compliance rate, a seasonal physical condition variation, a correlation between a fall history and a living environment, a relationship between sleep deprivation and cognitive function decline, a relationship between social isolation and a depressive tendency, a relationship between deterioration of economic conditions and nutritional status decline, and the like, and learns an individual-specific pattern. Specific examples of a prompt sentence to be read by the generative AI include “Based on the following care receiver data, predict a fall risk and a dementia progression risk, and generate a life support and preventive care plan for risk reduction. Care receiver data: age 83, female, medical history: osteoporosis, high blood pressure, and fall history, ADL: walking ability 2 (using a cane), excretion independence level: partial assistance, dementia evaluation: MMSE 18 points, vitals: blood pressure 155/95, heart rate 102, sleep time 4 hours, forgotten medication twice a week, living environment: many steps and living alone, care history: home visit care 3 times a week, lifestyle information: small food intake, decreased activity amount, all data for the past year attached in chronological order.” and the like. Specifically, in this step, the generative AI processing unit reads the accumulated time-series data and static profile data by batch processing. The generative AI processing unit inputs the read data to a multimodal neural network. The multimodal neural network includes independent encoder layers corresponding to respective modalities of text, image, and time-series waveform. The natural language processing AI converts text data into a word embedding vector. The time-series analysis AI normalizes vital data and generates a tensor cut out by a sliding window method. The image recognition AI converts image data into a multidimensional array of pixel values. The generative AI processing unit inputs the feature vector output from each encoder layer to a cross-attention mechanism. The cross-attention mechanism calculates the strength of a correlation between different modalities as a weighting factor. The cross-attention mechanism outputs an integrated context vector. The causal inference AI eliminates the influence of a confounding factor from the context vector using a structural causal model. The generative model AI generates a future risk probability distribution from the context vector using a decoder layer. The generative model AI outputs a prediction score and its confidence interval for each risk item. When the prediction score exceeds a specified safety threshold, the system sets an alert flag on a memory. With this configuration, the system mathematically detects a complex risk factor that is overlooked by a single data source. The system significantly reduces a false positive rate of prediction. This technology is applied to a failure prediction system of a complex mechanical system and an integrated risk management system in a financial institution.
Step 4: Automatic generation of individually optimized preventive care and life support plan In this step, the preventive care plan proposal unit automatically generates an individually optimized plan considering the living environment, preferences, family structure, economic conditions, religious constraints, social background, and the like of the care receiver, such as elimination of steps and installation of handrails in a living environment, introduction of walking training and balance exercise, a brain training and conversation program for suppressing dementia progression, introduction of a medication support device, monitoring enhancement by care staff, life rhythm adjustment for sleep improvement, meal content review and water intake promotion, recommendation of hobby activities and social participation, strengthening of cooperation with family members and a community, proposal of economic support measures, promotion of community participation for preventing social isolation, and strengthening of a safety confirmation system at the time of a disaster, based on an analysis result of the generative AI processing unit. Specific examples of a prompt sentence to be read by the generative AI include “Based on the following health, lifestyle, and environmental data of a care receiver, generate a specific preventive care and life support plan in Japanese for reducing a fall risk and a dementia progression risk. Data: age 80, male, medical history: diabetes, high blood pressure, and fall history, ADL: walking ability 3 (using a walker), excretion independence level: independent, dementia evaluation: MMSE 20 points, vitals: blood pressure 150/90, heart rate 95, sleep time 5 hours, forgotten medication once a week, living environment: few steps and living together, care history: day service twice a week, lifestyle information: slightly decreased activity amount, with hobby activities, all data for the past two years attached in chronological order.” and the like. Specifically, in this step, the preventive care plan proposal unit receives the risk prediction score and the context vector output in Step 3 as input data. The preventive care plan proposal unit activates a constrained optimization solver. The constrained optimization solver formulates the economic conditions of the care receiver, the support capability of the family, and the service provision resources of the community as hard constraint conditions. The constrained optimization solver sets maximization of a risk reduction effect as an objective function. The constrained optimization solver calculates an optimal combination vector of support measures using mixed integer linear programming. The preventive care plan proposal unit inputs the calculated combination vector to a prompt generation module. The prompt generation module embeds the combination vector into a natural language template. The prompt generation module generates a structured prompt text. The preventive care plan proposal unit transmits the generated prompt text to an inference endpoint of a large language model. The large language model executes an autoregressive token generation process. The large language model outputs a natural language plan text including a specific action plan, a schedule, and notes. The system converts the output plan text into report data in a PDF format or an HTML format. With this configuration, the system fully automatically generates a plan that achieves both logical consistency and readability for humans. The system dramatically improves the productivity of plan creation work. This technology is applied to a personalized curriculum generation system in an educational field and an optimal delivery route proposal system in a logistics field.
Step 5: Real-time remote monitoring and automatic notification/emergency response at the time of abnormality In this step, the remote monitoring cooperation unit receives biological data and lifestyle information in real time from a home medical device, a wearable device, a monitoring camera, a fall sensor, a door opening/closing sensor, a sleep sensor, a wandering detection sensor, an emergency call button, a GPS device, and the like of the care receiver, and sequentially transmits the biological data and the lifestyle information to the generative AI processing unit. The generative AI analyzes the received data in real time, and automatically issues an alert notification to a care staff or a family member at the time of an abnormality, for example, when a blood pressure or a heart rate rapidly increases, when a fall sensor is activated, when a respiratory arrest is detected during sleep, when forgotten medication continues, when wandering or abnormal behavior is detected, when a door opening/closing sensor is activated at midnight, or when an emergency call button is pressed, and automatically schedules a remote medical examination or an emergency response as necessary. Specific examples of a prompt sentence to be read by the generative AI include “Analyze the following real-time biological data and lifestyle information, and when an abnormal value or an increase in risk is detected, generate contents to be notified to a care staff or a family member and a recommended countermeasure in Japanese. Data: blood pressure 160/100, heart rate 110, fall sensor activated, sleep time 3 hours, forgotten medication twice in a row, wandering detection sensor activated, all data for the past week attached in chronological order.” and the like. Specifically, in this step, the remote monitoring cooperation unit establishes a bidirectional communication session between an edge device and a cloud server. The remote monitoring cooperation unit continuously receives a stream of biological data using a WebSocket protocol. The remote monitoring cooperation unit stores the received stream data in a ring buffer on a memory. The remote monitoring cooperation unit applies a moving average filter and a Kalman filter to the data in the ring buffer. The remote monitoring cooperation unit generates smoothed data from which sensor noise has been removed. The remote monitoring cooperation unit inputs the smoothed data to an anomaly detection algorithm. The anomaly detection algorithm is configured using an isolation forest or a one-class support vector machine. The anomaly detection algorithm outputs a degree to which the input data deviates from a cluster of normal data as an anomaly score. When the anomaly score exceeds a dynamic threshold, the remote monitoring cooperation unit generates an interrupt process. The remote monitoring cooperation unit generates a payload in a JSON format including a code indicating the type of anomaly, an occurrence time, and a snapshot of corresponding sensor data. The remote monitoring cooperation unit transmits the payload to a push notification server. The push notification server immediately distributes an alert to a mobile terminal of a registered care staff. When receiving a pressing signal of the emergency call button, the system activates an interactive voice response system and executes a call process to an emergency institution. With this configuration, the system constructs a fully automated anomaly detection and response loop that does not depend on human monitoring. The system shortens a response delay to a fatal event to a physical limit. This technology is applied to a remote monitoring system of an autonomous driving vehicle and a security monitoring system of critical infrastructure.

### (Specific Use Case)

For example, when the system of the present invention is applied to a care receiver who is an elderly woman living alone, the care receiver information acquisition unit automatically acquires high blood pressure, osteoporosis, a past fall history, medication details, allergy information, a vaccination history, a rehabilitation record, a swallowing function evaluation, a bedsore occurrence history, and the like from an electronic medical record or a care record, the activities of daily living data acquisition unit acquires a walking ability (using a cane), an excretion independence level (partial assistance), a food intake status (independent), a bathing and changing clothes independence level (assistance), an independence level of getting up and standing up from a bed (independent), an independence level of moving to a toilet (independent), a stair climbing ability (impossible), an outdoor mobility ability (once a week), an independence level of shopping and cooking (assistance), an independence level of money management and medication management (family management), and the like from a staff record or a sensor, and the vital data acquisition unit acquires a blood pressure (155/95), a heart rate (102), a body temperature, a blood oxygen saturation, a body weight, and a body fat percentage from a home sphygmomanometer or a wearable device, a sleep time (4 hours) and the number of mid-wakefulness (twice) from a sleep sensor, and the number of steps (less than 1000 steps a day) and calorie consumption from an activity meter in real time. The cognitive function evaluation data acquisition unit acquires MMSE 18 points, HDS-R 20 points, a response delay in daily conversation, a wandering tendency, observation records of family members and staff, and the like, and the living environmental factor acquisition unit acquires many steps in a residence, partial handrail installation, living alone, no pet, temperature and humidity of a residence, noise, heat insulation performance of a house, difficult access to a surrounding medical institution, a high disaster risk, a weak regional monitoring system, and the like. The care history acquisition unit records home visit care 3 times a week, no day service usage, a rehabilitation consultation history, past fall accidents and near-miss cases, a care plan change history, a staff replacement history, a service satisfaction evaluation, a transition of a care certification category, a care benefit record, requests and complaints from family members, and the like, the medication status acquisition unit acquires forgotten medication twice a week, a medication compliance rate of 80%, an operation status of a medication alert, no occurrence of a drug side effect, a drug change history, no drug allergy, a drug cost, a drug storage status, a drug remaining amount management, a medication guidance history, and the like from a medication support device, and the lifestyle information acquisition unit acquires meal contents (small intake), the number of excretions (twice a day), presence or absence of incontinence (once a week), a sleep time (4 hours), an activity amount (declining tendency), hobby activities (reading only), a social participation status (almost none), the number of bathing (twice a week), an outing frequency (once a week), a housework implementation status (impossible), an independence level of shopping and cooking (assistance), a communication frequency with friends and family members (once a week), a television viewing time (2 hours a day), a newspaper reading time (30 minutes a day), a participation status in religious activities and community activities (none), and the like from a sensor, an application, or a staff record. Specifically, the system executes a data collection profile customized for this specific care receiver profile. The care receiver information acquisition unit transmits an HTTP request to an API endpoint of the electronic medical record system. The care receiver information acquisition unit parses the medical record data returned in a JSON format. The care receiver information acquisition unit extracts an ICD-10 code of high blood pressure or osteoporosis. The activities of daily living data acquisition unit acquires point cloud data from a depth camera installed indoors. The activities of daily living data acquisition unit inputs the point cloud data to a three-dimensional convolutional neural network. The three-dimensional convolutional neural network outputs asymmetry of a posture during walking and variation in stride length as a numerical tensor. The vital data acquisition unit acquires R-R interval data of a heart rate in units of milliseconds from a smart watch. The vital data acquisition unit calculates a ratio of a high-frequency component and a low-frequency component, which is an index of autonomic nerve activity, from the R-R interval data. The cognitive function evaluation data acquisition unit acquires a voice waveform of daily conversation via a smart speaker. The cognitive function evaluation data acquisition unit extracts a feature vector indicating a pause length of speech and diversity of vocabulary from the voice waveform. The living environmental factor acquisition unit acquires environmental data from an indoor temperature and humidity sensor. The living environmental factor acquisition unit acquires external meteorological data from an open data API of the Japan Meteorological Agency. The system links these multidimensional data to a unique ID of the care receiver and stores the multidimensional data in a relational database and a time-series database. With this configuration, the system reconstructs the state of the care receiver as a digital twin in a virtual space by multifaceted sensor fusion technology. The system improves the comprehensiveness and accuracy of data. This technology is applied to a personalized healthcare monitoring system and a resident state estimation system in a smart home.

The long-term memory management unit integrally accumulates all of these pieces of information in chronological order, and records in detail a blood pressure transition over the past three years, a declining tendency of a cognitive function score, a change in walking ability and ADL, a functional change before and after rehabilitation intervention, a correlation between a fall history and a living environment, a change in medication compliance rate, a seasonal variation in sleep time and activity amount, a change in health indicators associated with a change in family structure or care service, a deterioration in health condition at the time of a disaster occurrence, a change in life rhythm at the time of an infectious disease epidemic, and the like. Specifically, the long-term memory management unit encodes the collected multidimensional data as a node feature of a graph neural network. The long-term memory management unit creates an edge between nodes based on temporal adjacency and semantic relevance. The long-term memory management unit formats the blood pressure transition data over the past three years as a time-series tensor. The long-term memory management unit quantifies the declining tendency of the cognitive function score as a slope parameter of a linear regression model. The long-term memory management unit generates a context vector combining an occurrence time of a fall event with living environment data (illuminance, temperature, humidity) and vital data (blood pressure fluctuation, sleep deprivation) immediately before the occurrence time. The long-term memory management unit inputs this context vector to a clustering algorithm. The clustering algorithm extracts a complex pattern that is a root cause of a fall. The long-term memory management unit calculates a cross-correlation function between a chronological change in medication compliance rate and a fluctuation in cognitive function score. The long-term memory management unit specifies a causal relationship with a time delay between the two. The long-term memory management unit adds these analysis results as metadata to the original time-series data. The long-term memory management unit persists the data in a distributed file system. With this configuration, the system constructs a semantically structured knowledge base, not just a list of data. The system dramatically improves learning efficiency and inference accuracy of a subsequent prediction model. This technology is applied to an advanced mining system of electronic medical record data and a long-term analysis system of a customer behavior history.

The generative AI processing unit comprehensively analyzes all these data, a natural language processing AI extracts a risk factor and a progress from medical and care records, a time-series analysis AI detects a change and an abnormal pattern in vitals, ADL, cognitive function, and lifestyle information, an image recognition AI extracts a risk factor from images of meal contents, behavior patterns, and a housing environment, a causal inference AI analyzes a relationship between a living environment, a care history, a medication status, and a health condition, and a generative model AI predicts a future fall risk, dementia progression risk, living function decline risk, dehydration or infectious disease risk, social isolation risk, economic hardship risk, and the like. For example, the AI automatically extracts a declining tendency of walking ability and cognitive function, a change in medication compliance rate, a seasonal physical condition variation, a correlation between a fall history and a living environment, a relationship between sleep deprivation and cognitive function decline, a relationship between social isolation and a depressive tendency, a relationship between deterioration of economic conditions and nutritional status decline, and the like, and learns an individual-specific pattern. Specifically, the generative AI processing unit reads a feature tensor of the care receiver from the constructed knowledge base with a batch size of 1. The generative AI processing unit supplies the feature tensor to an input layer of a deep learning model. The natural language processing AI adopts a BERT architecture. The natural language processing AI extracts keywords such as “staggering” and “decreased motivation” from text data of a care record, and converts them into a multidimensional embedding vector. The time-series analysis AI adopts an LSTM network. The time-series analysis AI receives a time-series array of vital data and ADL data over the past three years as an input. The time-series analysis AI calculates a decline probability of future walking ability as an output value of a sigmoid function. The image recognition AI adopts a ResNet architecture. The image recognition AI scores a degree of nutrient deficiency from an image tensor of a meal. The causal inference AI models a probabilistic dependency among sleep deprivation, forgotten medication, and a fall risk as a graph structure using a Bayesian network. The generative model AI receives an integrated vector combining the feature vectors output from these respective AIs as an input. The generative model AI maps the integrated vector to a latent space using a variational autoencoder. The generative model AI generates a plurality of scenarios of a future health condition from the latent space. The generative model AI calculates an occurrence probability of each scenario using a softmax function. The system outputs a scenario with the highest occurrence probability as a prediction result. With this configuration, the system mathematically specifies a hidden risk factor from a combination of an enormous number of variables that cannot be processed by a human expert. The system optimizes the timing of preventive intervention. This technology is applied to a prognosis prediction system of a complex disease and a predictive maintenance system of mechanical equipment.

The preventive care plan proposal unit automatically generates an individually optimized plan based on an analysis result of the generative AI processing unit, taking into consideration a living environment, a preference, a family structure, an economic situation, a religious restriction, a social background, and the like of a care receiver, such as elimination of steps and installation of handrails in a living environment, introduction of walking training and balance exercise, a brain training and conversation program for suppressing dementia progression, introduction of a medication support device, monitoring enhancement by care staff, life rhythm adjustment for sleep improvement, review of meal contents and water intake promotion, recommendation of hobby activities and social participation, enhancement of cooperation with family members and a community, proposal of economic support measures, promotion of community participation for preventing social isolation, and enhancement of a safety confirmation system in the event of a disaster. For example, the preventive care plan proposal unit proposes a combination of various preventive care and life support measures, such as enhancement of remote monitoring and an emergency call system for an elderly person living alone, introduction of a dementia prevention program when there is a cognitive function decline tendency, enhancement of house modification and walking training when a fall risk is high, introduction of a medication support device when there is a lot of forgotten medication, proposal of a sleep improvement program when there is a sleep disorder, utilization of a dietary supplement and a meal support service when a food intake amount is small, recommendation of community activities and volunteer participation when there is a social isolation tendency, proposal of utilization of a public support system when there is economic hardship, and enhancement of a safety confirmation system and an evacuation support measure in the event of a disaster. Specifically, the preventive care plan proposal unit receives vector data of a prediction scenario and a risk score output from the generative AI processing unit. The preventive care plan proposal unit activates a hybrid system combining a rule-based inference engine and a deep reinforcement learning agent. The inference engine extracts a candidate list of predefined countermeasures from a database for an item whose risk score exceeds a predetermined threshold. The deep reinforcement learning agent reads the extracted candidate list as an action space. The deep reinforcement learning agent reads a profile vector (living alone, economic situation, past illness history, etc.) of the care receiver as a state space. The deep reinforcement learning agent calculates an action-value function for each combination of countermeasures using a Q-learning algorithm. The deep reinforcement learning agent selects a set of countermeasures that maximizes an action value as an optimal policy. The preventive care plan proposal unit inputs a parameter group of the selected optimal policy to a large language model. The large language model converts the parameter group into a natural language sentence. The large language model outputs structured plan data including specific action items such as “installation of a remote monitoring sensor”, “addition of home visit rehabilitation twice a week”, and “introduction of a medication calendar”. The system transmits the output plan data to a terminal of a care manager and starts an approval workflow. With this configuration, the system computationally solves a multi-objective optimization problem and automatically generates a plan that exhibits a maximum effect under resource constraints. The system significantly shortens a lead time for plan creation. This technology is applied to an automatic generation system of a personalized financial portfolio and an optimization system of a cultivation plan in smart agriculture.

The remote monitoring cooperation unit receives biological data and lifestyle information in real time from a home medical device, a wearable device, a monitoring camera, a fall sensor, a door opening/closing sensor, a sleep sensor, a wandering detection sensor, an emergency call button, a GPS device, and the like, and sequentially transmits the biological data and the lifestyle information to the generative AI processing unit, and the generative AI analyzes the received data in real time, and automatically issues an alert notification to a care staff or a family member in the event of an abnormality, such as when a blood pressure or a heart rate rapidly increases, when a fall sensor is activated, when respiratory arrest is detected during sleep, when forgotten medication continues, when wandering or abnormal behavior is detected, when a door opening/closing sensor is activated at midnight, or when an emergency call button is pressed, and automatically schedules a remote medical examination or an emergency response as necessary. Specifically, the remote monitoring cooperation unit maintains an always-on TCP/IP session with an edge gateway device installed in a home of the care receiver. The remote monitoring cooperation unit receives a stream of sensor data from the edge gateway device using an MQTT protocol. The remote monitoring cooperation unit writes the received stream data into an in-memory time-series database. The remote monitoring cooperation unit activates a stream processing engine. The stream processing engine applies a statistical anomaly detection algorithm to a data window updated in milliseconds. The stream processing engine calculates a first derivative of a blood pressure value. The stream processing engine detects a rapid increase event when the first derivative exceeds a set safety threshold. The stream processing engine calculates a norm of an acceleration tensor output from the fall sensor. The stream processing engine detects a fall event when the norm exceeds a specified multiple of gravitational acceleration. The remote monitoring cooperation unit generates an alert payload including a snapshot of corresponding sensor data and basic information of the care receiver at the moment an abnormal event is detected. The remote monitoring cooperation unit inputs the alert payload to the generative AI processing unit. The generative AI processing unit analyzes the alert payload and determines an urgency level. When the urgency level is a maximum value, the system generates a notification voice to an emergency command center using an automatic voice synthesis module, and executes an automatic call processing using a SIP protocol. With this configuration, the system completes a process from abnormality detection to initial response without human intervention. The system exhibits an extremely important technical effect of improving a survival rate. This technology is applied to an automatic monitoring system for dangerous work in a factory and a real-time accident detection system for transportation infrastructure.

Specific examples of a prompt sentence to be read by the generative AI include “Predict a fall risk and a dementia progression risk based on the following care receiver data, and generate a life support and preventive care plan for risk reduction. Care receiver data: age 83, female, past illness history: osteoporosis, high blood pressure, and fall history, ADL: walking ability 2 (using a cane), excretion independence level: partial assistance, dementia evaluation: MMSE 18 points, vitals: blood pressure 155/95, heart rate 102, sleep time 4 hours, forgotten medication twice a week, living environment: many steps and living alone, care history: home visit care 3 times a week, lifestyle information: small food intake amount and decreased activity amount, and all data for the past year attached in chronological order.” and the like. Specifically, the system executes a process of converting structured data extracted from a database into a natural language text format using a prompt generation module. The prompt generation module maps multidimensional variables such as an age, a gender, a past illness history, an ADL score, an average value and a variance value of vital data, and flag data of a living environment of the care receiver in accordance with a predefined JSON schema. The prompt generation module inputs the mapped JSON data to a template engine. The template engine expands the variables into a text character string, and dynamically constructs a prompt sentence whose context is easy for a large language model to understand. The system inputs the constructed prompt sentence to a tokenizer. The tokenizer converts the text character string into a token ID tensor which is an array of integers. The system supplies the token ID tensor to an input layer of a large language model having a transformer architecture. The large language model calculates a dependency relationship between input tokens using a self-attention mechanism having billions of parameters. The large language model generates an output token sequence including a probability value of a fall risk, a prediction score of dementia progression, and a list of specific intervention measures for reducing them. The system inputs the output token sequence to a decoder and reversely converts the output token sequence into natural language text data. The system extracts a numerical value of a risk score and an action item from the text data using a regular expression, and stores them in a database as structured plan data. With this configuration, the system seamlessly executes conversion between unstructured data and structured data. The system optimizes and uses a general-purpose language model for a specific domain task. This technology is applied to an automatic response generation system in customer support and an automatic summarization and risk extraction system for legal documents.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

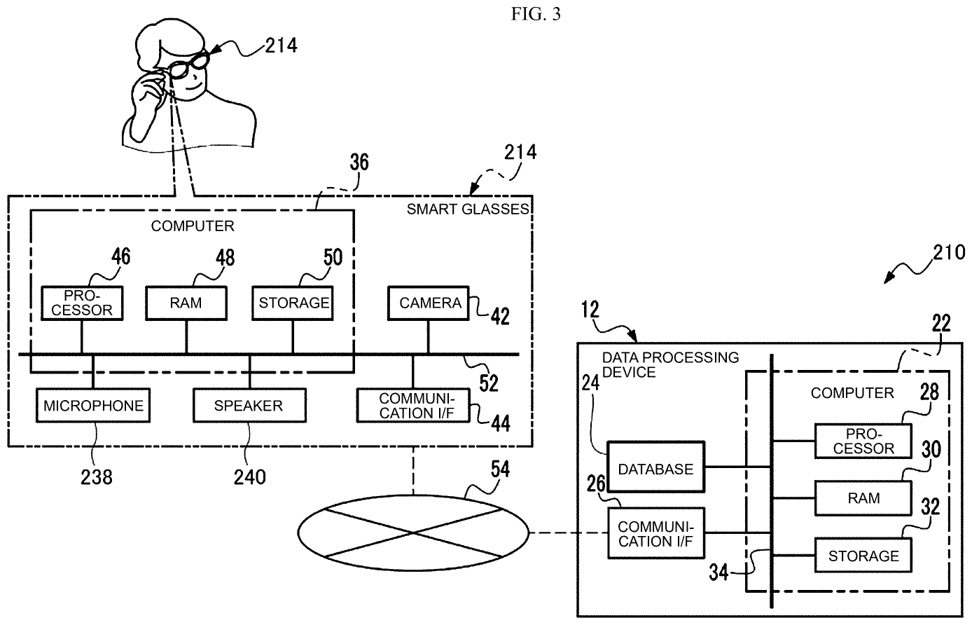

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

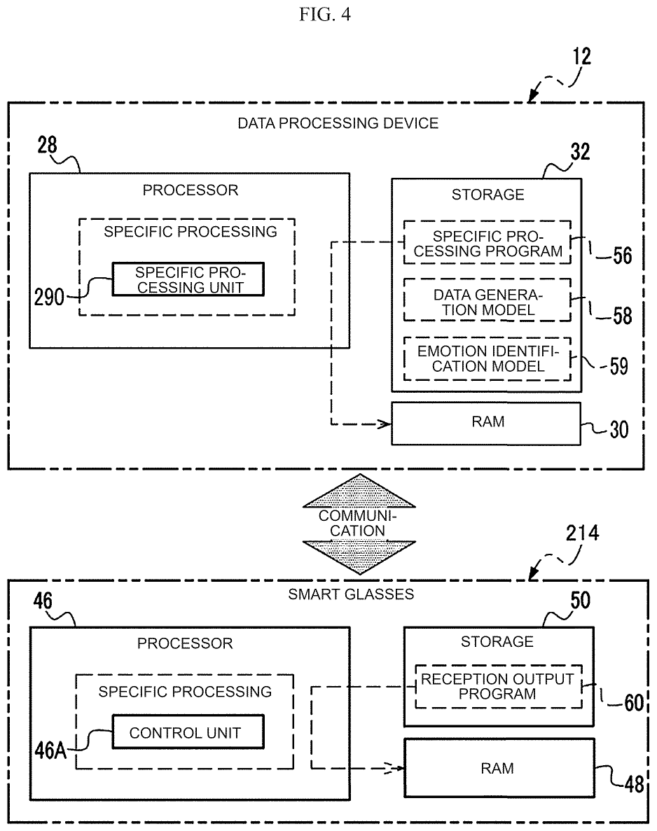

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

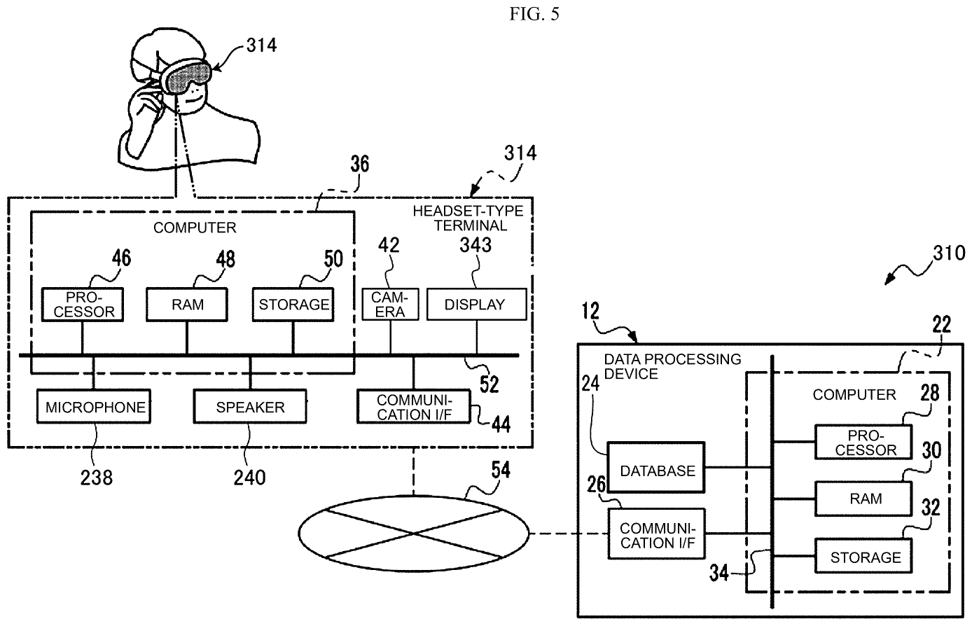

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

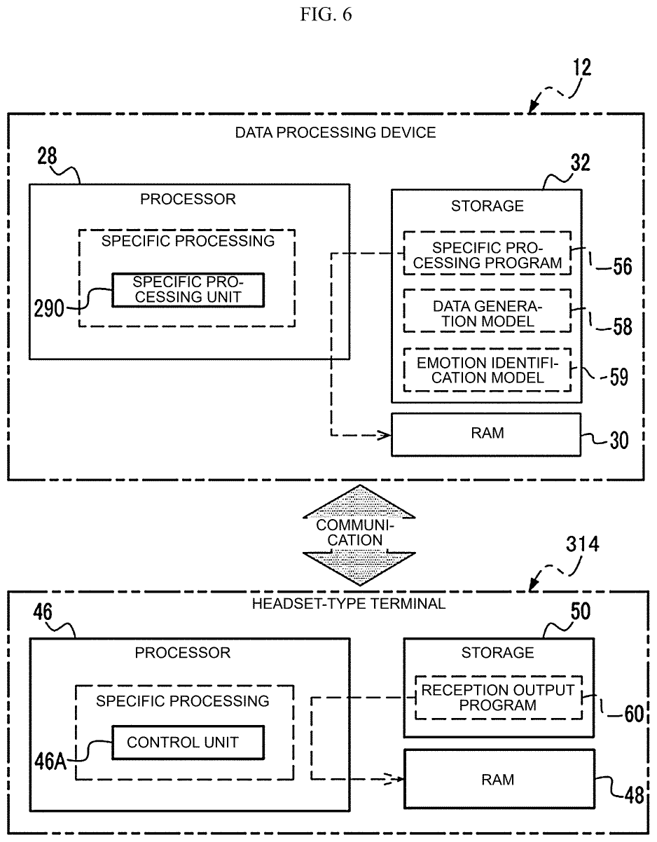

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

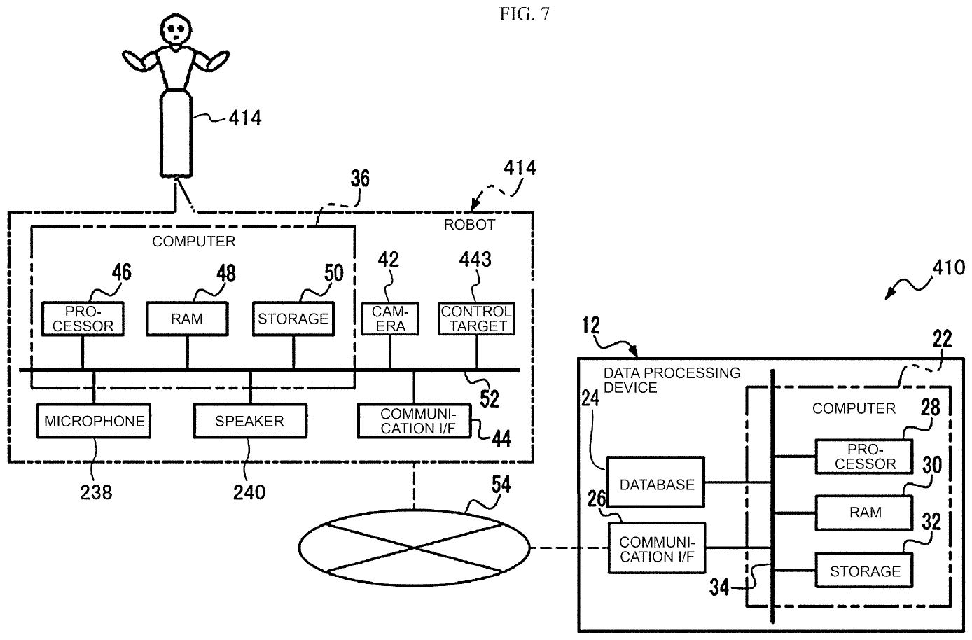

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

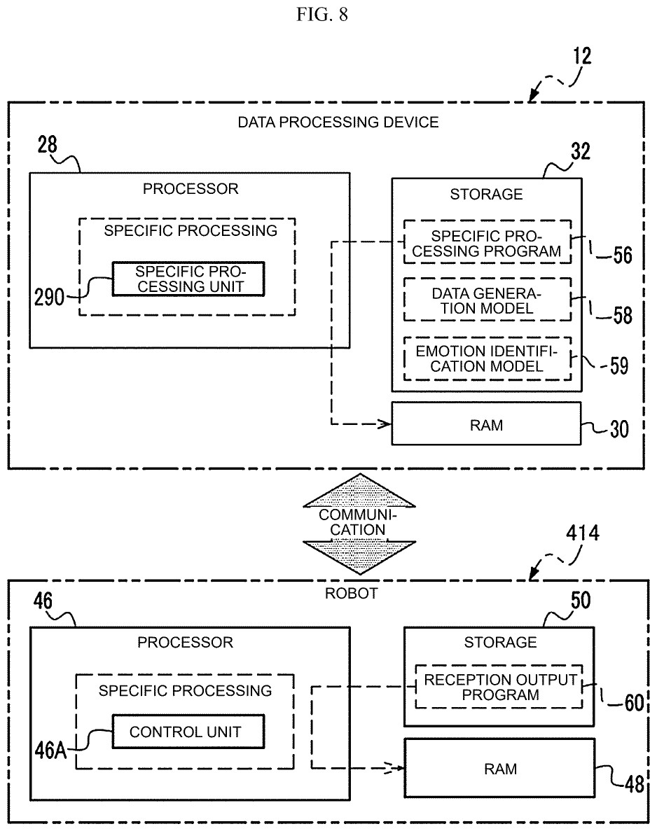

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

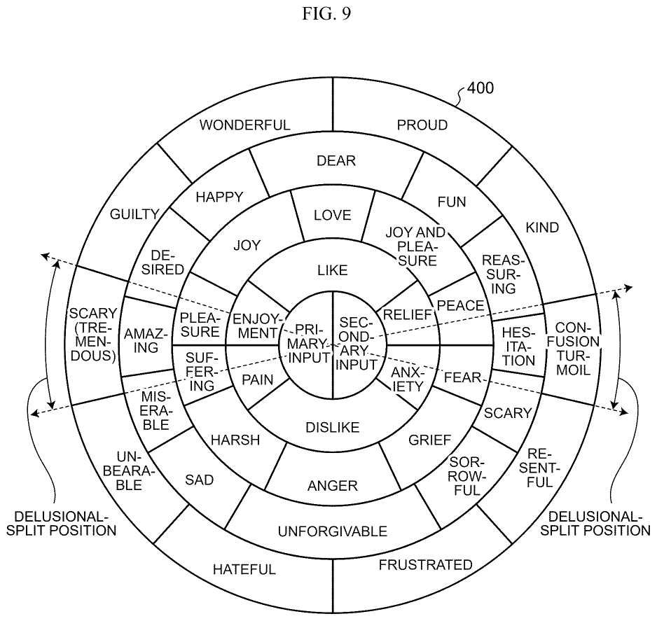

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

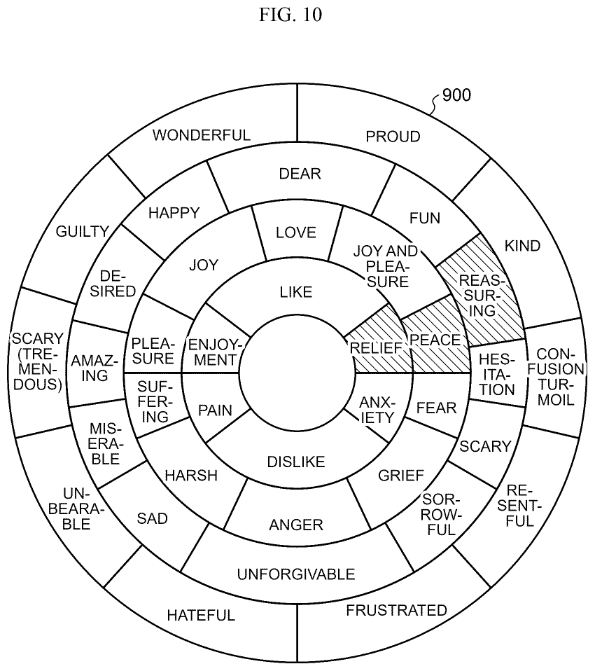

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A system comprising: a care receiver information acquisition unit; an activities of daily living data acquisition unit; a vital data acquisition unit; a cognitive function evaluation data acquisition unit; a living environmental factor acquisition unit; a care history acquisition unit; a medication status acquisition unit; a lifestyle information acquisition unit; a long-term memory management unit; a generative AI processing unit; a preventive care plan proposal unit; and a remote monitoring cooperation unit, wherein the care receiver information acquisition unit is configured to automatically acquire health records, a chronic disease history, a fall history, a fracture history, a hospitalization history, medication details, allergy information, and the like for each care receiver from an electronic medical record or a care record; the activities of daily living data acquisition unit is configured to acquire a walking ability, an excretion independence level, a food intake status, a bathing and changing clothes independence level, and the like from a record of a care staff or a sensor; the vital data acquisition unit is configured to acquire a blood pressure, a heart rate, a body temperature, a blood oxygen saturation, a respiratory rate, a body weight, and the like in real time from a home medical device or a wearable device; the cognitive function evaluation data acquisition unit is configured to acquire regular dementia evaluation scores, AI automatic evaluations from daily conversation and behavior patterns, observation records of family members and staff, and the like; the living environmental factor acquisition unit is configured to acquire steps and handrail installation status in a residence, living alone or living together, temperature and humidity of a residence, noise, medical institution access status, and the like; the care history acquisition unit is configured to record a usage status of home visit care and day service, a rehabilitation consultation history, past care accidents and near-miss cases, and the like; the medication status acquisition unit is configured to acquire presence or absence of forgotten medication or incorrect medication, and a medication compliance rate from a medication support device or a medication record application; the lifestyle information acquisition unit is configured to acquire meal contents and calorie intake, the number of excretions and presence or absence of incontinence, a sleep time and the number of mid-wakefulness, an activity amount and an exercise habit, and the like from a sensor, an application, or a staff record; the long-term memory management unit is configured to integrally accumulate all of these pieces of information in chronological order; the generative AI processing unit is configured to comprehensively analyze these data to quantify a fall risk, a dementia progression risk, a living function decline risk, a dehydration or infectious disease risk, and the like; the preventive care plan proposal unit is configured to automatically generate an individually optimized preventive care and life support plan such as living environment improvement, walking training, a dementia progression suppression program, medication support device introduction, monitoring enhancement by care staff, sleep improvement, meal content review, and water intake promotion based on an analysis result of the generative AI processing unit; the remote monitoring cooperation unit is configured to receive biological data in real time from a home medical device or a wearable device of the care receiver, automatically issue an alert notification to a care staff or a family member when there is an abnormality, and automatically schedule a remote medical examination or an emergency response as necessary; and all of these processes are operated by a generative AI.

### (Supplementary Note 2)

The system according to Supplementary Note 1, wherein the generative AI processing unit is configured to analyze chronological changes in past walking abilities, cognitive function scores, vital data, medication compliance rates, living environmental factors, care histories, lifestyle information, and the like accumulated in the long-term memory management unit, extract an individual-specific health and lifestyle pattern such as a seasonal variation, a life event, an effect of care intervention, a change in medication compliance rate, and a transition of sleep and activity amount, early detect a sign of a future fall risk, dementia progression risk, and living function decline risk, and dynamically optimize and propose an intervention timing and content in the preventive care plan proposal unit.

### (Supplementary Note 3)

The system according to Supplementary Note 1, wherein the remote monitoring cooperation unit is configured to sequentially transmit real-time biological data and lifestyle information acquired from a home medical device or a wearable device of the care receiver to the generative AI processing unit, and when the generative AI processing unit detects an abnormal value or an increase in risk, the generative AI processing unit is configured to automatically issue an alert notification to a care staff or a family member, determine whether a remote medical examination or an emergency response can be performed according to a residence, a care system, or a mobility difficulty of the care receiver, automatically schedule the remote medical examination or the emergency response as necessary, and notify the care receiver, the family member, and the care staff.

What is claimed is:

1. A system comprising:
circuitry configured to:
receive, via a communication interface coupled to a packet-switched network, heterogeneous time-series data streams from a plurality of IoT sensor devices, execute primary noise filtering and sliding window segmentation at an edge computing node to generate three-dimensional tensors comprising time, sensor, and feature axes, and transmit compressed feature vectors to a cloud computing node via the communication interface;
retrieve structured data records from external data service endpoints via the communication interface, and construct an integrated feature tensor at the cloud computing node by fusing the compressed feature vectors with the structured data records;
apply a hybrid deep learning model comprising a large language model component and a graph neural network component to the integrated feature tensor to generate a state transition prediction score and an output instruction sequence comprising prioritized operational steps;
accumulate the integrated feature tensor and the state transition prediction score in a longitudinal processing record in chronological order in a storage device; and
transmit the state transition prediction score and the output instruction sequence to a terminal device via the communication interface, and issue a control command when the state transition prediction score exceeds a threshold parameter.

2. The system according to claim 1, wherein the circuitry is configured to input the three-dimensional tensors to a deep convolutional neural network at the cloud computing node to extract activity classification features, generate a classification label vector indicating activity state categories from the extracted features, and incorporate the classification label vector as a feature dimension in the integrated feature tensor.

3. The system according to claim 2, wherein the circuitry is configured to apply an anomaly detection model to the three-dimensional tensors to compute reconstruction error scores by comparing predicted sensor values against observed sensor values, generate an anomaly signal when a reconstruction error score exceeds an anomaly threshold parameter, and update the state transition prediction score when an anomaly signal is generated.

4. The system according to claim 1, wherein the circuitry is configured to drive an API gateway to issue data extraction queries to a plurality of external data service endpoints via the communication interface, parse acquired data to extract entity records from unstructured text using a natural language processing model, and map the extracted entity records to a relational database schema in the storage device.

5. The system according to claim 4, wherein the circuitry is configured to generate a feature amount tensor from the extracted entity records comprising a binary flag array corresponding to historical state indicators, an integer value array corresponding to event frequency records, and a floating-point array corresponding to continuous measurement transitions, and transfer the feature amount tensor to the hybrid deep learning model for state transition prediction score computation.

6. The system according to claim 1, wherein the circuitry is configured to extract a trend component from the longitudinal processing record by applying a moving average filter to time-series parameter arrays, and detect a pattern deviation by comparing a current trend component against a historical baseline pattern derived from the longitudinal processing record.

7. The system according to claim 6, wherein the circuitry is configured to apply the large language model component of the hybrid deep learning model to the longitudinal processing record to identify correlated state change events across different time windows, generate a correlation feature vector representing inter-variable dependency relationships, and incorporate the correlation feature vector into the integrated feature tensor prior to state transition prediction score computation.

8. The system according to claim 1, wherein the circuitry is configured to apply the graph neural network component of the hybrid deep learning model to a state graph comprising state variable nodes and dependency edges derived from the structured data records, execute message passing operations between adjacent nodes, and generate a state transition probability vector indicating likely future state transitions.

9. The system according to claim 8, wherein the circuitry is configured to generate the output instruction sequence by applying a retrieval-augmented generation process to the state transition prediction score and the state transition probability vector with reference to context data retrieved from a vector database storing reference records, and generate prioritized operational steps by autoregressive decoding.

10. The system according to claim 1, wherein the circuitry is configured to receive updated time-series data streams from the IoT sensor devices at periodic intervals via the communication interface, process the updated data streams at the edge computing node to generate updated compressed feature vectors, update the integrated feature tensor by incorporating the updated compressed feature vectors, and regenerate the state transition prediction score by re-applying the hybrid deep learning model to the updated integrated feature tensor.

11. The system according to claim 10, wherein the circuitry is configured to monitor the regenerated state transition prediction score after each periodic update, issue an escalated control command to the terminal device when the regenerated state transition prediction score increases above a first threshold parameter, and issue an emergency response command to an emergency response system when the regenerated state transition prediction score exceeds a second threshold parameter higher than the first threshold parameter.

12. The system according to claim 1, wherein the circuitry is configured to receive biological attribute data from an external biological data service via the communication interface, extract sequence feature data and phenotype association scores from the biological attribute data, and incorporate the sequence feature data and the phenotype association scores as additional feature dimensions in the integrated feature tensor.

13. The system according to claim 1, wherein the circuitry is configured to personalize the output instruction sequence by conditioning the hybrid deep learning model on a preference profile data record stored in the storage device, and adjust the prioritized operational steps based on the preference profile data record.

14. The system according to claim 13, wherein the circuitry is configured to update a machine learning model used for state transition prediction score computation by generating training pairs from historical integrated feature tensors and corresponding longitudinal outcome records, and fine-tune the machine learning model on the training pairs to improve prediction accuracy.

15. The system according to claim 1, wherein the circuitry is configured to apply the graph neural network component of the hybrid deep learning model to a knowledge graph structure derived from the structured data records by encoding entity relationships as weighted edges, and compute a knowledge graph embedding vector to incorporate as an additional feature dimension in the integrated feature tensor.

16. The system according to claim 1, wherein the circuitry is configured to distribute compressed feature vectors from a plurality of edge computing nodes to the cloud computing node via a content delivery network, aggregate the compressed feature vectors from all edge computing nodes, and execute hybrid deep learning model inference on the aggregated feature tensor in parallel across a graphics processing unit cluster.

17. The system according to claim 1, wherein the IoT sensor devices are distributed across a monitoring environment and configured to generate heterogeneous time-series data streams, the structured data records comprise contextual attribute records retrieved from domain-specific data service systems, and the output instruction sequence specifies prioritized operational response steps corresponding to the state transition prediction score.

18. A system comprising:
circuitry configured to:
receive, via a communication interface coupled to a packet-switched network, heterogeneous time-series data streams from a plurality of IoT sensor devices, execute noise filtering and sliding window segmentation at an edge computing node to generate three-dimensional tensors, and transmit compressed feature vectors to a cloud computing node;
retrieve structured data records from external data service endpoints and construct an integrated feature tensor by fusing the compressed feature vectors with the structured data records;
apply a hybrid deep learning model comprising a large language model component and a graph neural network component to the integrated feature tensor to generate a state transition prediction score and an output instruction sequence comprising prioritized operational steps; and
transmit the state transition prediction score and the output instruction sequence to a terminal device via the communication interface, and issue a control command when the state transition prediction score exceeds a threshold parameter.

19. The system according to claim 18, wherein the circuitry is configured to accumulate the integrated feature tensor in a longitudinal processing record in chronological order, apply a retrieval-augmented generation process to generate an updated output instruction sequence from an updated state transition prediction score and context data retrieved from a vector database, and issue an escalated control command when the updated score exceeds a first threshold and an emergency response command when it exceeds a second higher threshold.

20. A method comprising:
receiving, via a communication interface coupled to a packet-switched network, heterogeneous time-series data streams from a plurality of IoT sensor devices, executing noise filtering and sliding window segmentation at an edge computing node to generate three-dimensional tensors comprising time, sensor, and feature axes, and transmitting compressed feature vectors to a cloud computing node;
retrieving structured data records from external data service endpoints, and constructing an integrated feature tensor at the cloud computing node by fusing the compressed feature vectors with the structured data records;
applying a hybrid deep learning model comprising a large language model component and a graph neural network component to the integrated feature tensor to generate a state transition prediction score and an output instruction sequence comprising prioritized operational steps;
accumulating the integrated feature tensor and the state transition prediction score in a longitudinal processing record in chronological order in a storage device; and
transmitting the state transition prediction score and the output instruction sequence to a terminal device via the communication interface, and issuing a control command when the state transition prediction score exceeds a threshold parameter.
